(19) United States
(12) Patent Application Publication
(10) Pub. No.: US 2022/0243045 A1
(43) Pub. Date: Aug. 4, 2022

(54) THERMOPLASTIC RESIN COMPOSITION, MOLDED ARTICLE, AND PRODUCT

(71) Applicant: Mitsubishi Electric Corporation, TOKYO (JP)

(72) Inventors: Reiji MORIOKA, TOKYO (JP); Etsuko HIROSE, TOKYO (JP); Keiko ISHIMOTO, TOKYO (JP); Yoshihide NISHIHIRO, TOKYO (JP); Daiji SATO, TOKYO (JP)

(21) Appl. No.: 17/606,610

(22) PCT Filed: Jul. 3, 2020
(86) PCT No.: PCT/JP2020/026119

§ 371 Date: Oct. 26, 2021

(30) Foreign Application Priority Data
Jul. 10, 2019 (JP) 2019-128411
Apr. 2, 2020 (JP) 2020-066726

(51) Int. Cl. C08L 25/04; C08L 71/02

(52) U.S. Cl. CPC C08L 25/04; C08L 2205/03; C08L 71/02

(57) ABSTRACT

A thermoplastic resin composition comprising; a thermoplastic resin (A) selected from the group consisting of an aromatic polycarbonate resin (A1), a styrene-based resin (A2), an aromatic polyester resin (A3), a polyphenylene ether resin (A4), a methacrylic resin (A5), a polyarylene sulfide resin (A6), an olefin resin (A7), a polyamide resin (A8), and mixtures thereof; a hydrophilic copolymer (B) having a polyoxyethylene chain; and a fatty acid metal salt (C) represented by the following formula (1): M(OH)y(R—COO)x . . . (1), wherein R is an alkyl group or alkenyl group having 6 to 40 carbon atoms; M is at least one metal element selected from the group consisting of aluminum, zinc, calcium, magnesium, lithium, and barium; and x and y each independently represent an integer of 0 or more, and satisfy the relation represented by x+y=[valency of M].

### TECHNICAL FIELD

The present disclosure relates to thermoplastic resin compositions, molded articles, and products.

### BACKGROUND ART

Thermoplastic molded articles have been used under a variety of environments in a variety of applications such as inner parts of home appliance products and OA apparatuses, housings, parts for vehicles, and sundry goods because thermoplastic resins are lighter than metals and easier to process than metals.

Their usage environment and usage method may cause powdery dust fouling made of sand dust, dust, soot, oily smoke, or the like to adhere to these thermoplastic resin molded articles. Adhesion of powdery dust fouling to the molded articles results in bad appearances thereof, and may reduce the performance of the products.

Thus, to suppress adhesion of powdery dust fouling, attempts to impart antistatic performance to thermoplastic resin molded articles using an antistatic agent have been made.

For example, a method of imparting antistatic performance to a molded article by causing an antistatic agent to adhere to the surface of the molded article through spraying, immersion, or application thereof is known. However, the method of causing the antistatic agent to adhere to the surface of the molded article has problems such that most of antistatic agents are made of a water-soluble surfactant and are removed by wiping, washing or the like, resulting in loss of antistatic effects of the antistatic agents.

On the other hand, another method (kneading method) of imparting antistatic performance to a thermoplastic resin molded article by compounding an antistatic agent as an additive with a thermoplastic resin is known. This kneading method has been recently receiving attention because of its long-lasting high antistatic effects.

A variety of compounds are known as antistatic agents used in the kneading method. For example, PTL 1 (Japanese Patent Laying-Open No. 2011-256293) discloses fatty acid amide compounds of aminoethylethanolamine. PTL 2 (Japanese Patent Application Laying-Open No. 58-118838) and PTL 3 (Japanese Patent Application Laying-Open No. 3-290464) disclose polyether ester amide. PTL 4 (Japanese Patent Application Laying-Open No. 2001-278985), PTL 5 (WO 2014/115745), and PTL 6 (WO 2014/148454) each disclose a block copolymer including an olefin block and a hydrophilic polymer block, and the like. PTLs 5 and 6 also disclose a polyether ester polymer-type antistatic agent.

To be noted, PTL 1 discloses use of an alkali metal compound or an alkaline earth metal compound (such as calcium stearate) in combination to enhance the antistatic effects of the fatty acid amide compounds of aminoethylethanolamine. Moreover, PTL 4 discloses use of an alkali metal compound, such as lithium chloride, potassium acetate, or sodium dodecylbenzenesulfonate, in combination to enhance the antistatic effects of the block copolymer including an olefin block and a hydrophilic polymer block. PTLs 5 and 6 disclose compounding of an alkali metal compound such as potassium acetate or sodium dodecylbenzenesulfonate with a polyether ester polymer-type antistatic agent.

### CITATION LIST

### Patent Literature

PTL 1: Japanese Patent Application Laying-Open No. 2011-256293
PTL 2: Japanese Patent Application Laying-Open No. 58-118838
PTL 3: Japanese Patent Application Laying-Open No. 3-290464
PTL 4: Japanese Patent Application Laying-Open No. 2001-278985
PTL 5: WO 2014/115745
PTL 6: WO 2014/148454

### SUMMARY OF INVENTION

### Technical Problem

However, it is found that the antistatic agents above all demonstrate some effects of suppressing adhesion of hydrophilic powdery dust fouling made of sand dust, dust or the like, but they hardly demonstrate the effects of suppressing adhesion of hydrophobic powdery dust fouling made of soot, oily smoke, or the like. In other words, any resin composition which hardly allow adhesion of both hydrophilic powdery dust fouling and hydrophobic powdery dust fouling has not been provided.

Accordingly, an object of the present disclosure is to suppress adhesion of both hydrophilic powdery dust fouling and hydrophobic powdery dust fouling to a molded article comprising a thermoplastic resin composition.

### Solution to Problem

A thermoplastic resin composition comprising: a thermoplastic resin (A) selected from the group consisting of an aromatic polycarbonate resin (A1), a styrene-based resin (A2), an aromatic polyester resin (A3), a polyphenylene ether resin (A4), a methacrylic resin (A5), a polyarylene sulfide resin (A6), an olefin resin (A7), a polyamide resin (A8), and a mixture thereof;

a hydrophilic copolymer (B) having a polyoxyethylene chain; and
a fatty acid metal salt (C) represented by the following formula (1):

M(OH)y(R—COO)x (1)

wherein R is an alkyl group or alkenyl group having 6 to 40 carbon atoms; M is at least one metal element selected from the group consisting of aluminum, zinc, calcium, magnesium, lithium, and barium; and x and y each independently represent an integer of 0 or more, and satisfy the relation represented by x+y=[valency of M].

### Advantageous Effects of Invention

In the present disclosure, adhesion of both hydrophilic powdery dust fouling hydrophobic powdery dust fouling to a molded article comprising a thermoplastic resin composition can be suppressed by compounding the hydrophilic copolymer (B) and the fatty acid metal salt (C) with the thermoplastic resin (A).

### BRIEF DESCRIPTION OF DRAWINGS

FIG. 1 is a cross-sectional schematic view showing one example of a molded article according to Embodiment 2.

FIG. 2 is a schematic graph showing the compositional distribution in the depth direction of one example of the molded article according to Embodiment 2.

FIG. 3 is a conceptual diagram illustrating a thermoplastic resin composition according to an embodiment.

FIG. 4 is a conceptual diagram illustrating a thermoplastic resin composition according to an embodiment.

FIG. 5 is a cross-sectional schematic view showing one example of an air conditioner according to Embodiment 3.

FIG. 6 is a conceptual diagram illustrating a thermoplastic resin composition according to an embodiment.

### DESCRIPTION OF EMBODIMENTS

Embodiments according to the present disclosure will now be described. In the drawings, dimensional relations such as the length, the width, the thickness, the depth, and the like are appropriately changed for clarifying and simplifying the drawings, and do not represent actual dimensional relations.

### Embodiment 1

The thermoplastic resin composition according to the present embodiment comprises:

a thermoplastic resin (A) selected from the group consisting of an aromatic polycarbonate resin (A1), a styrene-based resin (A2), an aromatic polyester resin (A3), a polyphenylene ether resin (A4), a methacrylic resin (A5), a polyarylene sulfide resin (A6), an olefin resin (A7), a polyamide resin (A8), and a mixture thereof;
a hydrophilic copolymer (B) having a polyoxyethylene chain; and
a fatty acid metal salt (C).

The molded article comprising the thermoplastic resin composition according to the present embodiment provides a remarkable anti-contamination effect of suppressing adhesion of both hydrophilic powdery dust fouling and hydrophobic powdery dust fouling. Such a remarkable anti-contamination effect is provided by a thermoplastic resin composition containing all the components (A) to (C), and is difficult to obtain using only the component (A), only the component (B), only the component (C), only the components (A) and (B), only the components (A) and (C), or only the components (B) and (C).

The molded article comprising the thermoplastic resin composition according to the present embodiment can further have mechanical strength such as impact resistance.

<Thermoplastic Resin (A)>

The thermoplastic resin (A) is selected from the group consisting of an aromatic polycarbonate resin (A1), a styrene-based resin (A2), an aromatic polyester resin (A3), a polyphenylene ether resin (A4), a methacrylic resin (A5), a polyarylene sulfide resin (A6), an olefin resin (A7), a polyamide resin (A8), and a mixture thereof.

Examples of the mixture, that is, the mixture of at least two resins selected from the aromatic polycarbonate resin (A1), the styrene-based resin (A2), the aromatic 15 polyester resin (A3), the polyphenylene ether resin (A4), the methacrylic resin (A5), the polyarylene sulfide resin (A6), the olefin resin (A7), and the polyamide resin (A8) include, but should not be limited to, combinations of the aromatic polycarbonate resin (A1) with the styrene-based resin (A2), the aromatic polycarbonate resin (A1) with the aromatic polyester resin (A3), the aromatic polycarbonate resin (A1) with the olefin resin (A7), the aromatic polycarbonate resin (A1) with the methacrylic resin (A5), the styrene-based resin (A2) with the aromatic polyester resin (A3), the styrene-based resin (A2) with the methacrylic resin (A), the styrene-based resin (A2) with the olefin resin (A7), the styrene-based resin (A2) with the polyamide resin (A8), the polyphenylene ether resin (A4) with the olefin resin (A7), the methacrylic resin (A5) with the olefin resin (A7), and the olefin resin (A7) with the polyamide resin (A8).

(Aromatic Polycarbonate Resin (A1))

The aromatic polycarbonate resin (A1) is prepared usually by reacting a dihydroxy compound with a carbonate precursor through interface polycondensation or melt transesterification, or by polymerizing a carbonate prepolymer through solid phase transesterification, or by polymerizing a cyclic carbonate compound through ring-opening polymerization.

The dihydroxy component used there may be any dihydroxy component of an aromatic polycarbonate usually used, and may be bisphenols or aliphatic diols.

Examples of the bisphenols include 4,4′-dihydroxybiphenyl, bis(4-hydroxyphenyl)methane, 1,1-bis(4-hydroxyphenyl)ethane, 1,1-bis(4-hydroxyphenyl)-1-phenylethane, 2,2-bis(4-hydroxyphenyl)propane, 2,2-bis(4-hydroxy-3-methylphenyl)propane, 1,1-bis(4-hydroxyphenyl)-3,3,5-trimethylcyclohexane, 2,2-bis(4-hydroxy-3,3′-biphenyl)propane, 2,2-bis(4-hydroxy-3-isopropylphenyl)propane, 2,2-bis(3-t-butyl-4-hydroxyphenyl)propane, 2,2-bis(4-hydroxyphenyl)butane, 2,2-bis(4-hydroxyphenyl)octane, 2,2-bis(3-bromo-4-hydroxyphenyl)propane, 2,2-bis(3,5-dimethyl-4-hydroxyphenyl)propane, 2,2-bis(3-cyclohexyl-4-hydroxyphenyl)propane, 1,1-bis(3-cyclohexyl-4-hydroxyphenyl)cyclohexane, bis(4-hydroxyphenyl)diphenylmethane, 9,9-bis(4-hydroxyphenyl)fluorene, 9,9-bis(4-hydroxy-3-methylphenyl)fluorene, 1,1-bis(4-hydroxyphenyl)cyclohexane, 1,1-bis(4-hydroxyphenyl)cyclopentane, 4,4′-dihydroxydiphenylether, 4,4′-dihydroxy-3,3′-dimethyldiphenylether, 4,4′-sulfonyldiphenol, 4,4′-dihydroxydiphenyl sulfoxide, 4,4′-dihydroxydiphenyl sulfide, 2,2′-dimethyl-4,4′-sulfonyldiphenol, 4,4′-dihydroxy-3,3′-dimethyldiphenyl sulfoxide, 4,4′-hydroxy-3,3′-dimethyldiphenyl sulfide, 2,2′-diphenyl-4,4′-sulfonyldiphenol, 4,4′-dihydroxy-3,3′-diphenyldiphenyl sulfoxide, 4,4′-dihydroxy-3,3′-diphenyldiphenyl sulfide, 1,3-bis{2-(4-hydroxyphenyl)propyl}benzene, 1,4-bis{2-(4-hydroxyphenyl)propyl}benzene, 1,4-bis(4-hydroxyphenyl)cyclohexane, 1,3-bis(4-hydroxyphenyl)cyclohexane, 4,8-bis(4-hydroxyphenyl)tricyclo[5,2,1,02,6]decane, and 4,4′-(1,3-adamantanediyl)diphenol, 1,3-bis(4-hydroxyphenyl)-5,7-dimethyladamantane.

Examples of the aliphatic diols include 2,2-bis-(4-hydroxycyclohexyl)-propane, 1,1,4-tetradecanediol, octaethylene glycol, 1,1,6-hexadecanediol, 4,4′-bis(2-hydroxyethoxy)biphenyl, bis{(2-hydroxyethoxy)phenyl}methane, 1,1-bis{(2-hydroxyethoxy)phenyl}ethane, 1,1-bis{(2-hydroxyethoxy)phenyl}-1-phenylethane, 2,2-bis{(2-hydroxyethoxy)phenyl}propane, 2,2-bis{(2-hydroxyethoxy)-3-methylphenyl}propane, 1,1-bis{(2-hydroxyethoxy)phenyl}-3,3,5-trimethylcyclohexane, 2,2-bis{4-(2-hydroxyethoxy)-3,3′-biphenyl}propane, 2,2-bis{(2-hydroxyethoxy)-3-isopropylphenyl}propane, 2,2-bis{3-t-butyl-4-(2-hydroxyethoxy)phenyl}propane, 2,2-bis{(2-hydroxyethoxy)phenyl}butane, 2,2-bis{(2-hydroxyethoxy)phenyl}-4-methylpentane, 2,2-bis{(2-hydroxyethoxy)phenyl}octane, 1,1-bis{(2-hydroxyethoxy)phenyl}decane, 2,2-bis{3-bromo-4-(2-hydroxyethoxy)phenyl}propane, 2,2-bis{3,5-dimethyl-4-(2-hydroxyethoxy)phenyl}propane, 2,2-bis{3-cyclohexyl-4-(2-hydroxyethoxyphenylpropane, 1,1-bis{3-cyclohexyl-4-(2-hydroxyethoxy)phenyl}cyclohexane, bis{(2-hydroxyethoxy)phenyl}diphenylmethane, 9,9-bis{(2-hydroxyethoxy)phenyl}fluorene, 9,9-bis{4-(2-hydroxyethoxy)-3-methylphenyl)fluorene, 1,1-bis{(2-hydroxyethoxy)phenyl}cyclohexane, 1,1-bis{(2-hydroxyethoxy)phenyl}cyclopentane, 4,4′-bis(2-hydroxyethoxy)diphenylether, 4,4′-bis(2-hydroxyethoxy)-3,3′-dimethyldiphenylether, 1,3-bis[2-((2-hydroxyethoxy)phenyl}propyl]benzene, 1,4-bis[2-{(2-hydroxyethoxy)phenyl}propyl]benzene, 1,4-bis((2-hydroxyethoxy)phenyl}cyclohexane, 1,3-bis{(2-hydroxyethoxy)phenyl}cyclohexane, 4,8-bis{(2-hydroxyethoxy)phenyl}tricyclo[5,2,1,02,6]decane, 1,3-bis{(2-hydroxyethoxy)phenyl}-5,7-dimethyladamantane, 3,9-bis(2-hydroxy-1,1-dimethylethyl)-2,4,8,10-tetraoxaspiro(5,5)undecane, 1,4:3,6-dianhydro-D-sorbitol (isosorbide), 1,4:3,6-dianhydro-D-mannitol (isomannide), and 1,4:3,6-dianhydro-L-iditol (isoidide).

Among these, preferred are aromatic bisphenols. Among these, preferred are 1,1-bis(4-hydroxyphenyl)-1-phenylethane, 2,2-bis(4-hydroxyphenyl)propane, 2,2-bis(4-hydroxy-3-methylphenyl)propane, 1,1-bis(4-hydroxyphenyl)cyclohexane, 1,1-bis(4-hydroxyphenyl)-3,3,5-trimethylcyclohexane, 4,4′-sulfonyldiphenol, 2,2′-dimethyl-4,4′-sulfonyldiphenol, 9,9-bis(4-hydroxy-3-methylphenyl)fluorene, 1,3-bis{2-(4-hydroxyphenyl)propyl}benzene, and 1,4-bis{2-(4-hydroxyphenyl)propyl}benzene, and particularly preferred are 2,2-bis(4-hydroxyphenyl)propane, 1,1-bis(4-hydroxyphenyl)cyclohexane, 4,4′-sulfonyldiphenol, and 9,9-bis(4-hydroxy-3-methylphenyl)fluorene. Among these, most suitable is 2,2-bis(4-hydroxyphenyl)propane having high strength and high durability. These may be used alone or in combination.

The aromatic polycarbonate resin (A1) may be a branched polycarbonate resin prepared by using the dihydroxy compound in combination with a branching agent.

Examples of polyfunctional aromatic compounds having three or more functionalities and used in the branched polycarbonate resin include phloroglucin, phloroglucide, or 4,6-dimethyl-2,4,6-tris(4-hydroxydiphenyl)heptene-2,2,4,6-trimethyl-2,4,6-tris(4-hydroxyphenyl)heptane, 1,3,5-tris(4-hydroxyphenyl)benzene, 1,1,1-tris(4-hydroxyphenyl)ethane, 1,1,1-tris(3,5-dimethyl-4-hydroxyphenyl)ethane, 2,6-bis(2-hydroxy-5-methylbenzyl)-4-methylphenol, and 4-{4-[1,1-bis(4-hydroxyphenyl)ethyl]benzene}-α,α-dimethylbenzylphenol, tetra(4-hydroxyphenyl)methane, bis(2,4-dihydroxyphenyl)ketone, 1,4-bis(4,4-dihydroxytriphenylmethyl)benzene, or trimellitic acid, pyromellitic acid, benzophenone tetracarboxylic acid, and acid chlorides thereof. Among these, preferred are 1,1,1-tris(4-hydroxyphenyl)ethane and 1,1,1-tris(3,5-dimethyl-4-hydroxyphenyl)ethane, and particularly preferred is 1,1,1-tris(4-hydroxyphenyl)ethane.

These aromatic polycarbonate resins are produced by a standard known per se reaction method of producing an aromatic polycarbonate resin, for example, a method of reacting an aromatic dihydroxy component with a carbonate precursor substance such as phosgene or a carbonic diester. The basic method of the production method will be simply described.

In a reaction using phosgene as a carbonate precursor substance, usually the reaction is performed in the presence of an acid bonding agent and a solvent. The acid bonding agent to be used is an alkali metal hydroxide such as sodium hydroxide or potassium hydroxide or an amine compound such as pyridine, for example. The solvent to be used is a halogenated hydrocarbon such as methylene chloride or chlorobenzene, for example. To promote the reaction, for example, a catalyst such as a tertiary amine or a quaternary ammonium salt can also be used. At this time, the reaction temperature is usually 0 to 40° C., the reaction time is several minutes to 5 hours.

A transesterification reaction using a carbonic diester as the carbonate precursor substance is performed by a method of stirring the aromatic dihydroxy component and a carbonic diester with heating under an inert gas atmosphere to distill away the generated alcohol or phenols. Although the reaction temperature varies according to the boiling point of the generated alcohol or phenols, the reaction temperature is usually in the range of 120 to 300° C. The reaction is completed while the generated alcohol or phenols are distilled away under reduced pressure from the initial stage of the reaction. To promote the reaction, a catalyst usually used in the transesterification reaction can also be used.

Examples of the carbonic diester used in the transesterification reaction include diphenyl carbonate, dinaphthyl carbonate, bis(diphenyl)carbonate, dimethyl carbonate, diethyl carbonate, and dibutyl carbonate. Among these, particularly preferred is diphenyl carbonate.

In the present disclosure, a terminal terminator can be used in the polymerization reaction. The terminal terminator is used to control the molecular weight. The resulting aromatic polycarbonate resin has capped terminals, and thus higher thermal stability than those not having capped terminals. Examples of the terminal terminator include monofunctional phenols represented by the following formulae (2) to (4):

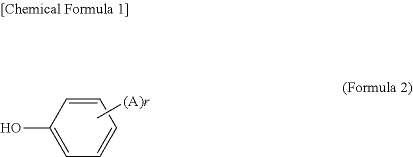

[In formula (2), A is a hydrogen atom, an alkyl group having 1 to 9 carbon atoms, an alkylphenyl group (the alkyl moiety has 1 to 9 carbon atoms), a phenyl group, or a phenylalkyl group (the alkyl moiety has 1 to 9 carbon atoms), and r is an integer of 1 to 5 (preferably 1 to 3)].

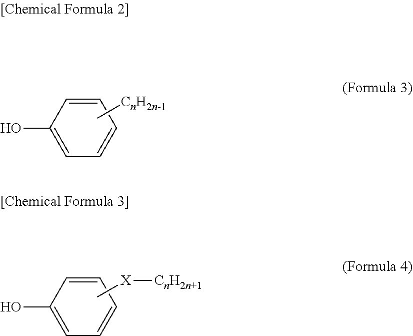

[In formulae (3) and (4), X is —R—O—, —R—CO—O—, or —R—O—CO—, where R represents a single bond or a divalent aliphatic hydrocarbon group having 1 to 10 (preferably 1 to 5) carbon atoms and n represents an integer of 10 to 50.]

Specific examples of the monofunctional phenols represented by the general formula (2) include phenol, isopropylphenol, p-tert-butylphenol, p-cresol, p-cumylphenol, 2-phenylphenol, 4-phenylphenol, and isooctylphenol.

The monofunctional phenols represented by the general formulae (3) and (4) are phenols having a long-chain alkyl group or an aliphatic ester group as a substituent. If the terminals of the aromatic polycarbonate resin are capped using these, these not only function as a terminal terminator or a molecular weight modifier, but also improve the melt fluidity of the resin to facilitate molding process thereof. In addition, these have an effect of reducing the water absorption rate of the resin. For these reasons, these phenols are preferably used.

The substituted phenols represented by the general formula (3) are those where n is 10 to 30, particularly preferably those where n is 10 to 26. Specific examples thereof include decylphenol, dodecylphenol, tetradecylphenol, hexadecylphenol, octadecylphenol, eicosylphenol, docosylphenol, and triacontylphenol.

The substituted phenols represented by the general formula (4) are suitably compounds where X is —R—CO—O— and R is a single bond, those where n is 10 to 30, particularly suitably those where n is 10 to 26. Specific examples thereof include decyl hydroxybenzoate, dodecyl hydroxybenzoate, tetradecyl hydroxybenzoate, hexadecyl hydroxybenzoate, eicosyl hydroxybenzoate, docosyl hydroxybenzoate, and triacontyl hydroxybenzoate.

Among these monofunctional phenols, preferred are the monofunctional phenols represented by the general formula (2), more preferred are alkyl- or phenylalkyl substituted phenols, and particularly preferred is p-tert-butylphenol, p-cumylphenol, or 2-phenylphenol.

These monofunctional phenol terminal terminators are desirably introduced into at least 5 mol %, preferably at least 10 mol % of the total terminals of the resulting aromatic polycarbonate resin. These terminal terminators may be used alone or in combination in the form of a mixture.

The aromatic polycarbonate resin (A1) may be a polyester carbonate prepared by copolymerizing an aromatic dicarboxylic acid, such as terephthalic acid, isophthalic acid, naphthalene dicarboxylic acid, or a derivative thereof, in the range not impairing the gist of the present disclosure.

The aromatic polycarbonate resin (A1) can have any viscosity average molecular weight without limitation. To be noted, a viscosity average molecular weight of less than 10000 reduces strength and the like and a viscosity average molecular weight of more than 50000 reduces molding processing properties. Thus, the viscosity average molecular weight is in the range of preferably 10000 to 50000, more preferably 12000 to 30000, still more preferably 15000 to 28000. The viscosity average molecular weight in the present disclosure is determined as follows: first, the specific viscosity to be calculated from the following expression is determined using an Ostwald viscometer from a solution of 0.7 g of the aromatic polycarbonate resin dissolved in 100 mL of methylene chloride at 20° C., and the determined specific viscosity is substituted into another expression below to determine the viscosity average molecular weight Mv:

Specific viscosity (η_{SP})=(t−t₀)/t₀

wherein to is the dropping time (in seconds) of methylene chloride, and t is the dropping time (in seconds) of the sample solution,
η_{SP}/c=[η]+0.45×[η]^{2c}, where [η] is the limiting viscosity,
[η]=1.23×10⁻⁴ Mv^{0.83}, and
c=0.7.

The total chlorine content in the aromatic polycarbonate resin (A1) is preferably 0 to 200 ppm, more preferably 0 to 150 ppm. A total chlorine content of more than 200 ppm in the aromatic polycarbonate resin is not preferable because of reduced hue and thermal stability.

(Styrene-Based Resin (A2))

Examples of the main component for the styrene-based resin (A2) according to the present embodiment include polystyrene resins (PSs), impact-resistant polystyrene resins (HIPSs), copolymers (MSs) of alkyl (meth)acrylate monomers with aromatic vinyl monomers, copolymers (ASs) of vinyl cyanide compounds with aromatic vinyl compounds, copolymers (ABSs) of vinyl cyanide compounds containing a diene rubber component with aromatic vinyl compounds, copolymers (AESs) of vinyl cyanide compounds containing an ethylene-α-olefin rubber component with aromatic vinyl compounds, copolymers (ASAs) of vinyl cyanide compounds containing an acrylic rubber component with aromatic vinyl compounds, copolymers (MBSs) of alkyl (meth)acrylate monomers containing a diene rubber component with aromatic vinyl compounds, copolymers (MABSs) of alkyl (meth)acrylate monomers containing a diene rubber component with vinyl cyanide compounds and aromatic vinyl compounds, and copolymer (MASs) of alkyl (meth)acrylate monomers containing an acrylic rubber component with aromatic vinyl compounds.

The main component indicates a component having the largest mass. The content of the main component in the styrene-based resin (A2) is preferably 90% by mass or more, more preferably 95% by mass or more.

The styrene-based resin (A2) may be a resin which is prepared in the presence of a catalyst such as a metallocene catalyst during production and has high stereoregularity, such as syndiotactic polystyrene. Alternatively, the styrene-based resin (A2) may be a polymer, a copolymer, and a block copolymer prepared by a method such as anionic living polymerization or radical living polymerization and having a narrow molecular weight distribution, and a polymer and a copolymer having high stereoregularity.

The polystyrene resin (PS) is a polymer prepared by polymerizing at least one aromatic vinyl compound by a polymerization method such as solution polymerization, bulk polymerization, suspension polymerization, or bulk-suspension polymerization. Examples of preferred aromatic vinyl compounds include styrene, alkylstyrenes such as α-methylstyrene, methylstyrene, ethylstyrene, isopropylstyrene, and tertiary-butylstyrene, phenylstyrene, vinylstyrene, chlorostyrene, bromostyrene, fluorostyrene, chloromethylstyrene, methoxystyrene, and ethoxystyrene. These can be used alone or in combination. Among these, particularly preferred aromatic vinyl compounds are styrene, p-methylstyrene, m-methylstyrene, p-tertiary-butylstyrene, p-chlorostyrene, m-chlorostyrene, and p-fluorostyrene, and particularly preferred is styrene.

The polystyrene resin (PS) can have any molecular weight without limitation. The mass average molecular weight measured against polystyrene standards by gel permeation chromatography (GPC) at 135° C. using trichlorobenzene as a solvent is preferably 100,000 or more, more preferably 150,000 or more. The molecular weight distribution can have any broadness.

The impact-resistant polystyrene resin (HIPS) is a polymer prepared by dispersing a rubber-like polymer made of, for example, butadiene rubber in the form of particles in a matrix made of an aromatic vinyl polymer such as PS. HIPS can be prepared, for example, by dissolving a rubber-like polymer in a mixed solution of an aromatic vinyl monomer and an inert solvent, and performing bulk polymerization, suspension polymerization, or solution polymerization with stirring. Alternatively, HIPS may be a mixture of a polymer prepared by dissolving a rubber-like polymer in a mixed solution of an aromatic vinyl monomer and an inert solvent with another aromatic vinyl polymer separately prepared, for example.

Although the matrix moiety made of the aromatic vinyl polymer in HIPS is not particularly limited, the mass average molecular weight measured against polystyrene standards by gel permeation chromatography (GPC) at 135° C. using trichlorobenzene as a solvent is preferably 100,000 or more, more preferably 150,000 or more. Although not particularly limited, generally the average particle diameter of the rubber-like polymer is appropriately 0.4 to 6.0 μm.

Styrene and derivatives thereof (such as o-methylstyrene, m-methylstyrene, p-methylstyrene, and 2,4-dimethylstyrene) can be used as the aromatic vinyl monomer, and styrene is most suitable. These monomers can be used in combination.

Polybutadiene, polyisoprene, a styrene-butadiene copolymer, or the like can be used as the rubber-like polymer. Examples of the polybutadiene include high cis-polybutadienes having a large cis-bond content and low cis-polybutadienes having a small cis-bond content.

Among these, preferably used is a polybutadiene containing 70% by mass or more of a high cis-polybutadiene rubber in 100% by mass of the rubber-like polymer, the high cis-polybutadiene rubber containing 90 mol % or more of a cis-1,4-bond.

Specifically, it is preferred that 70% by mass or more of the high cis-polybutadiene rubber be contained in 100% by mass of the rubber-like polymer present in the rubber-modified styrene resin in any case of a rubber-modified styrene resin prepared using a high cis-polybutadiene rubber alone, a rubber-modified styrene resin prepared using a mixture of a high cis-polybutadiene rubber and a low cis-polybutadiene rubber, or a mixture of a rubber-modified styrene resin prepared using a high cis-polybutadiene rubber and a rubber-modified styrene resin prepared using a low cis-polybutadiene rubber. Here, the high cis-polybutadiene rubber indicates a polybutadiene rubber containing the cis-1,4-bond in the proportion of 90 mol % or more, for example. The low cis-polybutadiene rubber indicates a polybutadiene rubber containing the 1,4-cis-bond in the proportion of 10 to 40 mol %, for example.

In the copolymer (MS) of an alkyl (meth)acrylate monomer and an aromatic vinyl monomer, the alkyl (meth)acrylate monomer is at least one monomer selected from methyl (meth)acrylate and phenyl (meth)acrylate, for example. In particular, use of methyl (meth)acrylate is preferred. The expression “(meth)acrylate” encompasses both methacrylate and acrylate.

As the aromatic vinyl monomer, for example, styrene, α-methylstyrene, o-methylstyrene, p-methylstyrene, vinylxylene, ethylstyrene, dimethylstyrene, p-tert-butylstyrene, vinylnaphthalene, methoxystyrene can be used, and particularly styrene is preferred. These can be used alone or in combination.

Although the compositional ratio of the mass average molecular weight of the MS and methyl (meth)acrylate/styrene are not particularly limited, the mass average molecular weight is preferably 80000 to 300000, more preferably 100000 to 200000, and the compositional ratio of methyl (meth)acrylate/styrene is preferably 80/20 to 40/60, more preferably 70/30 to 50/50.

In the copolymer (AS) of a vinyl cyanide compound and an aromatic vinyl compound, particularly acrylonitrile can be preferably used as the vinyl cyanide compound. Styrene and α-methylstyrene can be preferably used as the aromatic vinyl compound.

For the proportions of the components in the AS where the total is 100% by mass, the proportion of the vinyl cyanide compound is preferably 5 to 50% by mass, more preferably 15 to 35% by mass, and the proportion of the aromatic vinyl compound is preferably 95 to 50% by mass, more preferably 85 to 65% by mass.

Furthermore, other copolymerizable vinyl compounds described above may be mixed with these vinyl compounds. In this case, the proportion of the other vinyl compounds contained is preferably 15% by mass or less in the AS.

Although the AS may be produced by any method of bulk polymerization, suspension polymerization, emulsion polymerization, and the like, the AS is preferably produced by bulk polymerization. The copolymerization method may be any one of one-stage copolymerization and multi-stage copolymerization.

The AS has a reduced viscosity of preferably 0.2 to 1.0 d/g (20 to 100 mL/g), more preferably 0.3 to 0.5 dL/g (30 to 50 mL/g). A reduced viscosity of less than 0.2 dL/g (20 mL/g) reduces the impact while a reduced viscosity of more than 1.0 dL/g (100 mL/g) reduces processability.

The reduced viscosity is measured as follows: A solution prepared by precisely weighing 0.25 g of a copolymer (AS) prepared by copolymerizing a vinyl cyanide compound and an aromatic vinyl compound, and dissolving the AS in 50 mL of dimethylformamide over 2 hours is measured under an environment at 30° C. using an Ubbelohde viscometer. In the viscometer used, the flow time of the solvent is 20 to 100 seconds. The reduced viscosity is determined from the flow time of the solvent in seconds (to) and the flow time of the solution in seconds (t) using the following expression:

reduced viscosity (ηₛₚ/C)={(t/t₀)−1}/0.5

The copolymer (ABS) of a vinyl cyanide compound containing a diene rubber component with an aromatic vinyl compound, the copolymer (AES) of a vinyl cyanide compound containing an ethylene-α-olefin rubber component with an aromatic vinyl compound, the copolymer (ASA) of a vinyl cyanide compound containing an acrylic rubber component with an aromatic vinyl compound, the copolymer (MBS) of an alkyl (meth)acrylate monomer containing a diene rubber component with an aromatic vinyl compound, the copolymer (MABS) of an alkyl (meth)acrylate monomer containing a diene rubber component with a vinyl cyanide compound and an aromatic vinyl compound, and the copolymer (MAS) of an alkyl (meth)acrylate monomer containing an acrylic rubber component with an aromatic vinyl compound are thermoplastic copolymers.

In the present embodiment, the proportions of a variety of rubber components contained in ABS, AES, ASA, MBS, MABS, and MAS each are preferably 5 to 80% by mass, more preferably 8 to 50% by mass, particularly preferably 10 to 30% by mass.

Acrylonitrile can be particularly preferably used as the vinyl cyanide compound grafted to the rubber component. Styrene and α-methylstyrene can be particularly preferably used as the aromatic vinyl compound grafted to the rubber component.

Furthermore, methyl (meth)acrylate and ethyl (meth)acrylate can be particularly preferably used as the alkyl (meth)acrylate monomer.

The proportion of the component grafted to the rubber component is preferably 20 to 95% by mass, more preferably 50 to 90% by mass relative to 100% by mass of the styrene-based resin (A2). Furthermore, maleic anhydride, N-substituted maleimide, or the like can be mixed and used as part of the component grafted to the rubber component, and the proportion of the content thereof is preferably 15% by mass or less in the styrene-based resin (A2).

The rubber component is present in the form of particles in ABS, AES, ASA, MBS, MABS, and MAS. The rubber component has a particle diameter of preferably 0.1 to 5.0 μm, more preferably 0.15 to 1.5 μm, particularly preferably 0.2 to 0.8 μm.

Here, the distribution of the particle diameter of the rubber component may be a monodistribution, or may have two or more peaks. In the morphology of the particle diameter of the rubber component, rubber particles may form a single phase, or rubber particles and an occlude phase contained therearound may form a salami-like structure.

ABS, AES, ASA, MBS, MABS, and MAS may contain a free polymer component (such as an aromatic vinyl compound) generated during polymerization.

The reduced viscosity (the reduced viscosity previously determined at 30° C. by the method described above) of ABS, AES, ASA, MBS, MABS, and MAS is preferably 0.2 to 1.0 dL/g (20 to 100 mL/g), more preferably 0.3 to 0.7 dL/g (30 to 70 mL/g).

The proportion (grafting rate) of the aromatic vinyl compound or the like grafted to the rubber component is preferably 20 to 200% by mass, more preferably 20 to 70% by mass relative to the rubber component.

ABS, AES, ASA, MBS, MABS, and MAS may be produced by any one method of bulk polymerization, suspension polymerization, and emulsion polymerization. In particular, preferred ABS is those produced by bulk polymerization. Examples of representative bulk polymerization methods include continuous bulk polymerization (the so-called Toray method) described in Kagakukougyou (1984), Vol. 48, No. 6, p. 415, and continuous bulk polymerization (the so-called Mitsui Toatsu method) described in Kagakukougyou (1989), Vol. 53, No. 6, p. 423.

In the present embodiment, ABS, AES, ASA, MBS, MABS, and MAS all can be suitably used as the styrene-based resin (A2). In the copolymerization method, copolymerization may be performed at one stage or at several stages. Moreover, resins prepared by blending the ABS, AES, ASA, MBS, MABS, and MAS prepared by such a method with a vinyl compound polymer prepared by separately copolymerizing an aromatic vinyl compound and a vinyl cyanide component and the like can also be preferably used as the styrene-based resin (A2).

A small content of an alkali (earth) metal in AS, ABS, AES, ASA, MBS, MABS, and MAS is preferred from the viewpoint of favorable thermal stability and hydrolysis resistance. The content of the alkali (earth) metal in the styrene-based resin (A2) is preferably less than 100 ppm, more preferably less than 80 ppm, more preferably less than 50 ppm, particularly preferably less than 10 ppm. Thus, bulk polymerization is suitably used to reduce the content of the alkali (earth) metal.

In association with such favorable thermal stability and hydrolysis resistance, if an emulsifier is used in AS and ABS, the emulsifier is suitably sulfonates, more suitably alkyl sulfonates. If a solidifying agent is used, the solidifying agent is suitably sulfuric acid or an alkaline earth metal salt of sulfuric acid.

Examples of the rubber component contained in ABS, AES, ASA, MBS, MABS, and MAS include polybutadiene, polyisoprene, diene copolymers, copolymers of ethylene and α-olefins, copolymers of ethylene and unsaturated carboxylic acid esters, copolymers of ethylene and aliphatic vinyls (such as ethylene-vinyl acetate copolymer), non-conjugated diene terpolymers of ethylene and propylene, acrylic rubbers, and silicone rubbers.

Examples of the diene copolymers include random copolymers of styrene-butadiene and block copolymers thereof, acrylonitrile-butadiene copolymers, and copolymers of alkyl (meth)acrylate esters and butadiene.

Examples of the copolymers of ethylene and α-olefins include ethylene-propylene random copolymers and block copolymers, and ethylene-butene random copolymers and block copolymers.

Examples of the copolymers of ethylene and unsaturated carboxylic acid esters include ethylene-methacrylate copolymers and ethylene-butyl acrylate copolymers.

Examples of the non-conjugated diene terpolymers of ethylene and propylene include ethylene-propylene-hexadiene copolymers.

Examples of the acrylic rubbers include polybutyl acrylate, poly(2-ethylhexyl acrylate), and copolymers of butyl acrylate and 2-ethylhexyl acrylate.

Examples of the silicone rubbers include polyorganosiloxane rubber, IPN-type rubbers (i.e., rubbers having a structure composed of two rubber components mutually entangled not to separate from each other) made of a polyorganosiloxane rubber component and a polyalkyl (meth)acrylate rubber component, and IPN-type rubbers made of a polyorganosiloxane rubber component and a polyisobutylene rubber component.

The rubber component is preferably selected from the group consisting of polydiene rubbers (such as polybutadiene), acrylic rubbers, and ethylene-propylene rubbers. For the glass transition temperature of the rubber component, for example, that of acrylic rubber is typically −10° C. to −20° C., that of the ethylene-propylene rubber is typically −50° C. to −58° C., and that of the butadiene rubber is typically about −100° C.

The content of the rubber component in the ABS, AES, ASA, MBS, MABS, and MAS used in the present embodiment is preferably 4% by mass to 25% by mass. The content of the rubber component can be adjusted by controlling the amount of the rubber component during copolymerization, for example. Alternatively, the content of the rubber component can also be adjusted by mixing an aromatic vinyl copolymer containing the rubber component with an aromatic vinyl polymer or copolymer not containing the rubber component, for example.

(Aromatic Polyester Resin (A3))

The aromatic polyester resin (A3) is a polymer or copolymer prepared by a condensation reaction in which an aromatic dicarboxylic acid or a reactive derivative thereof and a diol or an ester derivative thereof are used as main components.

Examples of the aromatic dicarboxylic acid mentioned here include aromatic dicarboxylic acids such as terephthalic acid, isophthalic acid, orthophthalic acid, 1,5-naphthalenedicarboxylic acid, 2,6-naphthalenedicarboxylic acid, 4,4′-biphenyldicarboxylic acid, 4,4′-biphenyletherdicarboxylic acid, 4,4′-biphenylmethanedicarboxylic acid, 4,4′-biphenylsulfonedicarboxylic acid, 4,4′-biphenylisopropylidenedicarboxylic acid, 1,2-bis(phenoxy)ethane-4,4′-dicarboxylic acid, 2,5-anthracenedicarboxylic acid, 2,6-anthracenedicarboxylic acid, 4,4′-p-terphenylenedicarboxylic acid, and 2,5-pyridinedicarboxylic acid. Examples thereof also include diphenylmethanedicarboxylic acid, diphenyletherdicarboxylic acid, and (3-hydroxyethoxybenzoic acid. In particular, terephthalic acid and 2,6-naphthalenedicarboxylic acid can be preferably used. These aromatic dicarboxylic acids may be used in combination in the form of a mixture. To be noted, a small amount of one or more of an aliphatic dicarboxylic acid such as adipic acid, azelaic acid, sebacic acid, or dodecane diacid, an alicyclic dicarboxylic acid such as cyclohexanedicarboxylic acid, or the like can be mixed and used with the dicarboxylic acid.

Examples of the diol include aliphatic diols such as ethylene glycol, propylene glycol, butylene glycol, hexylene glycol, neopentyl glycol, pentamethylene glycol, hexamethylene glycol, decamethylene glycol, 2-methyl-1,3-propanediol, diethylene glycol, and triethylene glycol.

Examples thereof also include alicyclic diols such as 1,4-cyclohexanedimethanol. Examples thereof include diols having an aromatic ring, such as 2,2-bis(P-hydroxyethoxyphenyl)propane, and mixtures thereof. Furthermore, a small amount of a long-chain diol having a molecular weight of 400 to 6000, that is, one or more of polyethylene glycol, poly-1,3-propylene glycol, polytetramethylene glycol, and the like may be copolymerized.

The aromatic polyester resin (A3) can be branched by introducing a small amount of a branching agent. Any branching agent can be used, and examples thereof include trimesic acid, trimellitic acid, trimethylolethane, trimethylolpropane, and pentaerythritol.

Examples of the aromatic polyester resin (A3) include polyethylene terephthalate (PET), polytrimethylene terephthalate, polybutylene terephthalate (PBT), polyhexylene terephthalate, polyethylene naphthalate (PEN), polybutylene naphthalate (PBN), and polyethylene-1,2-bis(phenoxy)ethane-4,4′-dicarboxylate. Examples thereof also include copolymerized polyester resins such as polyethylene isophthalate/terephthalate and polybutylene terephthalate/isophthalate. Among these, polyethylene terephthalate, polybutylene terephthalate, polyethylene naphthalate, and polybutylene naphthalate having well-balanced mechanical properties and mixtures thereof can be preferably used.

The terminal group structure of the aromatic polyester resin (A3) is not particularly limited. The proportions of the hydroxyl group and the carboxyl group in the terminal group may be substantially equal, or the proportion of one of them may be higher. A compound reactive with such a terminal group may be reacted to cap the terminal group.

Although an alkylene glycol ester of an aromatic dicarboxylic acid and/or a low polymer thereof can be produced by any production method, the alkylene glycol ester of an aromatic dicarboxylic acid and/or a low polymer thereof is usually produced by reacting an aromatic dicarboxylic acid or an ester formable derivative thereof with an alkylene glycol or an ester formable derivative thereof under heating. For example, an ethylene glycol ester of terephthalic acid and/or a low polymer thereof used as a raw material for polyethylene terephthalate is produced by a direct esterification reaction of terephthalic acid with ethylene glycol, by a transesterification reaction of a lower alkyl ester of terephthalic acid with ethylene glycol, or by an addition reaction of ethylene oxide to terephthalic acid.

The alkylene glycol ester of an aromatic dicarboxylic acid and/or a low polymer thereof may contain another dicarboxylic acid ester copolymerizable therewith as an additional component in the range not substantially impairing the effect of the method according to the present disclosure. Specifically, another dicarboxylic acid ester may be contained in the range of 10 mol % or less, preferably 5 mol % or less relative to the total molar amount of the acid components.

The additional copolymerizable component is selected from the group consisting of esters of acid components and glycol components and anhydrides thereof. Examples of the acid components include one or more of aliphatic and alicyclic dicarboxylic acids such as adipic acid, sebacic acid, and 1,4-cyclohexanedicarboxylic acid, and hydroxycarboxylic acids such as p-hydroxyethoxybenzoic acid and p-oxybenzoic acid.

Examples of the glycol components include alkylene glycols having two or more carbon atoms, aliphatic, alicyclic, and aromatic diol compounds such as 1,4-cyclohexanedimethanol, neopentyl glycol, bisphenol A, and bisphenol S, and polyoxyalkylene glycol. These component esters may be used alone or in combination. The copolymerization amount thereof is preferably within the range specified above.

If terephthalic acid and/or dimethyl terephthalate is used as a starting raw material, a recovered dimethyl terephthalate prepared by depolymerization of polyalkylene terephthalate or a recovered terephthalic acid prepared by hydrolysis thereof can be used in an amount of 70% by mass or more relative to the mass of the total acid components which form polyester. In this case, the target polyalkylene terephthalate is preferably polyethylene terephthalate. In particular, use of recovered PET bottles, recovered fiber products, recovered polyester film products, and further polymer wastes generated in the production process of the products as raw material sources for production of polyester is preferred from the viewpoint of effective utilization of resources.

Here, the method of depolymerizing the recovered polyalkylene terephthalate to yield dimethyl terephthalate is not particularly limited, and any conventionally known method can be used. For example, the recovered polyalkylene terephthalate is depolymerizing in the presence of ethylene glycol, and the depolymerized product is fed to a transesterification reaction with a lower alcohol, such as methanol. This reaction mixture is refined to recover a lower alkyl ester of terephthalic acid, which is fed to a transesterification reaction with alkylene glycol. Th resulting phthalic acid/alkylene glycol ester is polycondensed. Thereby, a polyester resin can be yielded.

The method of recovering terephthalic acid from the recovered dimethyl terephthalate is not particularly limited, and any conventional method can be used. For example, dimethyl terephthalate is recovered from the reaction mixture obtained by a transesterification reaction by recrystallization and/or distillation, and is hydrolyzed by heating with water at a high temperature under pressure to recover terephthalic acid. In impurities contained in the terephthalic acid yielded by the method, the total content of 4-carboxybenzaldehyde, paratoluic acid, benzoic acid, and hydroxydimethyl terephthalate is preferably 1 ppm or less. The content of monomethyl terephthalate is preferably in the range of 1 to 5000 ppm.

The terephthalic acid recovered by the above method is subjected to a direct esterification reaction with alkylene glycol, and the resulting ester is polycondensed. Thereby, a polyester resin can be produced.

The production reaction condition for the aromatic polyester resin (A3) is also not particularly limited. Usually, the polycondensation reaction is preferably performed for 15 to 300 minutes under a temperature of 230 to 320° C. or under normal pressure or reduced pressure (0.1 Pa to 0.1 MPa) or under a combined condition thereof.

In the aromatic polyester resin (A3), an optional reaction stabilizer, such as trimethyl phosphate, may be added to the reaction system at any stage of the production of polyester. Furthermore, one or more of an antioxidant, an ultraviolet absorbing agent, a flame retardant, fluorescent brightener, a matting agent, a color adjuster, an antifoaming agent, and other additives may be compounded with the reaction system as needed. In particular, the polyester resin preferably contains an antioxidant containing at least one hindered phenol compound. The content is preferably 1% by mass or less relative to the mass of the polyester resin. If the content exceeds 1% by mass, it may cause a problem that the quality of the resulting product is reduced by thermal degradation of the antioxidant itself.

Examples of the hindered phenol compound include pentaerythritol-tetrakis[3-(3,5-di-tert-butyl-4-hydroxyphenyl)propionate], and 3,9-bis{2-[3-(3-tert-butyl-4-hydroxy-5-methylphenyl)propionyloxy]-1,1-dimethylethyl}-2,4,8,10-tetraoxaspiro[5,5]undecane. Combinations of these hindered phenol-based antioxidants with thioether secondary antioxidants are preferably used.

Although the method of adding the hindered phenol-based antioxidant to the polyester resin is not particularly limited, the hindered phenol-based antioxidant is preferably added after the end of the transesterification reaction or the esterification reaction or at any stage before the polymerization reaction is completed.

Although not limited, the aromatic polyester resin (A3) preferably has an intrinsic viscosity in the range of 0.30 to 1.5. An intrinsic viscosity within this range facilitates melt molding and results in high strength of the molded article prepared therefrom. A more preferred range of the intrinsic viscosity is 0.40 to 1.2, particularly preferably 0.50 to 1.0. The intrinsic viscosity of the aromatic polyester resin is measured by dissolving an aromatic polyester resin in orthochlorophenol and measuring the solution at a temperature of 35° C. To be noted, usually the polyester resin yielded by solid phase polycondensation is often used in bottles and the like, and often has an intrinsic viscosity of 0.70 to 0.90.

Preferably, the content of a cyclic trimer of the ester of the aromatic dicarboxylic acid and the alkylene glycol above is 0.5% by mass or less and the content of acetaldehyde is 5 ppm or less.

The cyclic trimer includes alkylene terephthalates (such as ethylene terephthalate, trimethylene terephthalate, tetramethylene terephthalate, and hexamethylene terephthalate) and alkylene naphthalates (such as ethylene naphthalate, trimethylene naphthalate, tetramethylene naphthalate, and hexamethylene naphthalate).

(Polyphenylene Ether Resin (A4))

The polyphenylene ether resin (A4) may be a mixed resin of a polyphenylene ether resin premixed with a polystyrene resin, or may be composed of only a polyphenylene ether resin.

Examples of the polyphenylene ether resin include a homopolymer having a repeating unit structure represented by the following formula (5) and a copolymer having a repeating unit structure represented by the following formula (5):

[Chemical Formula 4]

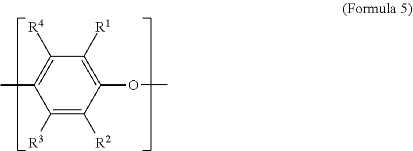

In the formula (5), R¹, R², R³, and R⁴ each independently are a monovalent group selected from the group consisting of a hydrogen atom, halogen atoms, primary alkyl groups having 1 to 7 carbon atoms, secondary alkyl groups having 1 to 7 carbon atoms, a phenyl group, haloalkyl groups, aminoalkyl groups, hydrocarbonoxy groups, and halohydrocarbonoxy groups having at least two carbon atoms which separate a halogen atom from an oxygen atom.

From the viewpoint of fluidity, toughness, and resistance against chemicals during processing, the reduced viscosity of the polyphenylene ether resin, which is measured using a 0.5 g/dL chloroform solution under a condition at 30° C. with an Ubbelohde viscosity tube, is preferably 0.15 to 2.0 dL/g, more preferably 0.20 to 1.0 dL/g, still more preferably 0.30 to 0.70 dL/g.

Examples of the polyphenylene ether resin include, but should not be limited to, homopolymers such as poly(2,6-dimethyl-1,4-phenylene ether), poly(2-methyl-6-ethyl-1,4-phenylene ether), poly(2-methyl-6-phenyl-1,4-phenylene ether), and poly(2,6-dichloro-1,4-phenylene ether); and copolymers of copolymers of 2,6-dimethylphenol and other phenols (such as 2,3,6-trimethylphenol and 2-methyl-6-butylphenol). Among these, preferred are poly(2,6-dimethyl-1,4-phenylene ether) and a copolymer of 2,6-dimethylphenol and 2,3,6-trimethylphenol, and more preferred is poly(2,6-dimethyl-1,4-phenylene ether) from the viewpoint of the balance between the toughness and the rigidity of the resulting resin composition and availability of raw materials.

The polyphenylene ether resin can be produced by a known method. Examples of the method of producing the polyphenylene ether resin include, but should not be limited to, the method according to Hay described in the specification of U.S. Pat. No. 3,306,874 in which 2,6-xylenol is subjected to oxidation polymerization in the presence of a complex of a cuprous salt and amine as a catalyst; and methods described in the specifications of U.S. Pat. Nos. 3,306,875, 3,257,357, and 3,257,358; and those described in Japanese Patent Publication No. 52-17880, and Japanese Patent Application Laying-Open Nos. 50-51197 and 63-152628.

Examples of the polystyrene resin preliminarily contained in the polyphenylene ether resin (A4) include atactic polystyrenes, rubber-reinforced polystyrenes (high impact polystyrenes, HIPSs), styrene-acrylonitrile copolymers (ASs) having 50% by mass or more of styrene content, and ABS resins prepared by reinforcing the styrene-acrylonitrile copolymer with rubber. Atactic polystyrenes and/or high impact polystyrenes are preferred.

These polystyrene resins may be used alone or in combination.

Preferably, the polyphenylene ether resin (A4) to be used is a polyphenylene ether resin (A4) comprising a polyphenylene ether resin and a polystyrene resin and having a mass proportion of the polyphenylene ether resin to the polystyrene resin of 97/3 to 5/95. The mass proportion of the polyphenylene ether resin to the polystyrene resin is more preferably 90/10 to 10/90, still more preferably 80/20 to 10/90 from the viewpoint of higher fluidity.

(Methacrylic Resin (A5))

The methacrylic resin (A5) used in the present disclosure is substantially a copolymer with alkyl methacrylate or alkyl acrylate, and another vinyl monomer not containing an aromatic vinyl monomer can be copolymerized in the range not impairing the object of the present disclosure.

The methacrylic resin is a polymer prepared by polymerizing a monomer comprising 30 to 100% by mass of alkyl methacrylate, 0 to 70% by mass of an acrylate ester, and 0 to 49% by mass of another vinyl monomer which is copolymerizable with these and does not contain an aromatic vinyl monomer. If the methacrylic resin is a copolymer of an alkyl methacrylate and an alkyl acrylate, for the mass proportion of the alkyl methacrylate to the alkyl acrylate, the mass proportion of the alkyl methacrylate is preferably 40 to 90% by mass, more preferably 10 to 60% by mass, and that of the alkyl methacrylate is preferably 50 to 85% by mass, more preferably 50 to 15% by mass relative to 100% by mass of the total of the alkyl methacrylate and the alkyl acrylate.

The alkyl methacrylate may have an alkyl group having about 1 to 8 carbon atoms. Examples thereof include methyl methacrylate, ethyl methacrylate, n-butyl methacrylate, t-butyl methacrylate, and 2-ethylhexyl methacrylate. Among these, methyl methacrylate is preferred. These alkyl methacrylates may be used in combination as needed.

The alkyl acrylate may have an alkyl group having about 1 to 8 carbon atoms. Examples thereof include methyl acrylate, ethyl acrylate, n-butyl acrylate, t-butyl acrylate, and 2-ethylhexyl acrylate. Among these, methyl acrylate and n-butyl acrylate are preferred. These alkyl acrylates may be used in combination as needed. In this case, it is preferred that n-butyl acrylate be used as a main component and one or more alkyl acrylates other than n-butyl acrylate be used, and it is more preferred that n-butyl acrylate and methyl acrylate be used and n-butyl acrylate be the main component. Here, the expression “n-butyl acrylate is the main component” indicates that the mass proportion of n-butyl acrylate is more than 50% by mass relative to 100% by mass of the total of two or more alkyl acrylates.

Another monomer not including alkyl methacrylate, alkyl acrylate, and the aromatic vinyl monomer may be a monofunctional monomer, i.e., a compound having one polymerizable carbon-carbon double bond in the molecule, or may be a polyfunctional monomer, i.e., a compound having at least two polymerizable carbon-carbon double bonds in the molecule.

Examples of the monofunctional monomer include cyanated alkenyls such as acrylonitriles and methacrylonitriles, acrylic acid, methacrylic acid, maleic anhydride, and N-substituted maleimide.

Examples of the polyfunctional monomer include polyunsaturated carboxylic acid esters of polyhydric alcohols, such as ethylene glycol dimethacrylate, butanediol dimethacrylate, and trimethylolpropane triacrylate; alkenyl esters of unsaturated carboxylic acids, such as allyl acrylates, allyl methacrylates, and allyl cinnamates; and polyalkenyl esters of polybasic acid, such as diallyl phthalates, diallyl maleates, triallyl cyanurate, and triallyl isocyanurate. These monomers other than alkyl methacrylate, alkyl acrylate, and aromatic vinyls may be used in combination as needed.

One or two or more of the methacrylic resins maybe used. In the two or more methacrylic resins, the methacrylic resins may be composed of different monomers, or may be composed of the same monomer in different mass proportions of the monomer.

The method of polymerizing the methacrylic resin is not particularly limited, and the methacrylic resin can be polymerized by a standard method such as bulk polymerization, suspension polymerization, or emulsion polymerization.

The methacrylic resin to be used can also be a so-called high impact methacrylic resin to which rubber particles are preliminarily compounded. Generally, these high impact methacrylic resins contain 5 to 40% by mass of a rubber component.

Although not particularly limited, the compounded rubber component suitably has a refractive index close to that of the methacrylic resin. Examples thereof include diene graft copolymers containing butadiene as the main component, rubber-like polymers having a core-shell type graft structure and containing an acrylate ester/a methacrylate ester as the main component, and rubber-like polymers grafted to enlarged particles.

The methacrylic resin (B) has an MFR value (230° C., load: 3.8 kg) of preferably 5 to 25 g/10 min, more preferably 10 to 20 g/10 min.

(Polyarylene Sulfide Resin (A6))

The polyarylene sulfide resin (A6) has a resin structure composed of a repeating unit having a structure in which arylene is bonded to a sulfur atom. The polyarylene sulfide resin includes the repeating unit represented by the following formula (6):

[Chemical Formula 5]

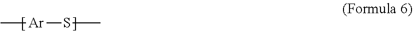

In the above formula (6), Ar is a substituted or non-substituted arylene. Examples of the arylene include, but should not be limited to, phenylene, naphthylene, biphenylene, and terphenylene.

If Ar has a substituent, examples of the substituent include, but should not be limited to, alkyl groups such as a methyl group, an ethyl group, a propyl group, an isopropyl group, a butyl group, an isobutyl group, a sec-butyl group, and a tert-butyl group; alkoxy groups such as a methoxy group, an ethoxy group, a propyloxy group, an isopropyloxy group, a butoxy group, an isobutyloxy group, a sec-butyloxy group, and a tert-butyloxy group; a nitro group; an amino group; and a cyano group.

Ar may have a single substituent, or may have two or more substituents. If Ar has two or more substituents, the substituents may be the same or different.

Among these polyarylene sulfide resins described above, preferred is a polyphenylene sulfide resin (PPS resin) where Ar is a substituted or non-substituted phenylene. The PPS resin includes at least one of the repeating units represented by the following formulae (7) and (8):

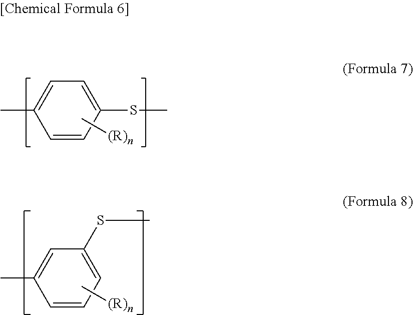

In the above formulae (7) and (8), examples of R each independently include alkyl groups such as a methyl group, an ethyl group, a propyl group, an isopropyl group, a butyl group, an isobutyl group, a sec-butyl group, and a tert-butyl group; alkoxy groups such as a methoxy group, an ethoxy group, a propyloxy group, an isopropyloxy group, a butoxy group, an isobutyloxy group, a sec-butyloxy group, and a tert-butyloxy group; a nitro group; an amino group; and a cyano group.

n is an integer of 0 to 4, preferably 0 to 2, more preferably 0 or 1, still more preferably 0. If n is 0, mechanical strength can be enhanced.

Among those described above, the PPS resin preferably includes the repeating unit represented by the formula (7) from the viewpoint of heat resistance, crystallinity, and the like.

The PPS resin may include a trifunctional structural unit represented by the following formula (9):

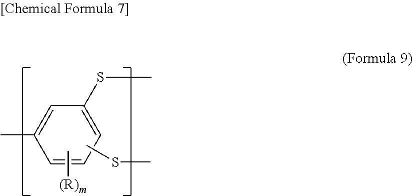

In the above formula (9), R is the same as that in the above formulae (7) and (8).

m is an integer of 0 to 3, preferably 0 to 2, more preferably 0 or 1, still more preferably 0.

If the PPS resin includes the trifunctional structural unit represented by the above formula (9), the content of the PPS resin is preferably 0.001 to 3 mol %, more preferably 0.01 to 1 mol % relative to the total molar amount of all the structural units.

Furthermore, the PPS resin may include structural units represented by the following formulae (10) to (14):

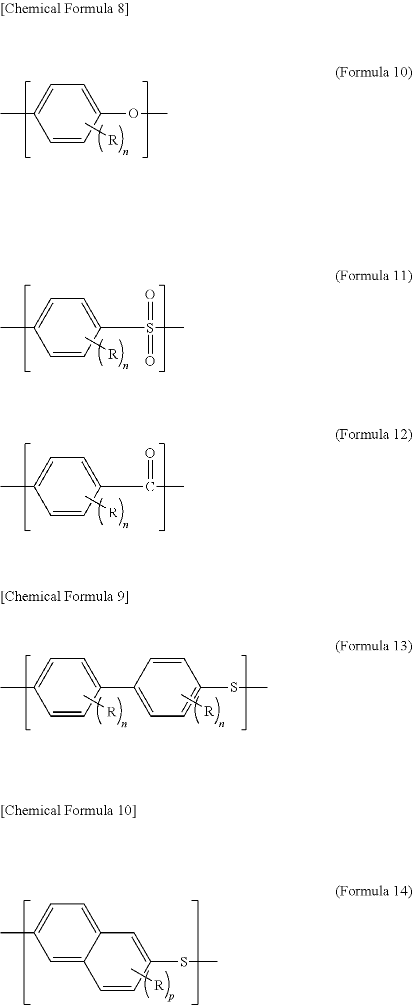

In the above formulae (10) to (14), R and n are the same as those in the above formula (7) and the like. p is an integer of 0 to 6, preferably 0 to 3, more preferably 0 or 1, still more preferably 0.

If the PPS resin includes the structural units represented by the above formulae (10) to (14), the content of the PPS resin is preferably 10 mol % or less, more preferably 5 mol % or less, still more preferably 3 mol % or less relative to the total structural units from the viewpoint of mechanical strength and the like. At this time, if the PPS resin includes two or more of the structural units represented by the above formulae (10) to (14), it is preferred that the total fall within the range of the content specified above.

These polyarylene sulfide resins described above may be used alone or in combination.

The polyarylene sulfide resin maybe linear or maybe branched. In an embodiment, a branched polyarylene sulfide resin can be obtained by heating a linear PAS resin in the presence of oxygen.

The polyarylene sulfide resin has a weight average molecular weight of preferably 25000 to 80000, more preferably 25000 to 50000. A weight average molecular weight of 25000 or more is preferred because material strength can be retained. On the other hand, a weight average molecular weight of 80000 or less is preferred from the viewpoint of molding properties.

In this specification, the value of the “weight average molecular weight” to be used is a value measured by gel permeation chromatography. At this time, the conditions for measurement by gel permeation chromatography are specified as follows. Namely, using a high performance GPC HLC-8220 (manufactured by Tosoh Corporation) and columns (TSK-GELGMHX L×2), 200 mL of a solution prepared by dissolving 5 mg of a sample in 10 g of tetrahydrofuran (THF) is injected into the apparatus to measure the weight average molecular weight at a flow rate of 1 mL/min (THF) and a thermostat temperature of 40° C. with a reflective index (RI) detector.

The melt viscosity of the polyarylene sulfide resin measured at 300° C. is preferably 2 to 1000 Pa·s, more preferably 10 to 500 Pa·s, still more preferably 60 to 200 Pa·s. A melt viscosity of 2 Pa·s or more is preferred because material strength can be retained. On the other hand, a melt viscosity of 1000 Pa·s or less is preferred from the viewpoint of molding properties.

The non-Newtonian index of the polyarylene sulfide resin is preferably 0.90 to 2.00, more preferably 0.90 to 1.50, still more preferably 0.95 to 1.20. A non-Newtonian index value of 0.90 or more is preferred because material strength can be retained. On the other hand, a non-Newtonian index of 2.00 or less is preferred from the viewpoint of molding properties.

The polyarylene sulfide resin can be produced by a known method. Examples thereof include (1) a method of polymerizing a dibalogenoaromatic compound in the presence of sulfur and sodium carbonate with a polyhalogenoaromatic compound or other copolymerization components added as needed, (2) a method of polymerizing a dihalogenoaromatic compound in a polar solvent in the presence of a sulfidating agent with a polyhalogenoaromatic compound or other copolymerization components added as needed, and (3) a method of self-condensing p-chlorothiophenol with other copolymerization components added as needed.

Among these methods, the method (2) is versatile and preferred. In the reaction, an alkali metal salt of carboxylic acid or sulfonic acid may be added or an alkali hydroxide may be added to control the degree of polymerization.

In the method (2) above, particularly preferred is

(a) a method of introducing a hydrous sulfidating agent to a mixture of a heated organic polar solvent and a dihalogenoaromatic compound at a rate such that water can be removed from the reaction mixture, reacting the dihalogenoaromatic compound and the sulfidating agent in the organic polar solvent with a polyhalogenoaromatic compound added as needed, and controlling the water content in the reaction system to the range of 0.02 to 0.5 mol relative to 1 mol of the organic polar solvent to produce a PAS resin (see Japanese Patent Application Laying-Open No. 07-228699), or
(b) a method of reacting a dihalogenoaromatic compound with an alkali metal hydrosulfide and an alkali metal salt of an organic acid in the presence of a solid alkali metal sulfide and an aprotic polar organic solvent with a polyhalogenoaromatic compound and other copolymerization components added as needed, while the alkali metal salt of an organic acid is being controlled to 0.01 to 0.9 mol relative to 1 mol of a sulfur source and the water content in the reaction system is being controlled in the range of 0.02 mol relative to 1 mol of the aprotic polar organic solvent (see WO 2010/058713).

Examples of the dihalogenoaromatic compound include, but should not be limited to, p-dihalobenzene, m-dihalobenzene, o-dihalobenzene, 2,5-dihalotoluene, 1,4-dihalonaphthalene, 1-methoxy-2,5-dihalobenzene, 4,4′-dihalobiphenyl, 3,5-dihalobenzoic acid, 2,4-dihalobenzoic acid, 2,5-dihalonitrobenzene, 2,4-dihalonitrobenzene, 2,4-dihaloanisole, p,p′-dihalodiphenylether, 4,4′-dihalobenzophenone, 4,4′-dihalodiphenylsulfone, 4,4′-dihalodiphenyl sulfoxide, 4,4′-dihalodiphenyl sulfide, and those compounds whose aromatic rings have an alkyl group having 1 to 18 carbon atoms. These dihalogenoaromatic compounds may be used alone or in combination.

Examples of the polyhalogenoaromatic compound include, but should not be limited to, 1,2,3-trihalobenzene, 1,2,4-trihalobenzene, 1,3,5-trihalobenzene, 1,2,3,5-tetrahalobenzene, 1,2,4,5-tetrahalobenzene, and 1,4,6-trihhalonaphthalene. These polyhalogenoaromatic compounds may be used alone or in combination.

The halogen atom contained in each compound is preferably a chlorine or bromine atom.

Examples of the method of post-treating the resulting reaction mixture yielded in the polymerization step and containing the polyarylene sulfide resin include, but should not be limited to:

(1) a method of distilling away the solvent under reduced pressure or normal pressure from the reaction mixture after the end of the polymerization reaction with or without adding an acid or a base, and then washing the solid product after the distillation of the solvent one time or two or more times with water, the reaction solvent (or an organic solvent having similar solubility to the low molecular polymer), or a solvent such as acetone, methyl ethyl ketone, or an alcohol, followed by neutralization, washing with water, filtration, and drying;
(2) a method of adding a solvent (a solvent which is soluble to the polymerization solvent used and is a poor solvent to at least polyarylene sulfide), such as water, acetone, methyl ethyl ketone, an alcohol, an ether, a halogenated hydrocarbon, an aromatic hydrocarbon, or an aliphatic hydrocarbon as a sedimentation agent to the reaction mixture after the end of the polymerization reaction to sediment solid products such as polyarylene sulfide and an inorganic salt, followed by filtration, washing, and drying;
(3) a method of adding the reaction solvent (or an organic solvent having similar solubility to the low molecular polymer) to the reaction mixture after the end of the polymerization reaction, stirring the reaction mixture, filtering the reaction mixture to remove the low molecular weight polymer, and washing the product with a solvent such as water, acetone, methyl ethyl ketone, or an alcohol one time or two or more times, followed by neutralization, washing with water, filtration, and drying;
(4) a method of adding water to the reaction mixture after the end of the polymerization reaction to wash the product with water, filtering the product, and optionally adding an acid during washing with water to perform an acid treatment, and drying the product; and
(5) a method of filtering the reaction mixture after the end of the polymerization reaction, and optionally washing the product with the reaction solvent one time or two or more times, followed by washing with water, filtration, and drying.

In the post-treatment methods exemplified in (1) to (5) above, the polyarylene sulfide resin may be dried in vacuum, in the air, or in an inert gas atmosphere of nitrogen or the like.

(Olefin Resin (A7))

The olefin resin (A) is a synthetic resin prepared by polymerizing or copolymerizing an olefin monomer having a radically polymerizable double bond.

Examples of the olefin monomer include, but should not be limited to, α-olefins and conjugated dienes. Examples of the α-olefins include ethylene, propylene, 1-butene, 1-pentene, 1-hexene, 1-heptene, 1-octene, and 4-methyl-1-pentene. Examples of the conjugated dienes include butadiene and isoprene. These olefin monomers may be used alone or in combination.

Examples of the olefin resin (A7) include, but should not be limited to, homopolymers of ethylene, copolymers of ethylene with α-olefins other than ethylene, homopolymers of propylene, copolymers of propylene with α-olefins other than propylene, homopolymers of butene, and homopolymers or copolymers of conjugated dienes such as butadiene and isoprene. The olefin resin (A7) is preferably a homopolymer of propylene or a copolymer of propylene with an α-olefin other than propylene.

If the olefin resin (A7) is a copolymer (polypropylene copolymer) of a propylene and another monomer, linear α-olefins and branched α-olefins can be suitably used as the α-olefin for copolymerization other than propylene. Examples of the linear olefins include ethylene, butene-1, pentene-1, hexene-1, heptene-1, and octene-1. Examples of the branched α-olefins include 2-methylpropene-1, 3-methylpentene-1, 4-methylpentene-1, 5-methylhexene-1, 4-methylhexene-1, and 4,4-dimethylpentene-1. These α-olefins for copolymerization may be used alone or in combination.

The compounding amount of these α-olefins (copolymerization components) for copolymerization in the olefin resin (A) is preferably 30% by mass or less, more preferably 20% by mass or less. The form of the copolymer prepared through copolymerization of these is not particularly limited, and may be any one of random, block, and graft types and mixed types of these, for example. The polypropylene copolymer (copolymer of propylene and another monomer) may be any one of a random copolymer and block copolymer usually used. Preferred examples of the polypropylene copolymer include propylene-ethylene copolymers, propylene-butene-1 copolymers, and propylene-ethylene-butene-1 copolymers.

The olefin resin (A7) to be used can also be a functional group-containing olefin resin prepared by introducing at least one functional group to the polypropylene polymer (polymer of a propylene monomer), the polypropylene copolymer, or the like, the functional group being selected from the group consisting of acid anhydride groups, a carboxyl group, a hydroxyl group, an amino group, and an isocyanate group.

(Polyamide Resin (A8))

The polyamide resin (A8) is a thermoplastic polymer having an amido bond, which polymer is made of amino acid, lactam, diamine, and dicarboxylic acid or an amide formable derivative thereof as the main constitutional raw material. A polycondensate prepared by condensing a diamine and a dicarboxylic acid or an acyl active form thereof can be used. A polymer prepared by polycondensing aminocarboxylic acid, lactam, or amino acid can also be used. These copolymers thereof can also be used.

Examples of the diamine include aliphatic diamines and aromatic diamines. Examples of the aliphatic diamines include tetramethylenediamine, hexamethylenediamine, undecamethylenediamine, dodecamethylenediamine, 2,2,4-trimethylhexamethylenediamine, 2,4,4-trimethylhexamethylenediamine, 5-methylnanomethylenediamine, 2,4-dimethyloctamethylenediamine, metaxylylenediamine, paraxylylenediamine, 1,3-bis(aminomethyl)cyclohexane, 1-amino-3-aminomethyl-3,5,5-trimethylcyclohexane, 3,8-bis(aminomethyl)tricyclodecane, bis(4-aminocyclohexyl)methane, bis(3-methyl-4-aminocyclohexyl)methane, 2,2-bis(4-aminocyclohexyl)propane, bis(aminopropyl)piperazine, and aminoethylpiperazine.

Examples of the aromatic diamines include p-phenylenediamine, m-phenylenediamine, 2,6-naphthalenediamine, 4,4′-diphenyldiamine, 3,4′-diphenyldiamine, 4,4′-diaminodiphenylether, 3,4′-diaminodiphenylether, 4,4′-sulfone, 3,4′-diaminodiphenylsulfone, 4,4′-diaminodiphenylketone, 3,4′-diaminodiphenylketone, and 2,2-bis(4-aminophenyl)propane.

Examples of the dicarboxylic acid include adipic acid, suberic acid, azelaic acid, sebacic acid, dodecanoic acid, terephthalic acid, isophthalic acid, naphthalene dicarboxylic acid, 2-chloroterephthalic acid, 2-methylterephthalic acid, 5-methylisophthalic acid, 5-sodium sulfoisophthalic acid, hexahydroterephthalic acid, hexahydroisophthalic acid, and diglycolic acid.

Specifically, examples of the polyamide resin include aliphatic polyamides such as polycaproamide (nylon 6), polytetramethylene adipamide (nylon 46), polyhexamethylene adipamide (nylon 66), polyhexamethylene sebacamide (nylon 610), polyhexamethylene dodecamide (nylon 612), polyundecamethyleneadipamide (nylon 116), polyundecaneamide (nylon 11), and polydodecaneamide (nylon 12). Examples thereof also include aliphatic-aromatic polyamides such as polytrimethylhexamethylene terephthalamide, polyhexamethylene isophthalamide (nylon 61), polyhexamethylene terephthal/isophthalamide (nylon 6T/6I), polybis(4-aminocyclohexyl)methane dodecamide (nylon PACM12), polybis(3-methyl-4-aminocyclohexyl)methane dodecamide (nylondimethyl PACM12), polymethxylylene adipamide (nylon MXD6), polyundecamethylene terephthalamide (nylon 11T), polyundecamethylene hexahydro terephthalamide (nylon 1 IT(H)), and copolymerized polyamides thereof. Examples thereof also include copolymers and mixtures thereof, and poly(p-phenylene terephthalamide), and poly(p-phenylene terephthalamide-co-isophthalamide).

<Hydrophilic Copolymer (B)>

The hydrophilic copolymer (B) has a polyoxyethylene chain. Because the polyoxyethylene chain functions as a hydrophilic segment, a hydrophilic copolymer (B) having a polyoxyethylene chain demonstrates antistatic performance and an effect of suppressing adhesion of hydrophilic powdery dust fouling.

Examples of the hydrophilic copolymer (B) include a hydrophilic copolymer (B1) composed of a polyolefin repeatedly and alternately bonded to a hydrophilic polymer having the polyoxyethylene chain; and polyether ester amide (B2).

The hydrophilic copolymer (B) preferably contains at least one of the hydrophilic copolymer (BL) and the polyether ester amide (B2). In other words, the hydrophilic copolymer (B1) and the polyether ester amide (B2) are each a copolymer alternately having a plurality of blocks derived from polyolefin or polyamide and a plurality of blocks derived from the hydrophilic polymer having the polyoxyethylene chain. Use of at least one of the hydrophilic copolymer (B1) and the polyether ester amide (B2) further enhances the anti-contamination effect of the thermoplastic resin composition (molded article).

Compared to other hydrophilic polymers and the antistatic agent, the hydrophilic copolymer (B) having a polyoxyethylene chain (the hydrophilic copolymer (B1) and the polyether ester amide (B2) in particular) when mixed with the thermoplastic resin (A) is likely to reside on the surface of a molded article comprising the thermoplastic resin composition. In other words, compared to other hydrophilic polymers and the antistatic agent, a larger amount of the hydrophilic copolymer (B) having a polyoxyethylene chain is present on the surface thereof without buried inside the molded article. Thus, the anti-contamination effect is efficiently demonstrated with respect to the amount of the added hydrophilic copolymer (B) having a polyoxyethylene chain. For this reason, the hydrophilic copolymer (B) needed to provide similar anti-fouling performance is added in an amount smaller than those of other hydrophilic polymers.

The hydrophilic copolymer (B1) composed of a polyolefin repeatedly and alternately bonded to the hydrophilic polymer having a polyoxyethylene chain can be prepared by a method of modifying polypropylene or polyethylene with an acid, and reacting this with polyalkylene glycol, for example, as described in Japanese Patent Application Laying-Open Nos. 2001-278985 and 2003-48990.

The polyether ester amide is a block copolymer having a polyoxyethylene chain as a hydrophilic segment, and can be prepared by the methods described in Japanese Patent Application Laying-Open Nos.49-8472 and 6-287547.

The mass average molecular weight of the polyoxyethylene chain is preferably 1000 to 15000 from the viewpoint of heat resistance and reactivity with the polyolefin chain.

Because the hydrophilic copolymer (B) according to the present embodiment is dispersed in the thermoplastic resin composition to demonstrate the effect of suppressing adhesion of hydrophilic powdery dust fouling, usually a lower surface resistance value of the hydrophilic copolymer (B) itself is preferred. The surface resistance value of the hydrophilic copolymer (B) is preferably 1×10⁴ to 1×10¹⁰Ω, more preferably 1×10⁴ to 1×10⁷Ω.

For the purpose of enhancing the effect of suppressing adhesion of hydrophilic powdery dust fouling, the thermoplastic resin composition may further contain an antistatic agent other than the hydrophilic polymer described above. Examples of other antistatic agents include surfactants (such as anionic surfactants, cationic surfactants, nonionic surfactants, and amphoteric surfactants), and ionic liquids.

The hydrophilic copolymer (B) having a polyoxyethylene chain also has another special effect.

To obtain amphoteric (hydrophilic and hydrophobic) anti-fouling properties, both of the hydrophilic copolymer (B) and a fatty acid metal salt (C) described later are needed. The fatty acid metal salt (C) has a smaller molecular weight than that of the hydrophilic copolymer (B) and is less entangled with the thermoplastic resin (A) than the hydrophilic copolymer (B) is, and thus may drop from the surface of the molded article or may be degraded. However, if a large amount of the hydrophilic copolymer (B) is present on the surface of the molded article, the hydrophilic group of the fatty acid metal salt (C) adheres to the hydrophilic group of the hydrophilic copolymer (B) whose antistatic effect prevents adhesion of hydrophilic powdery dust fouling, thereby enabling the fatty acid metal salt (C) to be stably present on the surface thereof without dropping therefrom.

Because the fatty acid metal salt (C) has a non-polar hydrophobic group, i.e., R located opposite to the hydrophilic group of the fatty acid metal salt (C), a new effect not provided only by the hydrophilic copolymer (B), that is, a high effect of suppressing adhesion of hydrophobic powdery dust fouling is provided.

In other words, both the hydrophilic copolymer (B) having a polyoxyethylene chain and the fatty acid metal salt (C) are present on the surface of the molded article to demonstrate the synergetic effect, thereby demonstrating a high effect of suppressing both types of powdery dust fouling (anti-fouling properties).

<Fatty Acid Metal Salt (C)>

The fatty acid metal salt (C) is a compound represented by the following formula (1):

M(OH)y(R—COO)x (1)

wherein R is an alkyl group or alkenyl group having 6 to 40 carbon atoms; M is at least one metal element selected from the group consisting of aluminum, zinc, calcium, magnesium, lithium, and barium; x and y each independently represent an integer of 0 or more, and satisfy the relation represented by x+y=[valency of M].

The effect of suppressing adhesion of hydrophilic powdery dust fouling is provided even if only the hydrophilic polymer and the antistatic agent are used as additives. However, such use results in a low effect of suppressing adhesion of hydrophobic powdery dust fouling, and a reduction in adhesion amount of hydrophobic powdery dust fouling in Comparative Examples described later is no more than a half. For this reason, a novel measures is required.

Although silicone oil, a fluorinated resin such as PTFE, and hydrophobic silica such as fumed silica are known as additives which usually provide a water-repellant or oil-repellant effect, any one of the additives does not provide the effect of suppressing adhesion of hydrophobic powdery dust fouling. This is because these additives, when added to the resin, are buried inside the resin and do not reside on the surface thereof. The problem can be solved by compounding the fatty acid metal salt (C) with the thermoplastic resin (A) and the hydrophilic copolymer (B), the fatty acid metal salt being a material which can be present on the surface of the resin in a high concentration and has hydrophobicity and water and oil repellency.

The fatty acid metal salt used in the present embodiment is a fatty acid metal salt represented by the formula (1):

M(OH)y(R—COO)x (1)

wherein R is an alkyl group or alkenyl group having 6 to 40 carbon atoms; M is at least one metal element selected from the group consisting of aluminum, zinc, calcium, magnesium, lithium, and barium; x and y each independently represent an integer of 0 or more, and satisfy the relation represented by x+y=[valency of M].

In the formula (1), R has 6 to 40 carbon atoms, preferably 11 to 27 carbon atoms, still more preferably 15 to 20 carbon atoms. If R has less than 6 carbon atoms or more than 40 carbon atoms, these cases are not preferred because the effect of preventing adhesion of powdery dust is reduced. R is an alkyl group or an alkenyl group, and is preferably an alkyl group.

Generally, if the material has a contact angle to water larger than that to petroleum and mineral oil, it is considered that the material has water and oil repellency; and if the material has a contact angle to water larger than 90 degrees, it is considered that the material has hydrophobicity. The fatty acid metal salt (C) is such a material.

(Metal Element M)

In the formula (1), M is at least one metal element selected from the group consisting of aluminum, zinc, calcium, magnesium, lithium, and barium.

M is preferably at least one metal element selected from the group consisting of aluminum and zinc. In this case, the thermoplastic resin composition can demonstrate higher anti-fouling performance. M is more preferably aluminum. In this case, the thermoplastic resin composition can demonstrate still higher anti-fouling performance.

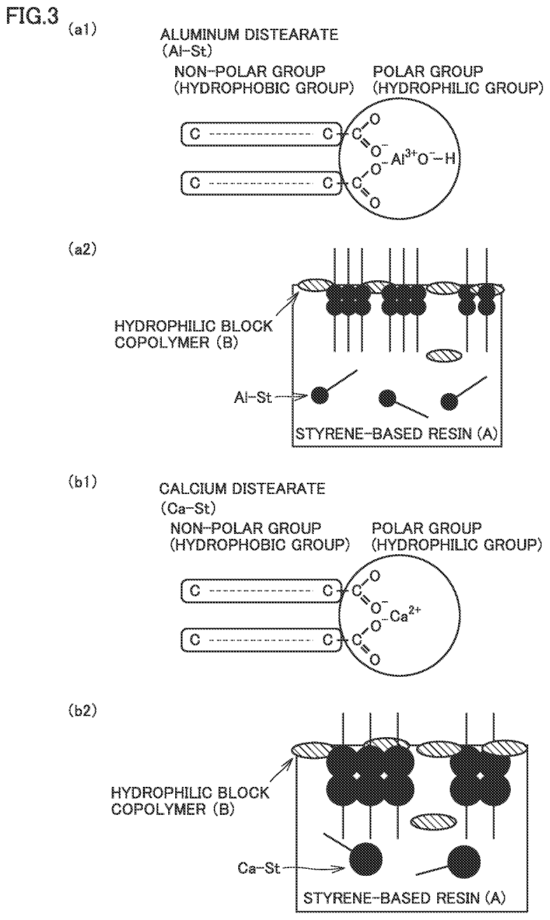

With reference to FIG. 3, compared to M having a large ionic radius ((b1) and (b2) of FIG. 3), M having a small ionic radius ((a1) and (a2) of FIG. 3) allows the non-polar group (hydrophobic group) of the fatty acid metal salt to be more densely arranged on the surface of the molded article comprising the thermoplastic resin composition. As the hydrophobic group is denser, the effect of suppressing adhesion of hydrophobic powdery dust fouling is more significantly enhanced. The ionic radius of M is 54 for aluminum, 74 for zinc, 100 for calcium, and 135 for barium, and aluminum has the largest ionic radius and zinc has the second largest ionic radius. Thus, to enhance the anti-contamination effect, aluminum is the most optimal and zinc is preferred as the metal element M.

(Fatty Acid)

Examples of the fatty acid which forms the fatty acid metal salt (C) according to the present embodiment include caproic acid, capric acid, lauric acid, palmitic acid, stearic acid, behenic acid, lignoceric acid, montanic acid, oleic acid, and linoleic acid. The fatty acid is preferably a long-chain fatty acid (fatty acid having 12 or more carbon atoms) such as stearic acid, behenic acid, or montanic acid. In particular, stearic acid is more preferred for production because of its availability and inexpensiveness.

Examples of the fatty acid metal salt (C) include zinc stearate, zinc 12-hydroxystearate, zinc laurate, zinc oleate, zinc 2-ethylhexanoate, aluminum tristearate, (dihydroxy)aluminum monostearate, (hydroxy)aluminum distearate, aluminum 12-hydroxystearate, aluminum laurate, aluminum oleate, and aluminum 2-ethylhexanoate. The fatty acid metal salt (C) is preferably zinc stearate, aluminum tristearate, (dihydroxy)aluminum monostearate, and (hydroxy)aluminum distearate, more preferably (hydroxy)aluminum distearate. These fatty acid metal salts (C) may be used alone or in combination.

As the features, aluminum stearate, zinc stearate, calcium stearate, and barium stearate have smoothness, high water repellency, and low surface free energy (about 21.2 mN/m). The material having low surface free energy, such as a fluorinated resin (surface free energy: about 21.5 mN/m), has a stable surface state. For this reason, fouling hardly adheres thereto. The effect of preventing hydrophobic powdery dust fouling, such as carbon black, soot, and oily smoke, is demonstrated by formation of a layer of aluminum stearate having low surface free energy on the surface of the molded article comprising the thermoplastic resin composition. Low surface free energy results in prevention of adhesion of hydrophilic powdery dust fouling, such as dust, sand, and clay. Accordingly, in addition to the static elimination effect of the hydrophilic copolymer (B) compounded in the thermoplastic resin composition, the anti-fouling properties of hydrophobic powdery dust fouling and hydrophilic powdery dust fouling are further enhanced.

(Valency)

In the formula (1), x and y each independently represent an integer of 0 or more, and satisfy the relation represented by x+y=[valency of M].

If the valency of M is 1, y is 0. If the valency of M is 2 or more, y is an integer of 0 or 1 or more. If the valency of M is 3 or more, y is preferably 1. In this case, the thermoplastic resin composition can demonstrate much higher anti-fouling performance.

As one example, aluminum stearate will be described, which is a long-chain fatty acid salt of aluminum where the valency of M is 3.

Aluminum stearate includes aluminum monostearate [Al(C₁₇H₃₅COO)(OH)₂]containing one stearic acid (mono-type), aluminum distearate [Al(C₁₇H₃₅COO)₂(OH)]containing two stearic acids (di-type, and aluminum tristearate [Al(C₁₇H₃₅COO)₃]containing three stearic acids (tri-type).

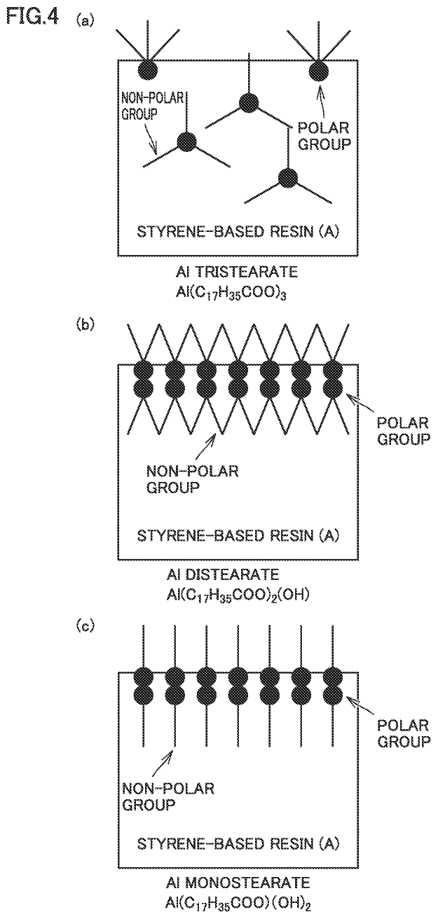

With reference to FIG. 4, aluminum tristearate hardly migrates to the surface of the molded article ((a) of FIG. 4) due to a large amount of the non-polar group. Furthermore, aluminum tristearate is an unstable substance and thus is readily hydrolyzed by the water content in the air to form a mixture with aluminum monostearate or aluminum distearate. Thus, aluminum distearate more readily migrates to the surface of the molded article ((b) of FIG. 4) and has a higher effect of suppressing both types of powdery dust than aluminum tristearate. If the valency of M is more than 3, similarly, the effect of suppressing both types of powdery dust by the di-type fatty acid metal salt having a smaller number of fatty acids is higher than that by the tri-type fatty acid metal salt.

On the other hand, aluminum monostearate has a smaller number of non-polar groups (hydrophobic groups) for R than that of aluminum distearate where the number of aluminum atoms is identical ((c) of FIG. 4). Accordingly, aluminum distearate has a higher effect of suppressing both types of powdery dust than that of aluminum monostearate.

In the actual measurement near the surface of the molded article using a time-of-flight secondary ion mass spectrometer (TOF-SIMS), C₁₈H₃₅O₂_{^{−}} derived from stearic acid was detected as secondary ions. Because the detection depth for TOF-SIMS is usually 1 to 2 nm, it was verified that stearic acid is present on the outermost surface of the molded article.

The secondary ion intensity ratio of C₁₈H₃₅O₂_{^{−}}, where the ion intensity of C₂H⁻ as the main peak during analysis of polystyrene is used as a reference, was 0.341 in the molded article containing aluminum distearate, which was 2- to 4-fold or higher than that (0.0687) of the molded article containing aluminum monostearate and that (0.172) of the molded article containing aluminum tristearate. Accordingly, in the molded article containing aluminum distearate (where y=1), a large amount of the non-polar group (hydrophobic group) is present on the surface thereof, and the effect of suppressing powdery dust is most readily demonstrated.

For the same reason as that for the above case where the valency of M is 3 or more, the effect of suppressing both types of powdery dust by the di-type fatty acid metal salt is higher than that by the mono-type fatty acid metal salt also if the valency of M is 2. Thus, if the valency of M is 2, y is preferably 0 (where x is 2).

<Contents of Components>

In the thermoplastic resin composition according to the present embodiment, the compounding amount of the hydrophilic copolymer (B) is preferably 1 to 20 parts by mass, more preferably 1 to 17 parts by mass relative to 100 parts by mass of the thermoplastic resin (A).

The compounding amount of the fatty acid metal salt (C) is preferably 0.5 to 10 parts by mass, more preferably 1 to 8 parts by mass relative to 100 parts by mass of the thermoplastic resin (A).

In particular, the thermoplastic resin composition according to the present embodiment preferably comprises 100 parts by mass of the thermoplastic resin (A), 1 to 20 parts by mass of the hydrophilic copolymer (B), and 0.5 to 10 parts by mass of the fatty acid metal salt (C).

Although the fatty acid metal salt (C) is usually compounded with the thermoplastic resin composition in an amount of 0.5% by mass or less (particularly, about 0.1%) as a lubricant, a mold release agent, or the like for improving molding properties, by compounding the fatty acid metal salt (C) in an amount of more than 0.5% by mass, the action of causing both the hydrophilic copolymer (B) and the fatty acid metal salt (C) on the surface of the molded article in high concentrations is demonstrated, and further amphoteric anti-contamination effect is enhanced.

If the compounding amount of the hydrophilic copolymer (B) is more than 20 parts by mass, mechanical strength such as elastic modulus reduces. If the compounding amount is less than 1 part by mass, a reduction in the effect of suppressing adhesion of powdery dust is observed.

If the compounding amount of the fatty acid metal salt (C) is more than 10 parts by mass, the heat resistance and the impact resistance reduce. If the compounding amount is less than 0.5 parts by mass, a reduction in the effect of suppressing adhesion of powdery dust is observed.

As described above, usually the fatty acid metal salt (C) is used for a purpose different from that of the present embodiment, i.e., suppressing both types of powdery dust fouling of hydrophilic powdery dust fouling and hydrophobic powdery dust fouling in some cases. As disclosed in Japanese Patent Application Laying-Open Nos. 2004-168055 and 2003-183529, for example, the fatty acid metal salt (C) is used as a lubricant, a molding improver, a mold release agent, an anti-fogging agent, or the like. In this case, the compounding amount of the fatty acid metal salt (C) is less than 0.5 parts by mass relative to 100 parts by mass of the thermoplastic resin (A). Furthermore, the compounding amount of the fatty acid metal salt (C) is 0.1 parts by mass or less in standard usage related to the production industry. The effect of suppressing adhesion of powdery dust by the fatty acid metal salt (C) has not been known yet.

In the present embodiment, the followings have been found: To obtain the effect of suppressing adhesion of both hydrophilic powdery dust fouling and hydrophobic powdery dust fouling for the purpose completely different from that of the conventional usage, the fatty acid metal salt (C) is used in a compounding amount sufficiently larger than that usually used, and such a sufficiently large compounding amount thereof provides a remarkable effect of suppressing adhesion of both types of powdery dust fouling. Accordingly, the compounding amount of the fatty acid metal salt (C) is preferably 0.5 parts by mass or more, more preferably 1 to 8 parts by mass relative to 100 parts by mass of the thermoplastic resin (A). In this case, the resulting effect of suppressing powdery dust is equal to or higher than that in the case where the coating for suppressing powdery dust is applied to the surface of the molded article. Such an example in which 1 part by mass or more of the fatty acid metal salt (C) is compounded relative to 100 parts by mass if the thermoplastic resin for the purpose of suppressing powdery dust has not been known yet.

The new effect of suppressing adhesion of hydrophobic powdery dust fouling is provided by R, which is a non-polar hydrophobic group of the fatty acid metal salt directed to the air. By adding the fatty acid metal salt (C) in an amount of 0.5% by mass or more relative to the thermoplastic resin (A), a large amount of hydrophobic groups can be densely disposed on the surface of the molded article comprising the thermoplastic resin composition to enhance the effect of suppressing adhesion of hydrophobic powdery dust fouling.

As described later, the effect of suppressing adhesion of hydrophilic powdery dust fouling is enhanced by the antistatic effect of the hydrophilic copolymer (B) having a polyoxyethylene chain, and the effect of suppressing adhesion of hydrophobic powdery dust fouling is enhanced by compounding the fatty acid metal salt (C) in combination, thus providing a new high effect on both types of fouling.

<Optional Components>

The thermoplastic resin composition according to the present embodiment may contain optional components such as a heat stabilizer, an ultraviolet absorbing agent, a photostabilizer, an antibacterial agent, an antifungal agent, and an inorganic filler in the ranges not impairing the object of the present embodiment.

(Heat Stabilizer)

The thermoplastic resin composition according to the present embodiment may contain a heat stabilizer to improve the thermal stability during production.

The heat stabilizer to be used is preferably a phosphorus-based stabilizer and/or a hindered phenol-based antioxidant, more preferably a combination thereof.

The phosphorus-based stabilizer and/or the hindered phenol-based antioxidant can be added to the thermoplastic resin composition according to the present embodiment in any amount.

The amount thereof to be added is preferably 0.01 to 1 part by mass, more preferably 0.01 to 0.6 parts by mass relative to 100 parts by mass of the thermoplastic resin composition because the effect of improving thermal stability is effectively obtained and the compounding amounts of the essential components described above are not affected.

Examples of the phosphorus-based stabilizer include phosphorous acid, phosphoric acid, phosphonous acid, phosphonic acid, esters thereof, phosphonite compounds, and tertiary phosphines.

Examples of the phosphorous acid esters (phosphite compounds) include triphenyl phosphite, tris(nonylphenyl) phosphite, tridecyl phosphite, distearylpentaerythritol diphosphite, bis(2,4-di-tert-butylphenyl)pentaerythritol diphosphite, bis(2,6-di-tert-butyl-4-methylphenyl)pentaerythritol diphosphite, bis{2,4-bis(1-methyl-1-phenylethyl)phenyl}pentaerythritol diphosphite, phenyl bisphenol A pentaerythritol diphosphite, bis(nonylphenyl)pentaerythritol diphosphite, and dicyclohexylpentaerythritol diphosphite.

In addition to those listed above, those which are reactive with divalent phenols and have a cyclic structure can also be used as the phosphorous acid esters (phosphite compounds).

Examples thereof include 2,2′-methylene bis(4,6-di-tert-butylphenyl)(2,4-di-tert-butylphenyl) phosphite, 2,2′-methylene bis(4,6-di-tert-butylphenyl)(2-tert-butyl-4-methylphenyl) phosphite, and 2,2-methylene bis(4,6-di-tert-butylphenyl)octyl phosphite.

Examples of the phosphoric acid esters (phosphate compounds) include triphenyl phosphate and trimethyl phosphate.

Examples of the phosphonite compounds include tetrakis(di-tert-butylphenyl)-biphenylene diphosphonite and bis(di-tert-butylphenyl)-phenyl-phenyl phosphonite.

These phosphonite compounds can be used in combination with the phosphite compounds having aryl groups which substitute two or more alkyl groups can be used, and such use in combination is preferred.

Examples of the phosphonic acid esters (phosphonate compounds) include dimethyl benzenephosphonate, diethyl benzenephosphonate, and dipropyl benzenephosphonate.

Examples of the tertiary phosphines include triphenyl phosphine. Among these phosphorus-based stabilizers, preferred are phosphonite compounds or phosphite compounds represented by the following general formula (15):

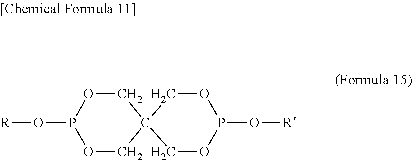

(In the formula (15), R and R′ represent an alkyl group having 6 to 30 carbon atoms or an aryl group having 6 to 30 carbon atoms, and may be the same or different). As described above, the phosphonite compound is preferably tetrakis(2,4-di-tert-butylphenyl)-biphenylene diphosphonite.

Among these, more suitable phosphite compounds represented by the above formula (15) are distearylpentaerythritol diphosphite, bis(2,4-di-tert-butylphenyl)pentaerythritol diphosphite, bis(2,6-di-tert-butyl-4-methylphenyl)pentaerythritol diphosphite, and bis{2,4-bis(1-methyl-1-phenylethyl)phenyl}pentaerythritol diphosphite.

Examples of the hindered phenol compound include tetrakis[methylene-3-(3-tert-butyl-4-hydroxy-5-methylphenyl)propionate]methane, octadecyl-3-(3,5-di-tert-butyl-4-hydroxyphenyl)propionate, and 3,9-bis[2-{3-(3-t-butyl-4-hydroxy-5-methylphenyl)propionyloxy}-1,1-dimethylethyl]-2,4,8,10-tetraoxaspiro[5,5]undecane.

The thermoplastic resin composition according to the present embodiment can contain a different heat stabilizer other than the phosphorus-based stabilizer and the hindered phenol-based antioxidant.

The different heat stabilizer is preferably used in combination with at least one of the phosphorus-based stabilizer and the hindered phenol-based antioxidant, and is particularly preferably used in combination with both thereof.

Examples of the different heat stabilizer include lactone-based stabilizers (see Japanese Patent Application Laying-Open No. 7-233160 for the details of this stabilizer) such as the reaction product of 3-hydroxy-5,7-di-tert-butyl-furan-2-one and o-xylene.

For the lactone-based stabilizers, Irganox HP-136 (registered trademark, manufactured by CIBA SPECIALTY CHEMICALS) and the like are commercially available.

As a mixed stabilizer of the lactone-based stabilizer, the phosphite compound, and the hindered phenol compound, Irganox HP-2921 (registered trademark, manufactured by CIBA SPECIALTY CHEMICALS) and the like are commercially available.

The amount of lactone-based stabilizer to be added is preferably 0.0005 to 0.05 parts by mass, more preferably 0.001 to 0.03 parts by mass relative to 100 parts by mass of the thermoplastic resin composition.

Examples of other different stabilizers include sulfur-containing stabilizers such as pentaerythritol tetrakis(3-mercaptopropionate), pentaerythritol tetrakis (3-laurylthiopropionate), and glycerol-3-stearylthiopropionate.

The different stabilizers other than the phosphorus-based stabilizer and/or the hindered phenol-based antioxidant can be added to the thermoplastic resin composition according to the present embodiment in any amount, and the amount thereof to be added is preferably 0.0005 to 0.1 parts by mass, more preferably 0.001 to 0.08 parts by mass, particularly preferably 0.001 to 0.05 parts by mass relative to 100 parts by mass of the thermoplastic resin composition.

(Ultraviolet Absorbing Agent)

The thermoplastic resin composition according to the present embodiment may contain an ultraviolet absorbing agent. Because the weatherability of the thermoplastic resin composition according to the present embodiment may be reduced due to influences from the rubber component or the like in some cases, compounding of the ultraviolet absorbing agent is effective in improving the weatherability.

Examples of the ultraviolet absorbing agent according to the present embodiment include benzophenone-based ultraviolet absorbing agents, benzotriazole-based ultraviolet absorbing agents, hydroxyphenyltriazine-based ultraviolet absorbing agents, cyclic iminoester-based ultraviolet absorbing agents, and cyanoacrylate-based ultraviolet absorbing agents.

Examples of the benzophenone-based ultraviolet absorbing agents include 2,4-dihydroxybenzophenone, 2-hydroxy-4-methoxybenzophenone, 2-hydroxy-4-octoxybenzophenone, 2-hydroxy-4-benzyloxybenzophenone, 2-hydroxy-4-methoxy-5-sulfoxybenzophenone, 2-hydroxy-4-methoxy-5-sulfoxytrihydridelatebenzophenone, 2,2′-dihydroxy-4-methoxybenzophenone, 2,2′,4,4′-tetrahydroxybenzophenone, 2,2′-dihydroxy-4,4′-dimethoxybenzophenone, 2,2′-dihydroxy-4,4′-dimethoxy-5-sodium sulfoxybenzophenone, bis(5-benzoyl-4-hydroxy-2-methoxyphenyl)methane, 2-hydroxy-4-n-dodecyloxybenzophenone, and 2-hydroxy-4-methoxy-2′-carboxybenzophenone.

Examples of the benzotriazole-based ultraviolet absorbing agents include 2-(2-hydroxy-5-methylphenyl)benzotriazole, 2-(2-hydroxy-5-tert-octylphenyl)benzotriazole, 2-(2-hydroxy-3,5-dicumylphenyl)phenylbenzotriazole, 2-(2-hydroxy-3-tert-butyl-5-methylphenyl)-5-chlorobenzotriazole, 2,2′-methylene bis[4-(1,1,3,3-tetramethylbutyl)-6-(2H-benzotriazol-2-yl)phenol], 2-(2-hydroxy-3,5-di-tert-butylphenyl)benzotriazole, 2-(2-hydroxy-3,5-di-tert-butylphenyl)-5-chlorobenzotriazole, 2-(2-hydroxy-3,5-di-tert-amylphenyl)benzotriazole, 2-(2-hydroxy-5-tert-octylphenyl)benzotriazole, 2-(2-hydroxy-5-tert-butylphenyl)benzotriazole, 2-(2-hydroxy-4-octoxyphenyl)benzotriazole, 2,2′-methylene bis(4-cumyl-6-benzotriazolephenyl), 2,2′-p-phenylene bis(1,3-benzooxazin-4-one), and 2-[2-hydroxy-3-(3,4,5,6-tetrahydrophthalimidomethyl)-5-methylphenyl]benzotriazole. Examples of other benzotriazole-based ultraviolet absorbing agents include polymers having a 2-hydroxyphenyl-2H-benzotriazole skeleton. Examples of the polymers having a 2-hydroxyphenyl-2H-benzotriazole skeleton include copolymers of 2-(2′-hydroxy-5-methacryloxyethylphenyl)-2H-benzotriazole and vinyl monomers copolymerizable with the monomer, and copolymers of 2-(2′-hydroxy-5-acryloxyethylphenyl)-2H-benzotriazole and vinyl monomers copolymerizable with the monomer.

Examples of the hydroxyphenyltriazine-based ultraviolet absorbing agents include 2-(4,6-diphenyl-1,3,5-triazin-2-yl)-5-hexyloxyphenol, 2-(4,6-diphenyl-1,3,5-triazin-2-yl)-5-methyloxyphenol, 2-(4,6-diphenyl-1,3,5-triazin-2-yl)-5-ethyloxyphenol, 2-(4,6-diphenyl-1,3,5-triazin-2-yl)-5-propyloxyphenol, and 2-(4,6-diphenyl-1,3,5-triazin-2-yl)-5-butyloxyphenol. Furthermore, examples thereof include compounds listed above and having a 2,4-dimethylphenyl group which substitutes the phenyl group, such as 2-(4,6-bis(2,4-dimethylphenyl)-1,3,5-triazin-2-yl)-5-hexyloxyphenol.

Examples of the cyclic imino ester-based ultraviolet absorbing agents include 2,2′-p-phenylene bis(3,1-benzooxazin-4-one), 2,2′-(4,4′-diphenylene)bis(3,1-benzooxazin-4-one), and 2,2′-(2,6-naphthalene)bis(3,1-benzooxazin-4-one).

Examples of the cyanoacrylate-based ultraviolet absorbing agents include 1,3-bis-[(2′-cyano-3′,3′-diphenylacryloyl)oxy]-2,2-bis[(2-cyano-3,3-diphenylacryloyl)oxy]methyl)propane, and 1,3-bis-[(2-cyano-3,3-diphenylacryloyl)oxy]benzene.

Furthermore, the ultraviolet absorbing agent may be a polymer-type ultraviolet absorbing agent prepared by copolymerizing an ultraviolet light absorbable monomer and/or a photostable monomer having a hindered amine structure with a monomer such as alkyl (meth)acrylate. Examples of the ultraviolet light absorbable monomer suitably include compounds which are (meth)acrylate esters and contain a benzotriazole skeleton, a benzophenone skeleton, a triazine skeleton, a cyclic imino ester skeleton, and a cyanoacrylate skeleton in the substituents of the esters.

Among these, preferred are benzotriazole-based and hydroxyphenyltriazine-based ultraviolet absorbing agents from the viewpoint of ultraviolet light absorbability, and preferred are cyclic imino ester-based and cyanoacrylate-based ultraviolet absorbing agents from the viewpoint of heat resistance and hue (transparency). These ultraviolet absorbing agents may be used alone or in the form of a mixture thereof.

The content of the ultraviolet absorbing agent is preferably 0.01 to 2 parts by mass, more preferably 0.02 to 2 parts by mass, still more preferably 0.03 to 1 part by mass, particularly preferably 0.05 to 0.5 parts by mass relative to 100 parts by mass of the thermoplastic resin composition.

(Photostabilizer)

The thermoplastic resin composition according to the present embodiment may contain a photostabilizer. Compounding of a photostabilizer is effective to prevent degradation because the thermoplastic resin composition according to the present embodiment may cause yellowing in the dark.

Hindered amine photostabilizers (HALSs) can be suitably used as such a photostabilizer. The HALSs include compounds represented by the following formulae (16) to (19) or combinations of thereof:

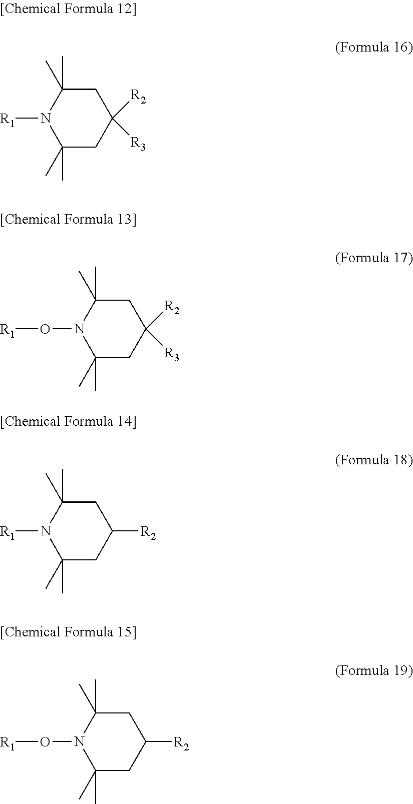

In the formulae (16) to (19), R₁ to R₃ are independent substituents. Examples of the substituents include hydrogen, an ether group, an ester group, an amine group, an amide group, an alkyl group, an alkenyl group, an alkynyl group, an aralkyl group, a cycloalkyl group, and an aryl group.

These substituents may have a functional group. Examples of the functional group include alcohols, ketones, anhydrides, imines, siloxanes, ethers, a carboxyl group, aldehydes, esters, amides, imides, amines, nitriles, ethers, urethanes, and combinations thereof.

The hindered amine photostabilizers (HALSs) are preferably compounds derived from substituted piperidine compounds, more preferably compounds derived from alkyl-substituted piperidyl, piperidinyl, or piperazinone compounds and substituted alkoxypiperidinyl compounds.

Examples of the hindered amine photostabilizers include, but should not be limited to, 2,2,6,6-tetramethyl-4-piperidone; 2,2,6,6-tetramethyl-4-piperidinol; bis-(1,2,2,6,6-pentamethylpiperidyl)-(3′,5′-di-t-butyl-4′-hydroxybenzyl)butyl malonate; di-(2,2,6,6-tetramethyl-4-piperidyl) sebacate; oligomers of N-(2-hydroxyethyl)-2,2,6,6-tetramethyl-4-piperidinol and succinic acid; oligomers of cyanuric acid and N,N-di(2,2,6,6-tetramethyl-4-piperidyl)-hexamethylenediamine; bis-(2,2,6,6-tetramethyl-4-piperidinyl) succinate; bis-(1-octyloxy-2,2,6,6-tetramethyl-4-piperidinyl)sebacate; bis-(1,2,2,6,6-pentamethyl-4-piperidinyl) sebacate; tetrakis-(2,2,6,6-tetramethyl-4-piperidyl)-1,2,3,4-butane tetracarboxylate; N,N′-bis-(2,2,6,6-tetramethyl-4-piperidyl)-hexane-1,6-diamine; N-butyl-2,2,6,6-tetramethyl-4-piperidineamine; 2,2′-[(2,2,6,6-tetramethyl-piperidinyl)-imino]-bis-[ethanol]; poly((6-morpholine-S-triazine-2,4-diyl)(2,2,6,6-tetramethyl-4-piperidinyl)-iminohexamethylene-(2,2,6,6-tetramethyl-4-piperidinyl)-imino); 5-(2,2,6,6-tetramethyl-4-piperidinyl)-2-cyclo-undecyl-oxazole); 1,1′-(1,2-ethane-di-yl)-bis-(3,3′,5,5′-tetramethyl-piperazinone); 8-acetyl-3-dodecyl-7,7,9,9-tetramethyl-1,3,8-triazaspiro(4.5)decane-2,4-dione; polymethyl propyl-3-oxy-[4(2,2,6,6-tetramethyl)-piperidinyl]siloxane; 1,2,3,4-butane-tetracarboxylic acid-1,2,3-tris(1,2,2,6,6-pentamethyl-4-piperidinyl)-4-tridecyl esters; copolymers of α-methylstyrene-N-(2,2,6,6-tetramethyl-4-piperidinyl)maleimide and N-stearylmaleimide; copolymers of 1,2,3,4-butanetetracarboxylic acid-β,β,β′,β′-tetramethyl-2,4,8,10-tetraoxaspiro[5.5]undecane-3,9-diethanol and 1,2,2,6,6-pentamethyl-4-piperidinyl esters; 2,4,8,10-tetraoxaspiro[5.5]undecane-3,9-diethanol and 1,2,3,4-butanetetracarboxylic acid, 2,2,6,6-tetramethyl-4-piperidinyl esters and β,β,β′,β′-tetramethyl-polymer; D-glucitol, 1,3:2,4-bis-o-(2,2,6,6-tetramethyl-4-piperidinylidene)-; oligomers of 7-oxa-3,20-diazadispiro[5.1.11.2]-heneicosan-21-one-2,2,4,4-tetramethyl-20-(oxiranylmethyl); propanedioic acid and [(4-methoxyphenyl)methylene]-,bis(1,2,2,6,6-pentamethyl-4-piperidinyl) esters; formamide and N,N′-1,6-hexanediylbis[N-(2,2,6,6-tetramethyl-4-piperidinyl; 1,3,5-triazine-2,4,6-triamine, N,N′″-[1,2-ethanediylbis[[[4,6-bis[butyl(1,2,2,6,6-pentamethyl-4-piperidinyl)amino]-1,3,5-triazin-2-yl]imino]-3,1-propanediyl]]-bis[N′,N″-dibutyl-N′,N″-bis(1,2,2,6,6-pentamethyl-4-piperidinyl); poly[[6-[(1,1,3,33-tetramethylbutyl)amino]-1,3,5-triazine-2,4-diyl][(2,2,6,6-tetramethyl-4-piperidinyl)-imino]-1,6-hexanediyl [(2,2,6,6-tetramethyl-4-piperidinyl)imino]]; 1,5-dioxaspiro(5.5)undecane 3,3-dicarboxylic acid, bis(2,2,6,6-tetramethyl-4-piperidinyl) esters; 1,5-dioxaspiro(5.5)undecane 3,3-dicarboxylate, bis(1,2,2,6,6-pentamethyl-4-piperidinyl) esters; N-2,2,6,6-tetramethyl-4-piperidinyl-N-amino-oxamide; 4-acryloyloxy-1,2,2,6,6-pentamethyl-4-piperidine; 1,5,8,12-tetrakis[2′,4′-bis(1″,2″,2″,6″,6″-pentamethyl-4″-piperidinyl(butyl)amino)-1′,3′,5′-triazin-6′-yl]-1,5,8,12-tetraazadodecane; 3-dodecyl-1-(2,2,6,6-tetramethyl-4-piperidyl)-pyrrolidine-2,5-dione; 1,1′-(1,2-ethane-di-yl)-bis-(3,3′,5,5′-tetra-methyl-piperazinone); 1,1′138-(1,3,5-triazine-2,4,6-triyltris((cyclohexylimino)-2,1-ethanediyl)tris(3,3,5,5-tetramethylpiperazinone); and 1,1′,1″-(1,3,5-triazine-2,4,6-trilytris((cyclohexylimino)-2,1-ethanediyl)tris(3,3,4,5,5-tetramethylpiperazinone).

The amount of the hindered amine photostabilizer (HALS) to be added is preferably 0.01 to 5 parts by mass, more preferably 0.05 to 3 parts by mass, still more preferably 0.1 to 1 part by mass relative to 100 parts by mass of the thermoplastic resin composition.

(Antibacterial Agent)

The thermoplastic resin composition according to the present embodiment may contain an antibacterial agent. Examples of the antibacterial agent include, but should not be limited to, inorganic antibacterial agents of antibacterial metals, such as zinc oxide, silver, copper, and zinc carried on crystalline aluminosilicic acid salts, amorphous aluminosilicic acid salts, silica gel, active alumina, diatomite, activated carbon, zirconium phosphate, hydroxy apatite, magnesium oxide, magnesium perchlorate, and glass. A preferred antibacterial metal is zinc oxide.

Zinc oxide is not particularly limited, and may be a commercially available product. For example, zinc oxide may be a product prepared by vaporizing a metal zinc by heating and burning it in the air or a product prepared by heating zinc sulfate or zinc nitrate. Those having a variety of shapes such as fibrous, platy, particulate, and tetrapodic zinc oxides can be used. The zinc oxide used in the present embodiment may be surface treated with silicon oxide, silicone oil, an organic silicon compound, or an organic titanium compound.

Examples of the commercially available zinc oxides include “Class 1 zinc oxide”, “Class 2 zinc oxide”, and “Class 3 zinc oxide” classified by JIS K-1410, pharmaceutical zinc oxides specified in The Japanese Pharmacopoeia, and anisotropic (columnar, platy, and tetrapodic) zinc oxides (zinc oxides having shape anisotropy) prepared through a hydrothermal preparation step. Among these zinc oxides, particulate zinc oxides having an average particle diameter of 50 to 200 nm, particularly 100 to 150 nm are preferred. The average particle diameter mentioned here indicates a particle diameter whose integrated mass distribution is 50% in the particle diameter distribution obtained from the measurement with a laser diffraction/scattering particle diameter distribution analyzer.

The compounding amount of the zinc oxide is preferably 0.01 to 1 part by mass, more preferably 0.05 to 0.5 parts by mass, still more preferably 0.1 to 0.3 parts by mass relative to 100 parts by mass of the thermoplastic resin composition.

(Inorganic Filler)

The thermoplastic resin composition according to the present embodiment may contain an inorganic filler as a reinforcing filler to impart rigidity and enhance strength.

Examples of the inorganic filler include talc, wollastonite, mica, clay, montmorillonite, smectite, kaolin, calcium carbonate, glass fibers, glass beads, glass balloons, glass milled fibers, glass flakes, carbon fibers, carbon flakes, carbon beads, carbon milled fibers, metal flakes, metal fibers, metal-coated glass fibers, metal-coated carbon fibers, metal-coated glass flakes, silica, ceramic particles, ceramic fibers, ceramic balloons, aramid particles, aramid fibers, polyarylate fibers, graphite, and a variety of whiskers such as potassium titanate whiskers, aluminum borate whiskers, and basic magnesium sulfate. Among these, silicate fillers such as talc, wollastonite, mica, glass fibers, and glass milled fibers are preferably used. Among these, particularly preferred are talc, wollastonite, and mica.

If the inorganic filler is compounded, the thermoplastic resin composition according to the present embodiment can contain an additive having an acidic group such as a carboxylic anhydride group or a sulfonate group to enhance the wettability of the inorganic filler.

The content of the inorganic filler in the present embodiment is preferably 0.1 to 30 parts by mass, more preferably 0.5 to 20 parts by mass, still more preferably 1 to 10 parts by mass relative to 100 parts by mass of the thermoplastic resin composition. If the compounding amount is less than 0.1 parts by mass, the reinforcement effect by the filler is not provided. If the compounding amount is more than 30 parts by mass, impact strength significantly reduces, and this is not preferred.

(Other Optional Components)

Examples of other optional components usable in the present embodiment include dyes and pigments for coloring, an antifoaming agent, a plasticizer, a lubricant, a mold release agent, and a flame retardant. Furthermore, a thermoplastic resin other than the thermoplastic resin (A) and the hydrophilic copolymer (B) can be compounded in the range not imparting the object of the present embodiment.

Such a thermoplastic resin to be used can be thermoplastic resins used as general-purpose resins in home appliances and OA apparatuses.

Examples of such thermoplastic resins include:

olefin resins, such as polyolefin resins (such as high density polyethylene, low density polyethylene, and polypropylene), cyclic olefin resins, and polyester resins (such as polylactic acid, polyethylene terephthalate, and polybutylene terephthalate),

styrene-based resins, such as polystyrene (PS resins), acrylonitrile butadiene styrene (ABS resins), and acrylonitrile styrene (AS resins),

ASA resins prepared by polymerizing the ABS resins in which butadiene is substituted by acrylic rubber,

AES resins prepared by polymerizing the ABS resins in which butadiene is substituted by ethylene rubber, and

methyl methacrylate butadiene styrene (MBS resins).

Examples of other general-purpose resins include polyvinyl chloride resins (such as polyvinyl chloride and polyvinylidene chloride), polymethyl methacrylate resins, polyvinyl alcohol, polyethylene terephthalate (PET resins), and polybutylene terephthalate (PBT resins).

Examples of engineering plastics having particularly high strength and reinforced functions such as heat resistance include polycarbonate resins (BPA-type polycarbonate and aliphatic polycarbonate), polyamide resins, polyphenylene ether resins (PPE resins), polyoxymethylene resins (such as polyacetal), polyphenylene sulfide resins, polyether imide resins, aromatic polyether ketone resins, polysulfone resins, and polyamidimide resins.

As the raw material(s) for the thermoplastic resin composition according to the present embodiment, these resins may be used alone or a plurality of resins thereof may be used in combination. The plurality of resins indicates a polymer alloy such as PC/ABS or PC/AS. Such a polymer alloy has both characteristics of polycarbonate (the PC resin) and those of the styrene-based resin (such as the ABS resin or the AS resin), and is used in broad fields such as electrical and electronic related applications, OA apparatuses, lighting apparatuses, precision instruments, automobile parts, and housewares.

Because the fatty acid metal salt (C) has a molecular weight lower than those of the thermoplastic resin (A) and the hydrophilic copolymer (B) having a polyoxyethylene chain, even if any one of the resins is used as the raw material, the fatty acid metal salt (C) is likely to be exposed from the surface of the molded article. Thus, a variety of resins can be compounded with the thermoplastic resin composition.

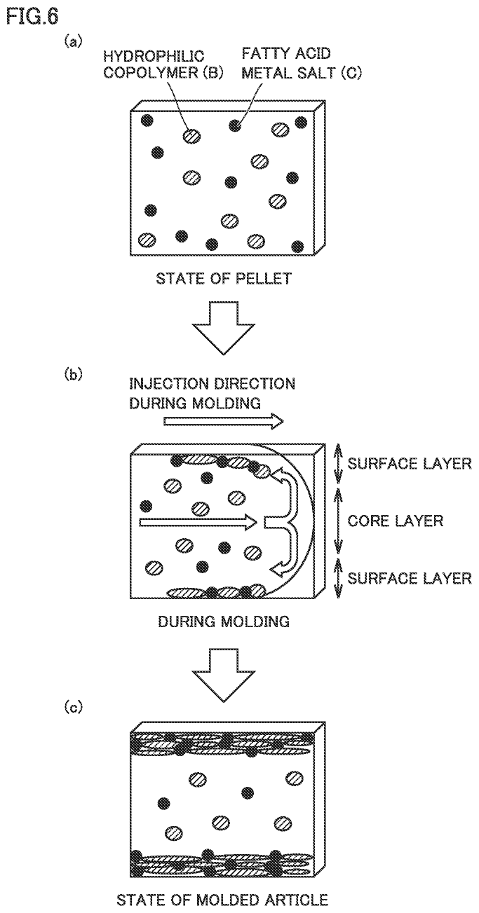

With reference to FIG. 6, the melt viscosity during molding of the fatty acid metal salt (C) and that of the hydrophilic copolymer (B) are different from each other. During molding, the thermoplastic resin (A) injected into a metal mold is first solidified, the hydrophilic copolymer (B) is then solidified, and thereafter the fatty acid metal salt (C) having a low molecular weight is solidified. In other words, because the solidifying rates of the hydrophilic copolymer (B) and the fatty acid metal salt (C) are lower than that of the thermoplastic resin (A), the hydrophilic copolymer (B) and the fatty acid metal salt are likely to be exposed from the surface of the molded article. Because the hydrophilic copolymer (B) and the fatty acid metal salt (C) have a melt viscosity during molding different from that of the thermoplastic resin (A) as described above, the hydrophilic copolymer (B) and the fatty acid metal salt (C) can be compounded with the thermoplastic resin (A).

In contrast, for example, a resin raw material having a high melting point (e.g., about 320° C. or more) and a significantly high polarity is difficult to disperse; thus, a desired effect of suppressing powdery dust is difficult to obtain. In other words, because the hydrophilic copolymer (B) and the fatty acid metal salt (C) are more likely to reside near the surface layer of the molded article than the thermoplastic resin (A) is, the effect of suppressing powdery dust is more readily demonstrated.

Furthermore, the polar group of the fatty acid metal salt (C) having a low molecular weight and the hydrophilic copolymer (B) having a polyoxyethylene chain have compatibility. For this reason, adhesion of the hydrophilic copolymer (B) to the fatty acid metal salt (C) can prevent detachment of the hydrophilic copolymer (B) and the fatty acid metal salt (C), causing a large amount of the hydrophilic copolymer (B) and a large amount of the fatty acid metal salt (C) to be present near the surface layer of the molded article. Thus, the effect of suppressing adhesion is likely to be demonstrated to both hydrophilic powdery dust fouling and hydrophobic powdery dust fouling.

<Production of Thermoplastic Resin Composition>

The thermoplastic resin composition according to the present embodiment can be produced by any method. Examples thereof include a method of sufficiently mixing the thermoplastic resin (A), the hydrophilic copolymer (B), the fatty acid metal salt (C), and other optional additives with preliminary mixing means such as a V-type blender, a Henschel mixer, a mechanochemical apparatus, or an extrusion mixer, optionally granulating the preliminary mixture with an extrusion granulator or a briquetting machine, then melt kneading the kneaded product with a melt kneader such as a vent-type twin screw extruder, and subsequently pelletizing the product with a pelletizer.

Other examples thereof include a method of feeding the components each independently to a melt kneader such as a vent-type twin screw extruder, and a method of preliminarily mixing part of the components, and then feeding the mixture to a melt kneader independently from the remainings of the components. Examples of the method of preliminarily mixing part of the components include a method of preliminarily mixing the components other than the thermoplastic resin (A) and thereafter mixing the mixture with the thermoplastic resin (A) or directly feeding the mixture to an extruder.

As the extruder, those having a vent through which the water content in the raw materials and a volatile gas generated from the melt kneaded resin are discharged can be preferably used. A vacuum pump is preferably disposed to efficiently discharge the water content and the volatile gas generated from the vent to the outside of the extruder. In addition, a screen for removing foreign substances mixed in the extruded raw material can be disposed in a zone upstream of an extruder die to remove foreign substances from the resin composition. Examples of such a screen include metallic meshes, screen changers, and sintered metal plates (such as disk filters).

Examples of the melt kneader include a twin screw extruder, a Banbury mixer, a kneading roll, a single screw extruder, and a multi-screw extruders having 3 or more screws.

The thermoplastic resin composition extruded as above are pelletized by directly cutting the extruded thermoplastic resin composition, or is pelletized by forming strands and then cutting the strands with a pelletizer. The shape of the pellet is suitably columnar. The diameter of the column is preferably 1 to 5 mm, more preferably 1.5 to 4 mm, still more preferably 2 to 3.3 mm. On the other hand, the length of the column is preferably 1 to 30 mm, more preferably 2 to 5 mm, still more preferably 2.5 to 3.5 mm.

Usually the thermoplastic resin composition according to the present embodiment can be produced into a variety of products by obtaining a molded article through injection molding of the pellets thereof. Examples of such injection molding include not only a standard molding method but also injection compression molding, injection press molding, gas assist injection molding, foaming molding (including a method of injecting a supercritical fluid), insert molding, inmold coating molding, heat-insulating mold molding, rapid heating/cooling mold molding, two-color molding, sandwich molding, and ultra-high speed injection molding. Any one of cold runner molding and hot runner molding can be selected.

Moreover, by extrusion molding, the thermoplastic resin composition according to the present embodiment can also be used in a variety of forms, such as various extrusion molded products, sheets, and films. The thermoplastic resin composition according to the present embodiment can also be molded into sheets and films thereof by inflation, calendering, or casting. Furthermore, the thermoplastic resin composition according to the present embodiment can also be molded into a thermally shrunk tube by performing a drawing operation thereon. The thermoplastic resin composition according to the present embodiment can also be formed into molded articles by rotational molding or blow molding.

### Embodiment 2

The molded article according to the present embodiment comprises the thermoplastic resin composition described above. The molded article according to the present embodiment comprising the thermoplastic resin composition provides an effect of suppressing adhesion of both hydrophilic powdery dust fouling and hydrophobic powdery dust fouling.

In the molded article according to the present embodiment, the concentration (content in the thermoplastic resin composition) of the fatty acid metal salt (C) near the surface of the molded article (in a portion ranging from the surface to a predetermined depth) is preferably higher than that of the fatty acid metal salt (C) inside the molded article (in a portion deeper than the predetermined depth from the surface). Specifically, for example, the concentration of the fatty acid metal salt (C) in a portion ranging from the surface of the molded article to a depth of 10 nm deeper from the surface is preferably higher than that of the fatty acid metal salt (C) in a portion deeper than the depth of 10 nm deeper from the surface.

The term “surface of the molded article” used here indicates at least part of the surface of the molded article, and does not need to be the entire surface of the molded article and may be part of the surface of the molded article.

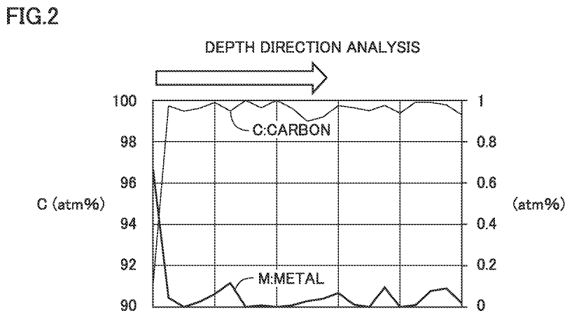

Such a difference in the concentration of the fatty acid metal salt (C) in the depth direction of the molded article can be verified, for example, by scraping the surface of the molded article with Ar ions to depths and performing elemental analysis of the metal element M (measurement of the area ratio of the metal element M) on the surface of the molded article scraped to each of the depths by X-ray photoemission spectroscopy (XPS) (see FIG. 2).

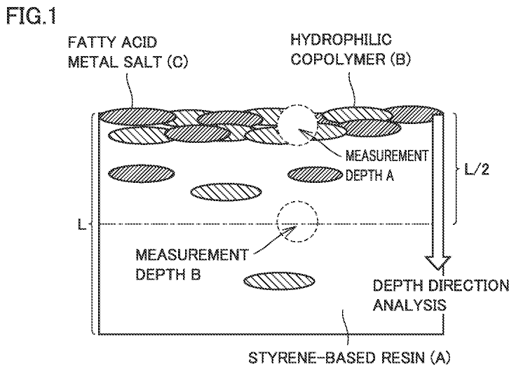

For example, as shown in FIG. 1, the concentrations of the fatty acid metal salt (C) (area ratios of the metal element M) at the respective depths are measured in a portion located within 10 nm from the surface of the molded article (measurement depth A) to determine the highest concentration among them. On the other hand, the concentration of the fatty acid metal salt (C) is measured at a depth corresponding to a half of the thickness L of the molded article (U/2: measurement depth B) shown by the dotted line in FIG. 1. By comparing these measured values of the concentration, the difference in the concentration of the fatty acid metal salt (C) in the depth direction of the molded article can be verified.

For example, in the sample (test piece) of the molded article having an amphoteric anti-contamination effect described later in Examples, the concentration of the fatty acid metal salt (C) in the portion located within 10 nm from the surface was two or more times the concentration of the fatty acid metal salt (C) in the portion deeper than the portion located within 10 nm from the surface of the molded article. In one specific example, the concentration of the fatty acid metal salt (C) in the portion located within 10 nm from the surface was 3.2% by mass at the maximum, and the concentration of the fatty acid metal salt (C) in the portion deeper than the portion located within 10 nm from the surface of the molded article was about 0.3% by mass to 0.6% by mass. The former was about 5 to 10 times the latter.

In the fatty acid metal salt (C), R is a non-polar group and the residue is a polar group. It is considered that during molding, the polar group adheres to the metal mold, and thus the fatty acid metal salt (C) is aligned in the state where the non-polar group is directed to the inside of the thermoplastic resin composition. Furthermore, after molding, the fatty acid metal salt (C) melted inside the thermoplastic resin composition migrates to the surfaces thereof.

Due to low miscibility with the thermoplastic resin, the fatty acid metal salt (C) is diffused to the surface of the thermoplastic resin composition (molded article) if compounded in an amount equal to or above critical solubility (concentration). It is considered that near the surfaces of the thermoplastic resin composition, a plurality of fatty acid metal salts (C) are bonded with their polar groups, and are aligned such that the hydrophobic groups Rs as the non-polar group are directed toward the outside (the air side) of the molded article.

Accordingly, the concentration of the fatty acid metal salt (C) in the thermoplastic resin composition near the surface of the molded article is higher than that inside the molded article, thus efficiently reducing the surface energy and providing a water and oil repellant effect on the surface of the molded article to which powdery dust fouling adheres. As a result, unlike the cases where the fatty acid metal salt (C) is used in standard applications such as a lubricant, a mold release agent, and the like, a novel effect of suppressing adhesion of hydrophobic powdery dust fouling on the surface of the molded article is obtained.

If a resin material after subjected to liquefaction once is molded into any shape to mold a molded article, the above effect can be obtained by providing the component proportion of the thermoplastic resin composition according to Embodiment 1 at the stage of liquefaction. For example, at the stage where the resin material is liquefied, the thermoplastic resin composition according to the present embodiment can also contain optional components described in Embodiment 1.

### Embodiment 3

The product according to the present embodiment includes the molded article described above. In other words, the molded article is used as resin parts (such as inner parts and housings) for products such as home appliances and OA apparatuses, for example. The product according to the present embodiment including the molded article above provides effects of improving cleanliness and reducing the frequency of maintenance.

Examples of the product include personal computers, laptop personal computers, CRT displays, printers, mobile terminals, mobile phones, copiers, fax machines, drivers for recording media (such as CDs, CD-ROMs, DVDs, PDs, and FDDs), parabola antennas, electric tools, VTRs, television sets, irons, hair dryers, rice cookers, microwave ovens, acoustic instruments, sound instruments (such as audio, laser disks (registered trademark), and compact disks), lighting apparatuses (LED), remote controllers, vent fans, range hoods, refrigerators, air conditioners (such as air conditioners, dehumidifiers, and humidifiers), air purifiers, cleaners, rice cookers, cooking heaters, bath goods, lavatory goods, jet towels, electric fans, typewriters, word processors, automobiles, apparatuses for automobiles (such as car navigators and car stereo systems), and sundry goods.

For example, if the molded article is used in resin parts for air conditioners, doors, display apparatuses, insulators, mirrors, measurement instruments, and operational units of a variety of apparatuses, adhesion of powdery dust fouling can be reduced to improve cleanliness and reduce the frequency of maintenance. In particular, the molded article is useful as resin parts for products which cannot be maintained for a long time by users or vendors.

The molded article according to the present embodiment comprising the thermoplastic resin composition above can be used in products including resin parts, and can be used in the applications above but also in broader applications.

Because the anti-contamination effect is simply obtained only by molding, the molded article according to the present embodiment comprising the thermoplastic resin composition above has an advantage over paintings and coatings having an anti-contamination effect such that the number of complex steps such as movement of the molded article and application work is significantly smaller. For this reason, the molded article comprising the thermoplastic resin composition above is suitable for mass production of products and has extremely high utility. Moreover, the molded article comprising the thermoplastic resin composition above is suitable for mass production of products and has extremely high utility because the molded article comprising the thermoplastic resin composition above has an advantage over paintings and coatings having an anti-contamination effect such that it is more readily used as an outer member without caring about uneven coating of the surface, rainbow patterns, and the gloss level.

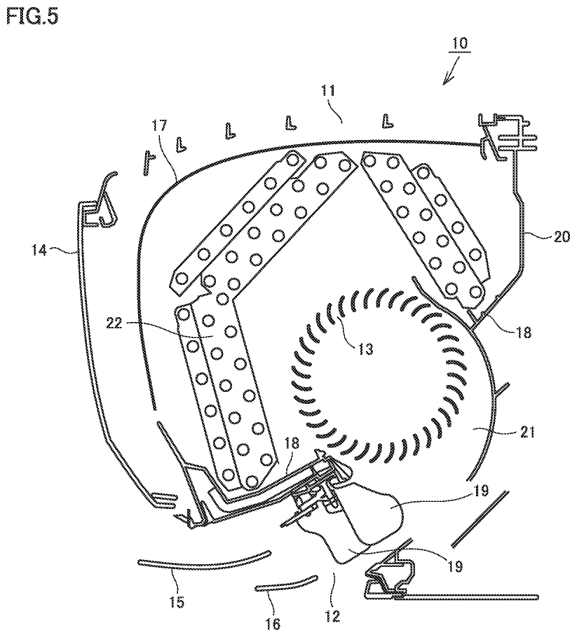

FIG. 5 is a cross-sectional schematic view showing an air conditioner according to the present embodiment. As shown in FIG. 5, a body case 10 of the indoor equipment of the air conditioner is formed in a shape horizontally long and approximately cuboidal. An air suction port 11 is disposed on the top surface. An air discharge port 12 is disposed in a lower portion of the front surface. A prefilter 17 is disposed from a side downstream of air suction port 11 to the front surface side of body case 10. A front surface panel 14 is disposed to cover the front surface of body case 10.

A fan 13 for discharging indoor air, which is suctioned from air suction port 11, from air discharge port 12 is disposed inside body case 10. A heat exchanger 22 is disposed upstream of fan 13, and a wind path 21 is present downstream of fan 13. The air passes through wind path 21. A drain pan 18 is disposed under heat exchanger 22.

Although not illustrated, a fan motor which drives fan 13, a controller which controls the operation of the air conditioner, and the like are disposed inside body case 10.

Vertical wind directing plates 15 and 16 adjust the discharge angle of the air discharged from air discharge port 12 in the vertical direction. A horizontal wind directing plate 19 adjusts the discharge angle of the air discharged from air discharge port 12 in the vertical direction. A support shaft is disposed at one end of vertical wind directing plates 15 and 16, and is supported by a bearing disposed on the side wall of air discharge port 12 to be freely swung and attachable/detachable. There are three cases for horizontal wind directing plate 19, i.e., it is fixed, the direction thereof can be manually set, or it is driven by a motor to be automatically swung in the horizontal direction.

After fan 13 is driven, the indoor air is suctioned from air suction port 11, passes through prefilter 17, heat exchanger 22, fan 13, wind path 21, air discharge port 12, horizontal wind directing plate 19, and vertical wind directing plates 15 and 16 in this order, and is discharged into the room. Together with the air, hydrophilic powdery dust fouling such as dust and sand fiber and hydrophobic powdery dust fouling such as oily smoke, soot, sebum, and tobacco with the wind are brought into contact with the members of the air conditioner. For this reason, air suction port 11, prefilter 17, heat exchanger 22, fan 13, wind path 21, air discharge port 12, horizontal wind directing plate 19, and vertical wind directing plates 15 and 16 are always continuously contaminated. Because the suctioned air is also brought into contact with a rear surface wall 20 facing prefilter 17 in front surface panel 14, rear surface wall 20 is also continuously contaminated.

A styrene-based resin such as PS or ABS is often used as the constitutional material for front surface panel 14, air discharge port 12, horizontal wind directing plate 19, vertical wind directing plates 15 and 16, wind path 21, and rear surface wall 20. To be noted, an olefin resin such as polypropylene (PP) is often used as the constitutional material for the frame of prefilter 17. An olefin resin such as PP or a styrene-based resin such as AS is often used as the constitutional material for fan 13.

The molded article comprising the thermoplastic resin composition above can be suitably used in products always continuously contaminated, such as the air conditioner.

Because fouling of the members can be reduced, an improvement in cleanliness and a reduction in frequency of maintenance can be expected as the effects when the molded article comprising the thermoplastic resin composition above is used in the air conditioner. Moreover, because of no rescattering of fouling, an odor caused by fouling and discomfort caused by the odor arriving with the wind are reduced. In addition, generation of fungi which take nourishment from fouling can be suppressed. Users need to clean the products installed in a high position close to the ceiling, such as the air conditioner, using a stepladder, and have difficulties in cleaning. However, use of the molded article above can reduce the frequency of cleaning, which is particularly preferred for the elderly people.

If the air path is narrowed by fouling deposited and filled between gaps of fan 13 or deposited on the surfaces of the wind paths, the cooling and heating ability reduces due to a reduction in wind amount or the power consumption of the fan increases. However, by suppressing fouling by use of the molded article above, the initial wind amount when purchased can be maintained to suppress an increase in power consumption.

Besides, for example, a styrene-based resin such as ABS or PS or an olefin resin such as PP is often used in trays for storing vegetables in refrigerators. A styrene-based resin such as ABS or PS or an olefin resin such as PP is often used in the dust box of the cleaner. An olefin resin such as PP is often used in sirocco fans of various vent fans and fan blades of electric fans. In all the cases, a reduction in fouling can reduce the time and effort needed for maintenance.

### EXAMPLES

<Methods for Evaluations>

### (1) Tensile Strength

The tensile strength (tensile stress at yield) was measured according to ISO 527-1,2. Compared to the tensile strength of the styrene-based resin (component A) in terms of the measured value, evaluation was performed according to the following criteria.

[Criteria for Evaluation of Tensile Strength]

A: a retention rate of 95% or more, B: a retention rate of less than 95% and 90% or more, C: a retention rate of less than 90% and 85% or more, D: less than 85%

### (2) Flexural Modulus

The flexural modulus was measured according to ISO 178 (size of the test piece: length of 80 mm×width of 10 mm×thickness of 4 mm). Compared to the flexural modulus of the styrene-based resin (component A) in terms of the measured value, evaluation was performed according to the following criteria.

[Criteria for Evaluation of Flexural Modulus]

A: a retention rate of 95% or more, B: a retention rate of less than 95% and 90% or more, C: a retention rate of less than 90% and 85% or more, D: less than 85%

### (3) Charpy Impact Strength

The Charpy impact strength of samples with a notch was measured according to ISO 179.

### (4) Surface Impact Strength

A rectangular plate of 150 mm×150 mm×2 mm (thickness) was molded using an injection molding machine. A high-speed surface impact test was performed atN=5 to measure the surface impact strength (breaking energy). The average at N=5 was determined. The form of fracture was evaluated according to the following criteria.

[Criteria for Evaluation of Form of Fracture]

A: ductile fracture, B: ductile fracture mixed with brittle fracture (the number of ductile fractures >the number of brittle fractures), C: ductile fracture mixed with brittle fracture (the number of brittle fractures >the number of ductile fractures), D: brittle fracture

In the evaluation of the form of fracture, the fracture of the test piece after the impact test was determined as ductile fracture if the test piece was not scattered without breakage and had uniform projections left in the portion through which the punch penetrated. The fracture of the test piece after the impact test was determined as brittle fracture if the test piece was broken into a shape of the punch or the cradle and had a flat portion through which the punch penetrated and a sharp end surface thereof. For the form of fracture, the ductile fracture is preferred to the brittle fracture.

As the tester, a high-speed surface impact tester Hydroshot HTM-1 (manufactured by SHIMADZU Corporation) was used. For the test conditions, the punch impact rate was 7 m/sec, the punch used had a semicircular distal end having a radius of 6.35 mm, and the hole of the cradle had a diameter of 25.4 mm.

### (5) Deflection Temperature Under Load

The deflection temperature under load was measured according to ISO 75-1 and ISO 75-2. The load for measurement was 1.80 MPa.

### (6) Evaluation of Powdery Dust Adhesive Properties

A rectangular plate of 150 mm×150 mm×2 mm (thickness) was prepared, and was left under an environment at 23° C. and a humidity of 50% for a week. Thereafter, the rectangular plate was tested about powdery dust adhesive properties. Kanto loam (JIS-11 test powder) was used in the evaluation on hydrophilic powdery dust adhesive properties, and carbon black (JIS-12 test powder) was used in the evaluation on hydrophobic powdery dust adhesive properties.

In the evaluation on the powdery dust adhesive properties, a predetermined amount (5 g) of powdery dust was air blown onto the surface of a molded article, and the surface of the molded article was observed at 100× with a KEYENCE digital microscope VHX-5000 to determine the proportion of the adhesion area of powdery dust by image processing. Then, evaluation was performed according to the following criteria.

[Criteria for Evaluation on Powdery Dust Adhesive Properties]

A: a proportion of the adhesion area of powdery dust of less than 3%, B: a proportion of the adhesion area of powdery dust of 3 to less than 6%, C: a proportion of the adhesion area of powdery dust of 6 to less than 9%, D: a proportion of the adhesion area of powdery dust of more than 9%

### Examples a1 to a55, b1 to b160, Comparative Examples a1 to a54, b1 to b160

As shown in Tables 1 to 22, 100 parts by mass of components A to C (total amount of the components A to C), 0.3 parts by mass of a mold release agent [manufactured by Riken Vitamin Co., Ltd.: Rikester EW400 (product name)], 0.1 parts by mass of a phosphorus-based heat stabilizer [manufactured by BASF SE, IRGAFOS168 (product name)], 0.1 parts by mass of a phenol-based heat stabilizer [manufactured by BASF SE; IRGANOX1076 (product name)], 0.2 parts by mass of a hindered amine-based photostabilizer [manufactured by ADEKA CORPORATION, Adekastab LA-57 (product name)], and 0.1 parts by mass of a benzotriazole-based ultraviolet absorbing agent [manufactured by SHIPRO KASEIKAISHA, LTD., SEESORB701 (product name)] were mixed with a V-type blender to prepare a mixture.

The resulting mixture was fed from the first feeding port of an extruder. The amount of the raw material (mixture) fed was precisely measured with a measuring apparatus [manufactured by Kubota Corporation, CWF]. The raw material was extruded with a vent-type twin screw extruder (manufactured by The Japan Steel Works, Ltd., TEX30 α-38.5 BW-3V) having a diameter of 30 mm, and was melt kneaded under the condition at a number of rotations of the screw of 200 rpm, an ejection amount of 20 kg/h, and a degree of vacuum of the vent of 3 kPa to prepare pellets of the thermoplastic resin composition. For the extrusion temperature, the temperature from the first feeding port to the die was set at 230° C. (Examples a1 to a55 and Comparative Examples a1 to a54) or the temperature shown in the tables (Examples b1 to b160 and Comparative Examples b1 to b160) was set.

Part of the resulting pellets was dried at 80° C. (Examples a1 to a55 and Comparative Examples a1 to a54) or the temperature shown in the tables (Examples b1 to b160 and Comparative Examples b1 to b160) for 4 hours in a hot air circulating dryer, and was molded into test pieces for evaluation (Examples a1 to a55, b1 to b160 and Comparative Examples a1 to a54, b1 to b160) using an injection molding machine (manufactured by FANUC CORPORATION, T-150D). As the basic conditions for injection molding, the cylinder temperature was 200° C., the metal mold temperature was 50° C. (Examples a1 to a55 and Comparative Examples a1 to a54) or the temperature shown in the tables (Examples b1 to b160 and Comparative Examples b1 to b160), and the injection rate was 20 mm/s.

The components A to C shown in Tables 1 to 22 (components represented by the symbols in the tables) are as follows.

### [Component A]

### (PC: A1 Component-1)

An aromatic polycarbonate resin [manufactured by Teijin Limited, Panlite L-1225WX bisphenol A polycarbonate resin, viscosity average molecular weight=19,700]

### (ABS: A2 Component-1)

An ABS resin [manufactured by NIPPON A&L INC., KRALASTIC SXH-330 (trade name), mass average molecular weight measured by GPC in terms of standard polystyrene: 90000, butadiene rubber component: about 17.5% by mass, mass average rubber particle diameter: 0.40 μm]

### (HIPS: A2 Component-2)

A high impact polystyrene resin [manufactured by PS Japan Corporation, H8672 (product name), rubber content: 9% by mass]

### (PS: A2 Component-3)

A polystyrene resin [manufactured by PS Japan Corporation, H77 (product name)]

### (PET: A3 Component-1)

A polyethylene terephthalate resin [manufactured by Teijin Limited, PET resin TR-8580H, Ge catalyst USED, IV=0.83]

### (PBT: A3 Component-2)

A polybutylene terephthalate resin [manufactured by POLYPLASTICS CO., LTD., DURANEX 500FP EF202X, IV=0.85])
(m-PPE: A4 Component-1)
A modified polyphenylene ether resin [prepared by melt kneading polyphenylene ether prepared through oxidation polymerization of 2,6-xylenol (reduced viscosity of polyphenylene ether=0.42 dL/g, which was measured at 30° C. using a 0.5 g/dL chloroform solution) and HIPS (manufactured by PS Japan Corporation, H8672) at a weight ratio of 40/60 using a vent-type twin screw extruder (The Japan Steel Works, Ltd., TEX30(x-38.5BW-3V) having a diameter of 30 mm where the cylinder temperature was 300° C., the number of rotations of the screw was 200 rpm, the ejection amount was 20 kg/h, and the degree of vacuum of the vent was 3 kPa.]

### (PMMA: A5 Component-1)

A polymethyl methacrylate resin [high impact methacrylic resin: manufactured by MITSUBISHI RAYON CO., LTD., ACRYPET IRS204, an acrylic resin comprising an acrylic resin matrix component and an acrylic rubber component, MFR=13 g/10 min (230° C./3.8 kgf)]

### (PPS: A6 Component-1)

A polyphenylene sulfide resin [prepared as follows: 16.5 kg of sodium sulfide (containing 49% of crystal water), 6.5 kg of sodium hydroxide, 5.2 kg of sodium acetate, and 22.0 kg of N-methyl-2-pyrrolidone were charged, and were dehydrated at 210° C. Thereafter, 20.5 kg of 1,4-dichlorobenzene and 20.0 kg of N-methyl-2-pyrrolidone were added to perform a reaction at 265° C. for 5 hours. The reaction product was washed with water, and then was dried. The glass transition temperature was 90° C., the melting point was 280° C., and the number average molecular weight was 11500.]

### (PA6: A8 Component-1)

A polyamide 6 resin [manufactured by Toray Industries, Inc., AMILAN CM1017, melting point=225° C.]

### (PA66: A8 Component-2)

A polyamide 66 resin [manufactured by Toray Industries, Inc., AMILAN CM3001-N, melting point=260° C.]

### [Component B]

### (PEPO-1)

A copolymer having a structure in which a polyolefin block and a hydrophilic polymer block were repeatedly and alternately bonded [manufactured by Sanyo Chemical Industries, Ltd., PELECTRON HS (trade name), surface resistance value=4×10⁵Ω] (PEPO-2)
A polyether ester amide [manufactured by Sanyo Chemical Industries, Ltd., PELESTAT NC6321 (trade name), surface resistance value=1×10⁹Ω]

### [Component C]

### (StZn)

zinc stearate [manufactured by NOF CORPORATION, zinc stearate (product name), metal content=10.5 to 11.3%, free fatty acid=0.5% or less]

### (StAl-1)

(dihydroxy)aluminum monostearate [manufactured by NOF CORPORATION, aluminum stearate 300 (product name), metal content=10.0 to 11.5%, free fatty acid=8.0% or less]

### (StAl-2)

(hydroxy)aluminum distearate [manufactured by NOF CORPORATION, aluminum stearate 600 (product name), metal content=8.5 to 10.0%, free fatty acid=12.0% or less]

### (StAl-3)

aluminum tristearate [manufactured by NOF CORPORATION, aluminum stearate 900 (product name), metal content=6.5 to 8.0%, free fatty acid=20 to 30%] The results of evaluations (1) to (6) above of the test pieces for evaluation (Examples a1 to a55, b1 to b160 and Comparative Examples a1 to a54, b1 to b160) are shown in Tables 1 to 22. To be noted, all of the evaluations (1) to (6) were not performed in all the Examples and Comparative Examples.

TABLE 1

| | | | | Example | | | | | | | | | |
|---|---|---|---|---|---|---|---|---|---|---|---|---|---|
| Items | | | Units | a1 | a2 | a3 | a4 | a5 | a6 | a7 | a8 | a9 | a10 |
| Composition | Component A | ABS | parts by | 100 | 100 | 100 | 100 | 100 | 100 | 100 | 100 | 100 | 100 |
| | | | mass | | | | | | | | | | |
| | Component B | PEPO-1 | parts by | 0.5 | 3.0 | 5.0 | 10.0 | 18.0 | 24.0 | 5.0 | 5.0 | 5.0 | 5.0 |
| | | PEPO-2 | mass | — | — | — | — | — | — | — | — | — | — |
| | Component C | StZn | parts by | — | — | — | — | — | — | — | — | — | — |
| | | StAl-1 | mass | — | — | — | — | — | — | — | — | — | — |
| | | StAl-2 | | 2.0 | 2.0 | 2.0 | 2.0 | 2.0 | 2.0 | 0.3 | 1.0 | 5.0 | 8.0 |
| | | StAl-3 | | — | — | — | — | — | — | — | — | — | — |

| | | | | | | | | | | | | |
|---|---|---|---|---|---|---|---|---|---|---|---|---|
| Evaluations | Tensile strength | MPa | 47 | 47 | 47 | 45 | 44 | 42 | 47 | 48 | 48 | 48 |
| | Evaluation | — | A | A | A | A | B | C | A | A | A | A |
| | Flexural modulus | MPa | 2340 | 2340 | 2330 | 2260 | 2150 | 2090 | 2320 | 2330 | 2350 | 2370 |
| | Evaluation | — | A | A | A | A | B | C | A | A | A | A |
| | Charpy impact strength | kJ/m² | 22 | 23 | 24 | 22 | 22 | 21 | 22 | 22 | 21 | 20 |
| | Surface impact strength | J | 24 | 24 | 23 | 23 | 22 | 22 | 24 | 23 | 21 | 19 |
| | (breakage energy) | | | | | | | | | | | |
| | Form of fracture | — | A | A | A | A | A | A | A | A | A | B |
| | Deflection temperature | ° C. | 79 | 79 | 79 | 78 | 78 | 77 | 79 | 77 | 77 | 76 |
| | under load | | | | | | | | | | | |
| | Hydrophilic powdery dust | % | 5 | 2 | 1 | 1 | 1 | 1 | 4 | 1 | 1 | 1 |
| | adhesive properties | | | | | | | | | | | |
| | Evaluation | — | B | A | A | A | A | A | B | A | A | A |
| | Hydrophobic powdery dust | % | 4 | 2 | 2 | 1 | 1 | 1 | 5 | 2 | 1 | 1 |
| | adhesive properties | | | | | | | | | | | |
| | Evaluation | — | B | A | A | A | A | A | B | A | A | A |

| | | | | Example | | | | | | | | |
|---|---|---|---|---|---|---|---|---|---|---|---|---|
| Items | | | Units | a11 | a12 | a13 | a14 | a15 | a16 | a17 | a18 | a19 |
| Composition | Component A | ABS | parts by | 100 | 100 | 100 | 100 | 100 | 100 | 100 | 100 | 100 |
| | | | mass | | | | | | | | | |
| | Component B | PEPO-1 | parts by | 5.0 | — | — | 5.0 | 5.0 | 5.0 | 5.0 | 5.0 | 5.0 |
| | | PEPO-2 | mass | — | 5.0 | 10.0 | — | — | — | — | — | — |
| | Component C | StZn | parts by | — | — | — | 0.3 | 2.0 | — | — | — | — |
| | | StAl-1 | mass | — | — | — | — | — | 0.3 | 2.0 | — | — |
| | | StAl-2 | | 12.0 | 2.0 | 2.0 | — | — | — | — | — | — |
| | | StAl-3 | | — | — | — | — | — | — | — | 0.3 | 2.0 |

| | | | | | | | | | | | |
|---|---|---|---|---|---|---|---|---|---|---|---|
| Evaluations | Tensile strength | MPa | 49 | 47 | 46 | 48 | 48 | 48 | 47 | 47 | 48 |
| | Evaluation | — | A | A | A | A | A | A | A | A | A |
| | Flexural modulus | MPa | 2380 | 2350 | 2250 | 2330 | 2340 | 2340 | 2300 | 2320 | 2350 |
| | Evaluation | — | A | A | A | A | A | A | A | A | A |
| | Charpy impact strength | kJ/m² | 18 | 23 | 22 | 22 | 22 | 23 | 22 | 23 | 23 |
| | Surface impact strength | J | 19 | 23 | 22 | 23 | 23 | 23 | 23 | 22 | 23 |
| | (breakage energy) | | | | | | | | | | |
| | Form of fracture | — | C | A | A | A | A | A | A | A | A |
| | Deflection temperature | ° C. | 74 | 78 | 78 | 78 | 78 | 78 | 77 | 78 | 77 |
| | under load | | | | | | | | | | |
| | Hydrophilic powdery dust | % | 1 | 4 | 1 | 6 | 6 | 6 | 4 | 6 | 4 |
| | adhesive properties | | | | | | | | | | |
| | Evaluation | — | A | B | A | C | C | C | B | C | B |
| | Hydrophobic powdery dust | % | 1 | 4 | 2 | 7 | 7 | 6 | 5 | 8 | 5 |
| | adhesive properties | | | | | | | | | | |
| | Evaluation | — | A | B | A | C | C | C | B | C | B |

TABLE 2

| | | | | Example | | | | | | | | |
|---|---|---|---|---|---|---|---|---|---|---|---|---|
| Items | | | Units | a20 | a21 | a22 | a23 | s24 | a25 | a26 | a27 | a28 |
| Composition | Component A | HIPS | parts by | 100 | 100 | 100 | 100 | 100 | 100 | 100 | 100 | 100 |
| | | | mass | | | | | | | | | |
| | Component B | PEPO-1 | parts by | 0.5 | 3.0 | 5.0 | 10.0 | 18.0 | 24.0 | 5.0 | 5.0 | 5.0 |
| | | PEPO-2 | mass | — | — | — | — | — | — | — | — | — |
| | Component C | StZn | parts by | — | — | — | — | — | — | — | — | — |
| | | StAl-1 | mass | — | — | — | — | — | — | — | — | — |
| | | StAl-2 | | 2.0 | 2.0 | 2.0 | 2.0 | 2.0 | 2.0 | 0.3 | 1.0 | 8.0 |
| | | StAl-3 | | — | — | — | — | — | — | — | — | — |
| Evaluations | Tensile strength | | MPa | 30 | 30 | 29 | 29 | 28 | 26 | 30 | 30 | 31 |
| | Evaluation | | — | A | A | A | A | B | C | A | A | A |
| | Flexural modulus | | MPa | 2210 | 2220 | 2190 | 2150 | 2080 | 1950 | 2200 | 2210 | 2260 |
| | Evaluation | | — | A | A | A | A | B | C | A | A | A |
| | Deflection temperature | | ° C. | 76 | 76 | 75 | 75 | 75 | 74 | 76 | 75 | 72 |
| | under load | | | | | | | | | | | |
| | Hydrophilic powdery dust | | % | 4 | 2 | 1 | 1 | 1 | 1 | 3 | 1 | 1 |
| | adhesive properties | | | | | | | | | | | |
| | Evaluation | | — | B | A | A | A | A | A | B | A | A |
| | Hydrophobic powdery dust | | % | 4 | 2 | 2 | 2 | 1 | 1 | 5 | 2 | 2 |
| | adhesive properties | | | | | | | | | | | |
| | Evaluation | | — | B | A | A | A | A | A | B | A | A |
| | | | | Example | | | | | | | | |
| Items | | | Units | a29 | a30 | a31 | a32 | a33 | a34 | 435 | a36 | a37 |
| Composition | Component A | HIPS | parts by | 100 | 100 | 100 | 100 | 100 | 100 | 100 | 100 | 100 |
| | | | mass | | | | | | | | | |
| | Component B | PEPO-1 | parts by | 5.0 | — | — | 5.0 | 5.0 | 5.0 | 5.0 | 5.0 | 5.0 |
| | | PEPO-2 | mass | — | 5.0 | 10.0 | — | — | — | — | — | — |
| | Component C | StZn | parts by | — | — | — | 0.3 | 2.0 | — | — | — | — |
| | | StAl-1 | mass | — | — | — | — | — | 0.3 | 2.0 | — | — |
| | | StAl-2 | | 12.0 | 2.0 | 2.0 | — | — | — | — | — | — |
| | | StAl-3 | | — | — | — | — | — | — | — | 0.3 | 2.0 |

| | | | | | | | | | | | |
|---|---|---|---|---|---|---|---|---|---|---|---|
| Evaluations | Tensile strength | MPa | 31 | 29 | 29 | 30 | 29 | 29 | 29 | 30 | 29 |
| | Evaluation | — | A | A | A | A | A | A | A | A | A |
| | Flexural modulus | MPa | 2270 | 2200 | 2160 | 2190 | 2200 | 2200 | 2210 | 2210 | 2200 |
| | Evaluation | — | A | A | A | A | A | A | A | A | A |
| | Deflection temperature | ° C. | 69 | 75 | 75 | 75 | 75 | 76 | 75 | 76 | 75 |
| | under load | | | | | | | | | | |
| | Hydrophilic powdery dust | % | 1 | 3 | 1 | 8 | 6 | 4 | 4 | 6 | 3 |
| | adhesive properties | | | | | | | | | | |
| | Evaluation | — | A | B | A | C | C | B | B | C | B |
| | Hydrophobic powdery dust | % | 1 | 3 | 2 | 7 | 7 | 6 | 4 | 7 | 4 |
| | adhesive properties | | | | | | | | | | |
| | Evaluation | — | A | B | A | C | C | C | B | C | B |

TABLE 3

| | | | | Example | | | | | | | | |
|---|---|---|---|---|---|---|---|---|---|---|---|---|
| Items | | | Units | a38 | a39 | a40 | a41 | a42 | a43 | a44 | a45 | a46 |
| Composition | Component A | PS | parts by | 100 | 100 | 100 | 100 | 100 | 100 | 100 | 100 | 100 |
| | | | mass | | | | | | | | | |
| | Component B | PEPO-1 | parts by | 0.5 | 3.0 | 5.0 | 10.0 | 18.0 | 24.0 | 5.0 | 5.0 | 5.0 |
| | | PEPO-2 | mass | — | — | — | — | — | — | — | — | — |
| | Component C | StZn | parts by | — | — | — | — | — | — | — | — | — |
| | | StAl-1 | mass | — | — | — | — | — | — | — | — | — |
| | | StAl-2 | | 2.0 | 2.0 | 2.0 | 2.0 | 2.0 | 2.0 | 0.3 | 1.0 | 8.0 |
| | | StAl-3 | | — | — | — | — | — | — | — | — | — |
| Evaluations | Tensile strength | | MPa | 40 | 39 | 39 | 39 | 37 | 35 | 39 | 39 | 40 |
| | Evaluation | | — | A | A | A | A | B | C | A | A | A |
| | Flexural modulus | | MPa | 3220 | 3200 | 3200 | 3130 | 2950 | 2860 | 3220 | 3200 | 3230 |
| | Evaluation | | — | A | A | A | A | B | C | A | A | A |
| | Deflection temperature | | ° C. | 75 | 75 | 75 | 75 | 74 | 73 | 75 | 75 | 72 |
| | under load | | | | | | | | | | | |
| | Hydrophilic powdery dust | | % | 4 | 2 | 1 | 1 | 1 | 1 | 3 | 2 | 1 |
| | adhesive properties | | | | | | | | | | | |
| | Evaluation | | — | B | A | A | A | A | A | B | A | A |
| | Hydrophobic powdery dust | | % | 5 | 2 | 2 | 2 | 1 | 1 | 5 | 2 | 1 |
| | adhesive properties | | | | | | | | | | | |
| | Evaluation | | — | B | A | A | A | A | A | B | A | A |
| | | | | Example | | | | | | | | |
| Items | | | Units | a47 | a48 | a49 | a50 | a51 | a52 | a53 | a54 | a55 |
| Composition | Component A | PS | parts by | 100 | 100 | 100 | 100 | 100 | 100 | 100 | 100 | 100 |
| | | | mass | | | | | | | | | |
| | Component B | PEPO-1 | parts by | 5.0 | — | — | 5.0 | 5.0 | 5.0 | 5.0 | 5.0 | 5.0 |
| | | PEPO-2 | mass | — | 5.0 | 10.0 | — | — | — | — | — | — |
| | Component C | StZn | parts by | — | — | — | 0.3 | 2.0 | — | — | — | — |
| | | StAl-1 | mass | — | — | — | — | — | 0.3 | 2.0 | — | — |
| | | StAl-2 | | 12.0 | 2.0 | 2.0 | — | — | — | — | — | — |
| | | StAl-3 | | — | — | — | — | — | — | — | 0.3 | 2.0 |

| | | | | | | | | | | | |
|---|---|---|---|---|---|---|---|---|---|---|---|
| Evaluations | Tensile strength | MPa | 41 | 39 | 39 | 40 | 39 | 39 | 39 | 39 | 39 |
| | Evaluation | — | A | A | A | A | A | A | A | A | A |
| | Flexural modulus | MPa | 3270 | 3200 | 3180 | 3210 | 3220 | 3200 | 3220 | 3190 | 3210 |
| | Evaluation | — | A | A | A | A | A | A | A | A | A |
| | Deflection temperature | ° C. | 69 | 75 | 75 | 75 | 74 | 74 | 74 | 75 | 75 |
| | under load | | | | | | | | | | |
| | Hydrophilic powdery dust | % | 1 | 3 | 1 | 6 | 6 | 6 | 4 | 4 | 4 |
| | adhesive properties | | | | | | | | | | |
| | Evaluation | — | A | B | A | C | C | C | B | B | B |
| | Hydrophobic powdery dust | % | 1 | 4 | 2 | 7 | 6 | 7 | 5 | 6 | 5 |
| | adhesive properties | | | | | | | | | | |
| | Evaluation | — | A | B | A | C | C | C | B | C | B |

TABLE 4

| | | | | Comparative Example | | | | | | | | |
|---|---|---|---|---|---|---|---|---|---|---|---|---|
| Items | | | Units | a1 | a2 | a3 | a4 | a5 | a6 | a7 | a8 | a9 |
| Composition | Component A | ABS | parts by | 100 | 100 | 100 | 100 | 100 | 100 | 100 | 100 | 100 |
| | | | mass | | | | | | | | | |
| | Component B | PEPO-1 | parts by | — | 3.0 | 5.0 | 10.0 | 18.0 | 24.0 | — | — | — |
| | | PEPO-2 | mass | — | — | — | — | — | — | 5.0 | 10.0 | — |
| | Component C | StZn | parts by | — | — | — | — | — | — | — | — | — |
| | | StAl-1 | mass | — | — | — | — | — | — | — | — | — |
| | | StAl-2 | | — | — | — | — | — | — | — | — | 0.3 |
| | | StAl-3 | | — | — | — | — | — | — | — | — | — |
| Evaluations | Tensile strength | | MPa | 47 | 46 | 46 | 45 | 43 | 41 | 45 | 45 | 47 |
| | Evaluation | | — | — | A | A | A | B | C | A | A | A |
| | Flexural modulus | | MPa | 2350 | 2340 | 2310 | 2250 | 2170 | 2100 | 2320 | 2240 | 2360 |
| | Evaluation | | — | — | A | A | A | B | C | A | A | A |
| | Charpy impact strength | | kJ/m² | 22 | 22 | 24 | 26 | 25 | 23 | 24 | 25 | 21 |
| | Surface impact strength | | J | 24 | 24 | 24 | 23 | 22 | 21 | 23 | 23 | 24 |
| | (breakage energy) | | | | | | | | | | | |
| | Form of fracture | | — | A | A | A | A | A | A | A | A | A |
| | Deflection temperature | | ° C. | 79 | 79 | 79 | 78 | 78 | 78 | 79 | 78 | 79 |
| | under load | | | | | | | | | | | |
| | Hydrophilic powdery dust | | % | 12 | 10 | 8 | 6 | 5 | 5 | 8 | 7 | 12 |
| | adhesive properties | | | | | | | | | | | |
| | Evaluation | | — | D | D | C | C | B | B | C | C | D |
| | Hydrophobic powdery dust | | % | 11 | 10 | 10 | 11 | 12 | 12 | 11 | 11 | 12 |
| | adhesive properties | | | | | | | | | | | |
| | Evaluation | | — | D | D | D | D | D | D | D | D | D |
| | | | | Comparative Example | | | | | | | | |
| Items | | | Units | a10 | a11 | a12 | a13 | a14 | a15 | a16 | a17 | a18 |
| Composition | Component A | ABS | parts by | 100 | 100 | 100 | 100 | 100 | 100 | 100 | 100 | 100 |
| | | | mass | | | | | | | | | |
| | Component B | PEPO-1 | parts by | — | — | — | — | — | — | — | — | — |
| | | PEPO-2 | mass | — | — | — | — | — | — | — | — | — |
| | Component C | StZn | parts by | — | — | — | 2.0 | 5.0 | — | — | — | — |
| | | StAl-1 | mass | — | — | — | — | — | 2.0 | 5.0 | — | — |
| | | StAl-2 | | 2.0 | 5.0 | 12.0 | — | — | — | — | — | — |
| | | StAl-3 | | — | — | — | — | — | — | — | 2.0 | 5.0 |

| | | | | | | | | | | | |
|---|---|---|---|---|---|---|---|---|---|---|---|
| Evaluations | Tensile strength | MPa | 48 | 47 | 49 | 47 | 47 | 48 | 47 | 47 | 48 |
| | Evaluation | — | A | A | A | A | A | A | A | A | A |
| | Flexural modulus | MPa | 2350 | 2360 | 2380 | 2360 | 2360 | 2350 | 2370 | 2340 | 2360 |
| | Evaluation | — | A | A | A | A | A | A | A | A | A |
| | Charpy impact strength | kJ/m² | 21 | 20 | 18 | 22 | 20 | 22 | 21 | 21 | 21 |
| | Surface impact strength | J | 24 | 20 | 18 | 24 | 24 | 24 | 23 | 24 | 23 |
| | (breakage energy) | | | | | | | | | | |
| | Form of fracture | — | A | B | C | A | A | A | A | A | A |
| | Deflection temperature | ° C. | 78 | 76 | 74 | 78 | 78 | 78 | 77 | 78 | 77 |
| | under load | | | | | | | | | | |
| | Hydrophilic powdery dust | % | 12 | 13 | 14 | 11 | 13 | 12 | 13 | 12 | 14 |
| | adhesive properties | | | | | | | | | | |
| | Evaluation | — | D | D | D | D | D | D | D | D | D |
| | Hydrophobic powdery dust | % | 11 | 7 | 6 | 11 | 9 | 12 | 10 | 11 | 10 |
| | adhesive properties | | | | | | | | | | |
| | Evaluation | — | D | C | C | D | D | D | D | D | D |

TABLE 5

| | | | | Comparative Example | | | | | | | | |
|---|---|---|---|---|---|---|---|---|---|---|---|---|
| Items | | | Units | a19 | a20 | a21 | a22 | a23 | a24 | a25 | a26 | a27 |
| Composition | Component A | HIPS | parts by | 100 | 100 | 100 | — | 100 | 100 | 100 | 100 | 100 |
| | | | mass | | | | | | | | | |
| | Component B | PEPO-1 | parts by | — | 3.0 | 5.0 | 10.0 | 18.0 | 24.0 | — | — | — |
| | | PEPO-2 | mass | — | — | — | — | — | — | — | — | — |
| | Component C | StZn | parts by | — | — | — | — | — | — | — | — | — |
| | | StAl-1 | mass | — | — | — | — | — | — | — | — | — |
| | | StAl-2 | | — | — | — | — | — | — | 0.3 | 2.0 | 8.0 |
| | | StAl-3 | | — | — | — | — | — | — | — | — | — |
| Evaluations | Tensile strength | | MPa | 30 | 30 | 30 | 29 | 28 | 26 | 30 | 30 | 31 |
| | Evaluation | | — | — | A | A | A | B | C | A | A | A |
| | Flexural modulus | | MPa | 2200 | 2210 | 2180 | 2100 | 1990 | 1930 | 2190 | 2220 | 2220 |
| | Evaluation | | — | — | A | A | A | B | C | A | A | A |
| | Deflection temperature | | ° C. | 76 | 76 | 75 | 75 | 74 | 74 | 76 | 75 | 71 |
| | under load | | | | | | | | | | | |
| | Hydrophilic powdery dust | | % | 18 | 15 | 8 | 8 | 5 | 5 | 19 | 17 | 16 |
| | adhesive properties | | | | | | | | | | | |
| | Evaluation | | — | D | D | C | C | B | B | D | D | D |
| | Hydrophobic powdery dust | | % | 19 | 18 | 18 | 17 | 16 | 16 | 19 | 18 | 8 |
| | adhesive properties | | | | | | | | | | | |
| | Evaluation | | — | D | D | D | D | D | D | D | D | C |
| | | | | Comparative Example | | | | | | | | |
| Items | | | Units | a28 | a29 | a30 | a31 | a32 | a33 | a34 | a35 | a36 |
| Composition | Component A | HIPS | parts by | 100 | 100 | — | 100 | 100 | 100 | 100 | 100 | 100 |
| | | | mass | | | | | | | | | |
| | Component B | PEPO-1 | parts by | — | — | — | — | — | — | — | — | — |
| | | PEPO-2 | mass | — | 5.0 | 10.0 | — | — | — | — | — | — |
| | Component C | StZn | parts by | — | — | — | 2.0 | 5.0 | — | — | — | — |
| | | StAl-1 | mass | — | — | — | — | — | 2.0 | 5.0 | — | — |
| | | StAl-2 | | 12.0 | — | — | — | — | — | — | — | — |
| | | StAl-3 | | — | — | — | — | — | — | — | 2.0 | 5.0 |

| | | | | | | | | | | | |
|---|---|---|---|---|---|---|---|---|---|---|---|
| Evaluations | Tensile strength | MPa | 32 | 29 | 28 | 30 | 30 | 30 | 31 | 29 | 30 |
| | Evaluation | — | A | A | B | A | A | A | A | A | A |
| | Flexural modulus | MPa | 2270 | 2210 | 2110 | 2190 | 2210 | 2200 | 2220 | 2190 | 2200 |
| | Evaluation | — | A | A | A | A | A | A | A | A | A |
| | Deflection temperature | ° C. | 68 | 75 | 75 | 75 | 75 | 76 | 75 | 76 | 76 |
| | under load | | | | | | | | | | |
| | Hydrophilic powdery dust | % | 15 | 8 | 8 | 18 | 17 | 18 | 17 | 18 | 18 |
| | adhesive properties | | | | | | | | | | |
| | Evaluation | — | D | C | C | D | D | D | D | D | D |
| | Hydrophobic powdery dust | % | 7 | 19 | 19 | 18 | 16 | 19 | 17 | 19 | 18 |
| | adhesive properties | | | | | | | | | | |
| | Evaluation | — | C | D | D | D | D | D | D | D | D |

TABLE 6

| | | | | Comparative Example | | | | | | | | |
|---|---|---|---|---|---|---|---|---|---|---|---|---|
| Items | | | Units | a37 | a38 | a39 | a40 | a41 | a42 | a43 | a44 | a45 |
| Composition | Component A | PC | parts by | 100 | 100 | 100 | 100 | 100 | 100 | 100 | 100 | 100 |
| | | | mass | | | | | | | | | |
| | Component B | PEPO-1 | parts by | — | 3.0 | 5.0 | 10.0 | 18.0 | 24.0 | — | — | — |
| | | PEPO-2 | mass | — | — | — | — | — | — | — | — | — |
| | Component C | StZn | parts by | — | — | — | — | — | — | — | — | — |
| | | StAl-1 | mass | — | — | — | — | — | — | — | — | — |
| | | StAl-2 | | — | — | — | — | — | — | 0.3 | 2.0 | 5.0 |
| | | StAl-3 | | — | — | — | — | — | — | — | — | — |
| Evaluations | Tensile strength | | MPa | 40 | 39 | 39 | 39 | 37 | 35 | 40 | 41 | 41 |
| | Evaluation | | — | — | A | A | A | B | C | A | A | A |
| | Flexural modulus | | MPa | 3200 | 3160 | 3100 | 3050 | 2910 | 2850 | 3210 | 3210 | 3250 |
| | Evaluation | | — | — | A | A | A | B | C | A | A | A |
| | Deflection temperature | | ° C. | 76 | 76 | 76 | 75 | 74 | 73 | 76 | 75 | 73 |
| | under load | | | | | | | | | | | |
| | Hydrophilic powdery dust | | % | 19 | 18 | 8 | 6 | 5 | 3 | 18 | 18 | 18 |
| | adhesive properties | | | | | | | | | | | |
| | Evaluation | | — | D | D | C | C | B | B | D | D | D |
| | Hydrophobic powdery dust | | % | 20 | 21 | 19 | 17 | 18 | 17 | 18 | 19 | 8 |
| | adhesive properties | | | | | | | | | | | |
| | Evaluation | | — | D | D | D | D | D | D | D | D | C |
| | | | | Comparative Example | | | | | | | | |
| Items | | | Units | a46 | a47 | a48 | a49 | a50 | a51 | a52 | a53 | a54 |
| Composition | Component A | PC | parts by | 100 | 100 | 100 | 100 | 100 | 100 | 100 | 100 | 100 |
| | | | mass | | | | | | | | | |
| | Component B | PEPO-1 | parts by | — | — | — | — | — | — | — | — | — |
| | | PEPO-2 | mass | — | 5.0 | 10.0 | — | — | — | — | — | — |
| | Component C | StZn | parts by | — | — | — | 2.0 | 5.0 | — | — | — | — |
| | | StAl-1 | mass | — | — | — | — | — | 2.0 | 5.0 | — | — |
| | | StAl-2 | | 12.0 | — | — | — | — | — | — | — | — |
| | | StAl-3 | | — | — | — | — | — | — | — | 2.0 | 5.0 |

| | | | | | | | | | | | |
|---|---|---|---|---|---|---|---|---|---|---|---|
| Evaluations | Tensile strength | MPa | 42 | 39 | 39 | 40 | 41 | 40 | 40 | 40 | 41 |
| | Evaluation | — | A | A | A | A | A | A | A | A | A |
| | Flexural modulus | MPa | 3260 | 3120 | 3060 | 3200 | 3220 | 3210 | 3230 | 3200 | 3240 |
| | Evaluation | — | A | A | A | A | A | A | A | A | A |
| | Deflection temperature | ° C. | 68 | 76 | 75 | 75 | 74 | 76 | 74 | 75 | 74 |
| | under load | | | | | | | | | | |
| | Hydrophilic powdery dust | % | 17 | 8 | 7 | 18 | 18 | 18 | 19 | 19 | 18 |
| | adhesive properties | | | | | | | | | | |
| | Evaluation | — | D | C | C | D | D | D | D | D | D |
| | Hydrophobic powdery dust | % | 8 | 19 | 18 | 19 | 18 | 17 | 17 | 18 | 18 |
| | adhesive properties | | | | | | | | | | |
| | Evaluation | — | C | D | D | D | D | D | D | D | D |

TABLE 7

| | | | | Example | | | | | | | | | |
|---|---|---|---|---|---|---|---|---|---|---|---|---|---|
| Items | | | Units | b1 | b2 | 63 | b4 | b5 | b6 | b7 | b8 | b9 | b10 |
| Composition | Component A | ABS | parts by | 100 | 100 | 100 | 100 | 100 | 100 | 100 | 100 | 100 | 100 |
| | | | mass | | | | | | | | | | |
| | Component B | PEPO-1 | parts by | | | | | | | | | | |
| | | PEPO-2 | mass | 0.5 | 3.0 | 5.0 | 10.0 | 18.0 | 24.0 | 5.0 | 5.0 | 5.0 | 5.0 |
| | Component C | StZn | parts by | | | | | | | | | | |
| | | StAl-1 | mass | | | | | | | | | | |
| | | StAl-2 | | 2.0 | 2.0 | 2.0 | 2.0 | 2.0 | 2.0 | 0.3 | 1.0 | 5.0 | 8.0 |
| | | StAl-3 | | | | | | | | | | | |

| Extrusion temperature (cylinder | | ° C. | 280 | 280 | 280 | 280 | 280 | 280 | 280 | 280 | 280 | 280 |
|---|---|---|---|---|---|---|---|---|---|---|---|---|
| temperature) | | | | | | | | | | | | |
| Drying temperature/cylinder | | ° C. | 120/ | 120/ | 120/ | 120/ | 120/ | 120/ | 120/ | 120/ | 120/ | 120/ |
| temperature/metal mold | | | 280/ | 280/ | 280/ | 280/ | 280/ | 280/ | 280/ | 280/ | 280/ | 280/ |
| temperature | | | 70 | 70 | 70 | 70 | 70 | 70 | 70 | 70 | 70 | 70 |
| Evaluations | Tensile strength | MPa | 64 | 64 | 63 | 60 | 58 | 55 | 63 | 64 | 64 | 65 |
| | Evaluation | — | A | A | A | A | B | C | A | A | A | A |
| | Flexural modulus | MPa | 2380 | 2370 | 2330 | 2300 | 2180 | 2050 | 2330 | 2340 | 2350 | 2350 |
| | Evaluation | — | A | A | A | A | B | C | A | A | A | A |
| | Charpy impact strength | kJ/m² | 14 | 15 | 17 | 18 | 20 | 21 | 17 | 18 | 16 | 13 |
| | Surface impact strength | J | 30 | 30 | 29 | 29 | 28 | 27 | 30 | 29 | 30 | 28 |
| | (breakage energy) | | | | | | | | | | | |
| | Form of fracture | — | A | A | A | A | A | A | A | A | A | B |
| | Deflection temperature | ° C. | 123 | 122 | 119 | 114 | 108 | 104 | 121 | 120 | 116 | 112 |
| | under load | | | | | | | | | | | |
| | Hydrophilic powdery dust | % | 5 | 1 | 1 | 1 | 1 | 1 | 5 | 1 | 1 | 1 |
| | adhesive properties | | | | | | | | | | | |
| | Evaluation | — | B | A | A | A | A | A | B | A | A | A |
| | Hydrophobic powdery | % | 5 | 2 | 1 | 1 | 1 | 1 | 5 | 2 | 1 | 1 |
| | dust adhesive properties | | | | | | | | | | | |
| | Evaluation | — | B | A | A | A | A | A | B | A | A | A |

| | | | | Example | | | | | | | | |
|---|---|---|---|---|---|---|---|---|---|---|---|---|
| Items | | | Units | b11 | b12 | b13 | b14 | b15 | b16 | b17 | b18 | b19 |
| Composition | Component A | ABS | parts by | 100 | 100 | 100 | 100 | 100 | 100 | 100 | 100 | 100 |
| | | | mass | | | | | | | | | |
| | Component B | PEPO-1 | parts by | | 5.0 | 10.0 | | | | | | |
| | | PEPO-2 | mass | 5.0 | | | 5.0 | 5.0 | 5.0 | 5.0 | 5.0 | 0.3 |
| | Component C | StZn | parts by | | | | 0.3 | 2.0 | | | | |
| | | StAl-1 | mass | | | | | | 0.3 | 2.0 | | |
| | | StAl-2 | | 12.0 | 2.0 | 2.0 | | | | | | |
| | | StAl-3 | | | | | | | | | 0.3 | 2.0 |

| Extrusion temperature (cylinder | | ° C. | 280 | 280 | 280 | 280 | 280 | 280 | 280 | 280 | 280 |
|---|---|---|---|---|---|---|---|---|---|---|---|
| temperature) | | | | | | | | | | | |
| Drying temperature/cylinder | | ° C. | 120/ | 120/ | 120/ | 120/ | 120/ | 120/ | 120/ | 120/ | 120/ |
| temperature/metal mold | | | 280/ | 280/ | 280/ | 280/ | 280/ | 280/ | 280/ | 280/ | 280/ |
| temperature | | | 70 | 70 | 70 | 70 | 70 | 70 | 70 | 70 | 70 |
| Evaluations | Tensile strength | MPa | 65 | 63 | 61 | 64 | 63 | 64 | 64 | 64 | 65 |
| | Evaluation | — | A | A | A | A | A | A | A | A | A |
| | Flexural modulus | MPa | 2360 | 2340 | 2310 | 2300 | 2340 | 2310 | 2340 | 2300 | 2330 |
| | Evaluation | — | A | A | A | A | A | A | A | A | A |
| | Charpy impact strength | kJ/m² | 12 | 17 | 17 | 18 | 17 | 18 | 18 | 18 | 17 |
| | Surface impact strength | J | 22 | 29 | 27 | 30 | 29 | 29 | 29 | 29 | 28 |
| | (breakage energy) | | | | | | | | | | |
| | Form of fracture | — | C | A | A | A | A | A | A | A | A |
| | Deflection temperature | ° C. | 109 | 119 | 114 | 120 | 120 | 120 | 119 | 121 | 119 |
| | under load | | | | | | | | | | |
| | Hydrophilic powdery dust | % | 1 | 2 | 2 | 7 | 7 | 7 | 4 | 8 | 5 |
| | adhesive properties | | | | | | | | | | |
| | Evaluation | — | A | A | A | C | C | C | B | C | B |
| | Hydrophobic powdery | % | 1 | 2 | 2 | 6 | 6 | 7 | 4 | 7 | 5 |
| | dust adhesive properties | | | | | | | | | | |
| | Evaluation | — | A | A | A | C | C | C | B | C | B |

TABLE 8

| | | | | Comparative Example | | | | | | | | |
|---|---|---|---|---|---|---|---|---|---|---|---|---|
| Items | | | Units | b1 | b2 | b3 | b4 | b5 | b6 | b7 | b8 | b9 |
| Composition | Component A | ABS | parts by | 100 | 100 | 100 | 100 | 100 | 100 | 100 | 100 | 100 |
| | | | mass | | | | | | | | | |
| | Component B | PEPO-1 | parts by | | | | | | | 5.0 | 10.0 | |
| | | PEPO-2 | mass | | 3.0 | 5.0 | 10.0 | 18.0 | 24.0 | | | |
| | Component C | StZn | parts by | | | | | | | | | |
| | | StAl-1 | mass | | | | | | | | | |
| | | StAl-2 | | | | | | | | | | 0.3 |
| | | StAl-3 | | | | | | | | | | |
| Extrusion temperature (cylinder | | | ° C. | 280 | 280 | 280 | 280 | 280 | 280 | 280 | 280 | 280 |
| temperature) | | | | | | | | | | | | |
| Drying temperature/cylinder | | | ° C. | 120/ | 120/ | 120/ | 120/ | 120/ | 120/ | 120/ | 120/ | 120/ |
| temperature/metal mold | | | | 280/ | 280/ | 280/ | 280/ | 280/ | 280/ | 280/ | 280/ | 280/ |
| temperature | | | | 70 | 70 | 70 | 70 | 70 | 70 | 70 | 70 | 70 |
| Evaluation | Tensile strength | | MPa | 64 | 64 | 63 | 60 | 58 | 55 | 63 | 61 | 64 |
| | Evaluation | | — | — | A | A | A | B | C | A | A | A |
| | Flexural modulus | | MPa | 2400 | 2360 | 2330 | 2290 | 2180 | 2060 | 2340 | 2300 | 2400 |
| | Evaluation | | — | — | A | A | A | B | C | A | A | A |
| | Charpy impact strength | | kJ/m² | 14 | 16 | 18 | 22 | 24 | 23 | 18 | 23 | 15 |
| | Surface impact strength | | J | 30 | 30 | 31 | 30 | 28 | 28 | 30 | 20 | 30 |
| | (breakage energy) | | | | | | | | | | | |
| | Form of fracture | | — | A | A | A | A | A | A | A | A | A |
| | Deflection temperature | | ° C. | 124 | 122 | 120 | 116 | 110 | 106 | 120 | 117 | 123 |
| | under load | | | | | | | | | | | |
| | Hydrophilic powdery dust | | % | 13 | 12 | 10 | 8 | 5 | 5 | 10 | 7 | 12 |
| | adhesive properties | | | | | | | | | | | |
| | Evaluation | | — | D | D | D | C | B | B | D | C | D |
| | Hydrophobic powdery dust | | % | 10 | 10 | 10 | 11 | 10 | 10 | 11 | 11 | 10 |
| | adhesive properties | | | | | | | | | | | |
| | Evaluation | | — | D | D | D | D | D | D | D | D | D |
| | | | | Comparative Example | | | | | | | | |
| Items | | | Units | b10 | b11 | b12 | b13 | b14 | b15 | b16 | b17 | b18 |
| Composition | Component A | ABS | parts by | 100 | 100 | 100 | 100 | 100 | 100 | 100 | 100 | 100 |
| | | | mass | | | | | | | | | |
| | Component B | PEPO-1 | parts by | | | | | | | | | |
| | | PEPO-2 | mass | | | | | | | | | |
| | Component C | StZn | parts by | | | | 2.0 | 5.0 | | | | |
| | | StAl-1 | mass | | | | | | 2.0 | 5.0 | | |
| | | StAl-2 | | 2.0 | 5.0 | 12.0 | | | | | | |
| | | StAl-3 | | | | | | | | | 2.0 | 5.0 |

| Extrusion temperature (cylinder | | ° C. | 280 | 280 | 280 | 280 | 280 | 280 | 280 | 280 | 280 |
|---|---|---|---|---|---|---|---|---|---|---|---|
| temperature) | | | | | | | | | | | |
| Drying temperature/cylinder | | ° C. | 120/ | 120/ | 120/ | 120/ | 120/ | 120/ | 120/ | 120/ | 120/ |
| temperature/metal mold | | | 280/ | 280/ | 280/ | 280/ | 280/ | 280/ | 280/ | 280/ | 280/ |
| temperature | | | 70 | 70 | 70 | 70 | 70 | 70 | 70 | 70 | 70 |
| Evaluation | Tensile strength | MPa | 64 | 65 | 67 | 64 | 65 | 64 | 65 | 64 | 64 |
| | Evaluation | — | A | A | A | A | A | A | A | A | A |
| | Flexural modulus | MPa | 2430 | 2430 | 2450 | 2420 | 2430 | 2410 | 2430 | 2420 | 2420 |
| | Evaluation | — | A | A | A | A | A | A | A | A | A |
| | Charpy impact strength | kJ/m² | 14 | 13 | 11 | 14 | 14 | 13 | 14 | 14 | 14 |
| | Surface impact strength | J | 28 | 25 | 20 | 28 | 26 | 28 | 27 | 27 | 27 |
| | (breakage energy) | | | | | | | | | | |
| | Form of fracture | — | A | A | B | A | A | A | A | A | A |
| | Deflection temperature | ° C. | 120 | 118 | 111 | 121 | 118 | 120 | 117 | 120 | 118 |
| | under load | | | | | | | | | | |
| | Hydrophilic powdery dust | % | 13 | 13 | 14 | 12 | 13 | 13 | 13 | 12 | 14 |
| | adhesive properties | | | | | | | | | | |
| | Evaluation | — | D | D | D | D | D | D | D | D | D |
| | Hydrophobic powdery dust | % | 8 | 6 | 5 | 10 | 8 | 10 | 10 | 10 | 10 |
| | adhesive properties | | | | | | | | | | |
| | Evaluation | — | C | C | B | D | C | D | D | D | D |

TABLE 9

| | | | | Example | | | | | | |
|---|---|---|---|---|---|---|---|---|---|---|
| Items | | | Units | b20 | b21 | b22 | b23 | b24 | b25 | b26 |
| Composition | Component A | PC | parts by | 70 | 70 | 70 | 30 | 70 | 70 | 70 |
| | | ABS | mass | 30 | 30 | 30 | 70 | 30 | 30 | 30 |
| | Component B | PEPO-1 | parts by | | | | | | | |
| | | PEPO-2 | mass | 0.5 | 3.0 | 5.0 | 5.0 | 10.0 | 18.0 | 24.0 |
| | Component C | StZn | parts by | | | | | | | |
| | | StAl-1 | mass | | | | | | | |
| | | StAl-2 | | 2.0 | 2.0 | 10 | 2.0 | 2.0 | 2.0 | 2.0 |
| | | StAl-3 | | | | | | | | |
| Extrusion temperature (cylinder | | | ° C. | 260 | 260 | 260 | 260 | 260 | 260 | 260 |
| temperature) | | | | | | | | | | |
| Drying temperature/cylinder | | | ° C. | 100/ | 100/ | 100/ | 80/ | 100/ | 100/ | 100/ |
| temperature/metal mold | | | | 260/ | 260/ | 260/ | 260/ | 260/ | 260/ | 260/ |
| temperature | | | | 60 | 60 | 60 | 60 | 60 | 60 | 60 |
| Evaluation | Tensile strength | | MPa | 58 | 57 | 56 | 53 | 55 | 53 | 51 |
| | Evaluation | | — | A | A | A | A | A | B | C |
| | Flexural modulus | | MPa | 2380 | 2340 | 2330 | 2570 | 2290 | 2170 | 2060 |
| | Evaluation | | — | A | A | A | A | A | B | C |
| | Charpy impact strength | | kJ/m² | 38 | 38 | 39 | 31 | 42 | 43 | 41 |
| | Surface impact strength | | J | 24 | 24 | 23 | 18 | 22 | 22 | 22 |
| | (breakage energy) | | | | | | | | | |
| | Form of fracture | | — | A | A | A | A | A | A | A |
| | Deflection temperature | | ° C. | 111 | 110 | 109 | 88 | 106 | 103 | 100 |
| | under load | | | | | | | | | |
| | Hydrophilic powdery dust | | % | 5 | 2 | 1 | 1 | 1 | 1 | 1 |
| | adhesive properties | | | | | | | | | |
| | Evaluation | | — | B | A | A | A | A | A | A |
| | Hydrophobic powdery dust | | % | 5 | 2 | 2 | 2 | 1 | 1 | 1 |
| | adhesive properties | | | | | | | | | |
| | Evaluation | | — | B | A | A | A | A | A | A |
| | | | | Example | | | | | | |
| Items | | | Units | b27 | b28 | b29 | b30 | b31 | b32 | b33 |
| Composition | Component A | PC | parts by | 70 | 70 | 70 | 70 | 70 | 30 | 70 |
| | | ABS | mass | 30 | 30 | 30 | 30 | 30 | 70 | 30 |
| | Component B | PEPO-1 | parts by | | | | | | 5.0 | 5.0 |
| | | PEPO-2 | mass | 5.0 | 5.0 | 5.0 | 5.0 | 5.0 | | |
| | Component C | StZn | parts by | | | | | | | |
| | | StAl-1 | mass | | | | | | | |
| | | StAl-2 | | 0.3 | 1.0 | 5.0 | 8.0 | 12.0 | 2.0 | 2.0 |
| | | StAl-3 | | | | | | | | |
| Extrusion temperature (cylinder | | | ° C. | 260 | 260 | 260 | 260 | 260 | 260 | 260 |
| temperature) | | | | | | | | | | |
| Drying temperature/cylinder | | | ° C. | 100/ | 100/ | 100/ | 100/ | 100/ | 80/ | 100/ |
| temperature/metal mold | | | | 260/ | 260/ | 260/ | 260/ | 260/ | 260/ | 260/ |
| temperature | | | | 60 | 60 | 60 | 60 | 60 | 60 | 60 |
| Evaluation | Tensile strength | | MPa | 56 | 57 | 58 | 59 | 60 | 53 | 56 |
| | Evaluation | | — | A | A | A | A | A | A | A |
| | Flexural modulus | | MPa | 2320 | 2330 | 2350 | 2370 | 2390 | 2580 | 2340 |
| | Evaluation | | — | A | A | A | A | A | A | A |
| | Charpy impact strength | | kJ/m² | 39 | 39 | 37 | 36 | 35 | 30 | 40 |
| | Surface impact strength | | J | 24 | 23 | 21 | 19 | 17 | 18 | 23 |
| | (breakage energy) | | | | | | | | | |
| | Form of fracture | | — | A | A | A | B | C | A | A |
| | Deflection temperature | | ° C. | 110 | 109 | 107 | 105 | 103 | 89 | 108 |
| | under load | | | | | | | | | |
| | Hydrophilic powdery dust | | % | 5 | 1 | 1 | 1 | 1 | 1 | 2 |
| | adhesive properties | | | | | | | | | |
| | Evaluation | | — | B | A | A | A | A | A | A |
| | Hydrophobic powdery dust | | % | 5 | 2 | 1 | 1 | 1 | 2 | 2 |
| | adhesive properties | | | | | | | | | |
| | Evaluation | | — | B | A | A | A | A | A | A |
| | | | | Example | | | | | | |
| Items | | | Units | b34 | b35 | b36 | b37 | b38 | b39 | b40 |
| Composition | Component A | PC | parts by | 70 | 70 | 70 | 70 | 70 | 70 | 70 |
| | | ABS | mass | 30 | 30 | 30 | 30 | 30 | 30 | 30 |
| | Component B | PEPO-1 | parts by | 10.0 | | | | | | |
| | | PEPO-2 | mass | | 5.0 | 5.0 | 5.0 | 5.0 | 5.0 | 5.0 |
| | Component C | StZn | parts by | | 0.3 | 2.0 | | | | |
| | | StAl-1 | mass | | | | 0.3 | 2.0 | | |
| | | StAl-2 | | 2.0 | | | | | | |
| | | StAl-3 | | | | | | | 0.3 | 2.0 |

| Extrusion temperature (cylinder | | ° C. | 260 | 260 | 260 | 260 | 260 | 260 | 260 |
|---|---|---|---|---|---|---|---|---|---|
| temperature) | | | | | | | | | |
| Drying temperature/cylinder | | ° C. | 100/ | 100/ | 100/ | 100/ | 100/ | 100/ | 100/ |
| temperature/metal mold | | | 260/ | 260/ | 260/ | 260/ | 260/ | 260/ | 260/ |
| temperature | | | 60 | 60 | 60 | 60 | 60 | 60 | 60 |
| Evaluation | Tensile strength | MPa | 54 | 56 | 56 | 55 | 56 | 56 | 56 |
| | Evaluation | — | A | A | A | A | A | A | A |
| | Flexural modulus | MPa | 2300 | 2320 | 2340 | 2310 | 2320 | 2320 | 3220 |
| | Evaluation | — | A | A | A | A | A | A | A |
| | Charpy impact strength | kJ/m² | 42 | 39 | 39 | 38 | 39 | 38 | 39 |
| | Surface impact strength | J | 22 | 23 | 23 | 23 | 23 | 22 | 23 |
| | (breakage energy) | | | | | | | | |
| | Form of fracture | — | A | A | A | A | A | A | A |
| | Deflection temperature | ° C. | 106 | 110 | 108 | 109 | 108 | 110 | 109 |
| | under load | | | | | | | | |
| | Hydrophilic powdery dust | % | 1 | 7 | 6 | 6 | 5 | 7 | 5 |
| | adhesive properties | | | | | | | | |
| | Evaluation | — | A | C | C | C | B | C | B |
| | Hydrophobic powdery dust | % | 1 | 7 | 7 | 6 | 5 | 8 | 5 |
| | adhesive properties | | | | | | | | |
| | Evaluation | — | A | C | C | C | B | C | B |

TABLE 10

| | | | | Comparative Example | | | | | | | |
|---|---|---|---|---|---|---|---|---|---|---|---|
| Items | | | Units | b19 | b20 | b21 | b22 | b23 | b24 | b25 | b26 |
| Composition | Component A | PC | parts by | 70 | 30 | 70 | 70 | 30 | 70 | 70 | 70 |
| | | ABS | mass | 30 | 70 | 30 | 30 | 70 | 30 | 30 | 30 |
| | Component B | PEPO-1 | parts by | | | | | | | | |
| | | PEPO-2 | mass | | | 3.0 | 5.0 | 5.0 | 10.0 | 18.0 | 24.0 |
| | Component C | StZn | parts by | | | | | | | | |
| | | StAl-1 | mass | | | | | | | | |
| | | StAl-2 | | | | | | | | | |
| | | StAl-3 | | | | | | | | | |

| Extrusion temperature (cylinder | | ° C. | 260 | 260 | 260 | 260 | 260 | 260 | 260 | 260 |
|---|---|---|---|---|---|---|---|---|---|---|
| temperature) | | | | | | | | | | |
| Drying temperature/cylinder | | ° C. | 100/ | 80/ | 100/ | 100/ | 80/ | 100/ | 100/ | 100/ |
| temperature/metal mold | | | 260/ | 260/ | 260/ | 260/ | 260/ | 260/ | 260/ | 260/ |
| temperature | | | 60 | 60 | 60 | 60 | 60 | 60 | 60 | 60 |
| Evaluation | Tensile strength | MPa | 58 | 55 | 57 | 57 | 53 | 56 | 53 | 50 |
| | Evaluation | — | — | — | A | A | A | A | B | C |
| | Flexural modulus | MPa | 2400 | 2600 | 2370 | 2330 | 2560 | 2290 | 2170 | 2080 |
| | Evaluation | — | — | — | A | A | A | A | B | C |
| | Charpy impact strength | kJ/m² | 37 | 30 | 39 | 40 | 32 | 42 | 43 | 40 |
| | Surface impact strength | J | 25 | 20 | 25 | 25 | 20 | 24 | 23 | 23 |
| | (breakage energy) | | | | | | | | | |
| | Form of fracture | — | A | A | A | A | A | A | A | A |
| | Deflection temperature | ° C. | 112 | 90 | 111 | 110 | 89 | 108 | 105 | 101 |
| | under load | | | | | | | | | |
| | Hydrophilic powdery dust | % | 11 | 12 | 10 | 8 | 8 | 7 | 6 | 5 |
| | adhesive properties | | | | | | | | | |
| | Evaluation | — | D | D | D | C | C | C | C | B |
| | Hydrophobic powdery dust | % | 11 | 11 | 10 | 10 | 11 | 10 | 11 | 11 |
| | adhesive properties | | | | | | | | | |
| | Evaluation | — | D | D | D | D | D | D | D | D |

| | | | | Comparative Example | | | | | | |
|---|---|---|---|---|---|---|---|---|---|---|
| Items | | | Units | b27 | b28 | b29 | b30 | b31 | b32 | b33 |
| Composition | Component A | PC | parts by | 70 | 70 | 70 | 70 | 70 | 30 | 70 |
| | | ABS | mass | 30 | 30 | 30 | 30 | 30 | 70 | 30 |
| | Component B | PEPO-1 | parts by | 5.0 | 5.0 | 10.0 | | | | |
| | | PEPO-2 | mass | | | | | | | |
| | Component C | StZn | parts by | | | | | | | |
| | | StAl-1 | mass | | | | | | | |
| | | StAl-2 | | | | | 0.3 | 2.0 | 2.0 | 5.0 |
| | | StAl-3 | | | | | | | | |

| Extrusion temperature (cylinder | | ° C. | 260 | 260 | 260 | 260 | 260 | 260 | 260 |
|---|---|---|---|---|---|---|---|---|---|
| temperature) | | | | | | | | | |
| Drying temperature/cylinder | | ° C. | 100/ | 80/ | 100/ | 100/ | 100/ | 80/ | 100/ |
| temperature/metal mold | | | 260/ | 260/ | 260/ | 260/ | 260/ | 260/ | 260/ |
| temperature | | | 60 | 60 | 60 | 60 | 60 | 60 | 60 |
| Evaluation | Tensile strength | MPa | 57 | 54 | 56 | 58 | 59 | 55 | 59 |
| | Evaluation | — | A | A | A | A | A | A | A |
| | Flexural modulus | MPa | 2320 | 2570 | 2290 | 2410 | 2440 | 2620 | 2460 |
| | Evaluation | — | A | A | A | A | A | A | A |
| | Charpy impact strength | kJ/m² | 39 | 32 | 40 | 37 | 37 | 29 | 36 |
| | Surface impact strength | J | 24 | 20 | 24 | 24 | 24 | 19 | 20 |
| | (breakage energy) | | | | | | | | |
| | Form of fracture | — | A | A | A | A | A | A | B |
| | Deflection temperature | ° C. | 110 | 89 | 107 | 111 | 109 | 89 | 107 |
| | under load | | | | | | | | |
| | Hydrophilic powdery dust | % | 8 | 8 | 8 | 11 | 11 | 11 | 12 |
| | adhesive properties | | | | | | | | |
| | Evaluation | — | C | C | C | D | D | D | D |
| | Hydrophobic powdery dust | % | 11 | 10 | 10 | 10 | 10 | 10 | 8 |
| | adhesive properties | | | | | | | | |
| | Evaluation | — | D | D | D | D | D | D | C |

| | | | | Comparative Example | | | | | | |
|---|---|---|---|---|---|---|---|---|---|---|
| Items | | | Units | b34 | b35 | b36 | b37 | b38 | b39 | b40 |
| Composition | Component A | PC | parts by | 70 | 100 | 100 | 100 | 100 | 100 | 100 |
| | | ABS | mass | 30 | | | | | | |
| | Component B | PEPO-1 | parts by | | | | | | | |
| | | PEPO-2 | mass | | | | | | | |
| | Component C | StZn | parts by | | 2.0 | 5.0 | | | | |
| | | StAl-1 | mass | | | | 2.0 | 5.0 | | |
| | | StAl-2 | | 12.0 | | | | | | |
| | | StAl-3 | | | | | | | 2.0 | 5.0 |

| Extrusion temperature (cylinder | | ° C. | 260 | 260 | 260 | 260 | 260 | 260 | 260 |
|---|---|---|---|---|---|---|---|---|---|
| temperature) | | | | | | | | | |
| Drying temperature/cylinder | | ° C. | 100/ | 100/ | 100/ | 100/ | 100/ | 100/ | 100/ |
| temperature/metal mold | | | 260/ | 260/ | 260/ | 260/ | 260/ | 260/ | 260/ |
| temperature | | | 60 | 60 | 60 | 60 | 60 | 60 | 60 |
| Evaluation | Tensile strength | MPa | 60 | 58 | 59 | 58 | 58 | 58 | 59 |
| | Evaluation | — | A | A | A | A | A | A | A |
| | Flexural modulus | MPa | 2490 | 2440 | 2450 | 2430 | 2450 | 2430 | 2440 |
| | Evaluation | — | A | A | A | A | A | A | A |
| | Charpy impact strength | kJ/m² | 34 | 37 | 36 | 36 | 36 | 37 | 36 |
| | Surface impact strength | J | 18 | 24 | 24 | 24 | 24 | 24 | 23 |
| | (breakage energy) | | | | | | | | |
| | Form of fracture | — | C | A | A | A | A | A | A |
| | Deflection temperature | ° C. | 104 | 110 | 107 | 110 | 108 | 109 | 107 |
| | under load | | | | | | | | |
| | Hydrophilic powdery dust | % | 12 | 11 | 11 | 11 | 12 | 11 | 12 |
| | adhesive properties | | | | | | | | |
| | Evaluation | — | D | D | D | D | D | D | D |
| | Hydrophobic powdery dust | % | 7 | 11 | 10 | 11 | 10 | 11 | 10 |
| | adhesive properties | | | | | | | | |
| | Evaluation | — | C | D | D | D | D | D | D |

TABLE 11

| | | | | Example | | | | | | |
|---|---|---|---|---|---|---|---|---|---|---|
| Items | | | Units | b41 | b42 | b43 | b44 | b45 | b46 | b47 |
| Composition | Component A | PET | parts by | | | | 100 | | | |
| | | PBT | mass | 100 | 100 | 100 | | 100 | 100 | 100 |
| | Component B | PEPO-1 | parts by | | | | | | | |
| | | PEPO-2 | mass | 0.5 | 3.0 | 5.0 | 5.0 | 10.0 | 18.0 | 24.0 |
| | Component C | StZn | parts by | | | | | | | |
| | | StAl-1 | mass | | | | | | | |
| | | StAl-2 | | 2.0 | 2.0 | 2.0 | 2.0 | 2.0 | 2.0 | 2.0 |
| | | StAl-3 | | | | | | | | |
| Extrusion temperature (cylinder | | | ° C. | 240 | 240 | 240 | 260 | 240 | 240 | 240 |
| temperature) | | | | | | | | | | |
| Drying temperature/cylinder | | | ° C. | 100/ | 100/ | 100/ | 100/ | 100/ | 100/ | 100/ |
| temperature/metal mold | | | | 240/ | 240/ | 240/ | 260/ | 240/ | 240/ | 240/ |
| temperature | | | | 30 | 30 | 30 | 60 | 30 | 30 | 30 |
| Evaluation | Tensile strength | | MPa | 57 | 56 | 56 | 54 | 55 | 52 | 50 |
| | Evaluation | | — | A | A | A | A | A | B | C |
| | Flexural modulus | | MPa | 2510 | 2490 | 2420 | 2320 | 2370 | 2280 | 2180 |
| | Evaluation | | — | A | A | A | A | A | B | C |
| | Surface impact strength | | J | 24 | 23 | 23 | 23 | 23 | 21 | 19 |
| | (breakage energy) | | | | | | | | | |
| | Form of fracture | | — | A | A | A | A | A | A | A |
| | Deflection temperature | | ° C. | 59 | 58 | 58 | 60 | 58 | 57 | 56 |
| | under load | | | | | | | | | |
| | Hydrophilic powdery dust | | % | 5 | 1 | 1 | 1 | 1 | 1 | 1 |
| | adhesive properties | | | | | | | | | |
| | Evaluation | | — | B | A | A | A | A | A | A |
| | Hydrophobic powdery dust | | % | 5 | 2 | 1 | 1 | 1 | 1 | 1 |
| | adhesive properties | | | | | | | | | |
| | Evaluation | | — | B | A | A | A | A | A | A |
| | | | | Example | | | | | | |
| Items | | | Units | b48 | b49 | b50 | b51 | b52 | b53 | b54 |
| Composition | Component A | PET | parts by | | | | | | | 100 |
| | | PBT | mass | 100 | 100 | 100 | 100 | 100 | 100 | |
| | Component B | PEPO-1 | parts by | | | | | | 5.0 | 5.0 |
| | | PEPO-2 | mass | 5.0 | 5.0 | 5.0 | 5.0 | 5.0 | | |
| | Component C | StZn | parts by | | | | | | | |
| | | StAl-1 | mass | | | | | | | |
| | | StAl-2 | | 0.3 | 1.0 | 5.0 | 8.0 | 12.0 | 2.0 | 2.0 |
| | | StAl-3 | | | | | | | | |
| Extrusion temperature (cylinder | | | ° C. | 240 | 240 | 240 | 240 | 240 | 240 | 260 |
| temperature) | | | | | | | | | | |
| Drying temperature/cylinder | | | ° C. | 100/ | 100/ | 100/ | 100/ | 100/ | 100/ | 100/ |
| temperature/metal mold | | | | 240/ | 240/ | 240/ | 240/ | 240/ | 240/ | 260/ |
| temperature | | | | 30 | 30 | 30 | 30 | 30 | 30 | 60 |
| Evaluation | Tensile strength | | MPa | 56 | 56 | 57 | 57 | 58 | 56 | 54 |
| | Evaluation | | — | A | A | A | A | A | A | A |
| | Flexural modulus | | MPa | 2420 | 2420 | 2440 | 2440 | 2460 | 2410 | 2330 |
| | Evaluation | | — | A | A | A | A | A | A | A |
| | Surface impact strength | | J | 23 | 23 | 23 | 20 | 18 | 23 | 22 |
| | (breakage energy) | | | | | | | | | |
| | Form of fracture | | — | A | A | A | B | C | A | A |
| | Deflection temperature | | ° C. | 58 | 57 | 57 | 56 | 56 | 58 | 59 |
| | under load | | | | | | | | | |
| | Hydrophilic powdery dust | | % | 4 | 1 | 1 | 1 | 1 | 1 | 1 |
| | adhesive properties | | | | | | | | | |
| | Evaluation | | — | B | A | A | A | A | A | A |
| | Hydrophobic powdery dust | | % | 5 | 2 | 1 | 1 | 1 | 2 | 1 |
| | adhesive properties | | | | | | | | | |
| | Evaluation | | — | B | A | A | A | A | A | A |
| | | | | Example | | | | | | |
| Items | | | Units | b55 | b56 | b57 | b58 | b59 | b60 | b61 |
| Composition | Component A | PET | parts by | | | | | | | |
| | | PBT | mass | 100 | 100 | 100 | 100 | 100 | 100 | 100 |
| | Component B | PEPO-1 | parts by | 10.0 | | | | | | |
| | | PEPO-2 | mass | | 5.0 | 5.0 | 5.0 | 5.0 | 5.0 | 5.0 |
| | Component C | StZn | parts by | | 0.3 | 2.0 | | | | |
| | | StAl-1 | mass | | | | 0.3 | 2.0 | | |
| | | StAl-2 | | 2.0 | | | | | | |
| | | StAl-3 | | | | | | | 0.3 | 2.0 |

| Extrusion temperature (cylinder | | ° C. | 240 | 240 | 240 | 240 | 240 | 240 | 240 |
|---|---|---|---|---|---|---|---|---|---|
| temperature) | | | | | | | | | |
| Drying temperature/cylinder | | ° C. | 100/ | 100/ | 100/ | 100/ | 100/ | 100/ | 100/ |
| temperature/metal mold | | | 240/ | 240/ | 240/ | 240/ | 240/ | 240/ | 240/ |
| temperature | | | 30 | 30 | 30 | 30 | 30 | 30 | 30 |
| Evaluation | Tensile strength | MPa | 55 | 56 | 55 | 56 | 56 | 56 | 56 |
| | Evaluation | — | A | A | A | A | A | A | A |
| | Flexural modulus | MPa | 2380 | 2420 | 2430 | 2420 | 2420 | 2420 | 2430 |
| | Evaluation | — | A | A | A | A | A | A | A |
| | Surface impact strength | J | 22 | 22 | 23 | 22 | 22 | 23 | 22 |
| | (breakage energy) | | | | | | | | |
| | Form of fracture | — | A | A | A | A | A | A | A |
| | Deflection temperature | ° C. | 58 | 58 | 58 | 58 | 57 | 58 | 57 |
| | under load | | | | | | | | |
| | Hydrophilic powdery dust | % | 1 | 7 | 6 | 6 | 5 | 7 | 5 |
| | adhesive properties | | | | | | | | |
| | Evaluation | — | A | C | C | C | B | C | B |
| | Hydrophobic powdery dust | % | 1 | 8 | 7 | 6 | 5 | 8 | 5 |
| | adhesive properties | | | | | | | | |
| | Evaluation | — | A | C | C | C | B | C | B |

TABLE 12

| | | | | Comparative Example | | | | | | | |
|---|---|---|---|---|---|---|---|---|---|---|---|
| Items | | | Units | b41 | b42 | b43 | b44 | b45 | b46 | b47 | b48 |
| Composition | Component A | PET | parts by | 100 | | | | 100 | | | |
| | | PBT | mass | | 100 | 100 | 100 | | 100 | 100 | 100 |
| | Component B | PEPO-1 | parts by | | | | | | | | |
| | | PEPO-2 | mass | | | 3.0 | 5.0 | 5.0 | 10.0 | 18.0 | 24.0 |
| | | StZn | parts by | | | | | | | | |
| | Component C | StAl-1 | mass | | | | | | | | |
| | | SlAl-2 | | | | | | | | | |
| | | StAl-3 | | | | | | | | | |

| Extrusion temperature (cylinder | | ° C. | 260 | 240 | 240 | 240 | 260 | 240 | 240 | 240 |
|---|---|---|---|---|---|---|---|---|---|---|
| temperature) | | | | | | | | | | |
| Drying temperature/cylinder | | ° C. | 100/ | 100/ | 100/ | 100/ | 100/ | 100/ | 100/ | 100/ |
| temperature/metal mold | | | 260/ | 240/ | 240/ | 240/ | 260/ | 240/ | 240/ | 240/ |
| temperature | | | 30 | 30 | 30 | 30 | 60 | 30 | 30 | 30 |
| Evaluation | Tensile strength | MPa | 55 | 58 | 57 | 56 | 54 | 55 | 52 | 50 |
| | Evaluation | — | — | — | A | A | A | A | B | C |
| | Flexural modulus | MPa | 2430 | 2500 | 2480 | 2400 | 2310 | 2380 | 2270 | 2180 |
| | Evaluation | — | — | — | A | A | A | A | B | C |
| | Surface impact strength | J | 25 | 26 | 24 | 24 | 24 | 23 | 22 | 20 |
| | (breakage energy) | | | | | | | | | |
| | Form of fracture | — | A | A | A | A | A | A | A | A |
| | Deflection temperature | °c | 61 | 59 | 59 | 58 | 60 | 58 | 57 | 56 |
| | under load | | | | | | | | | |
| | Hydrophilic powdery dust | % | 10 | 10 | 10 | 8 | 8 | 6 | 5 | 5 |
| | adhesive properties | | | | | | | | | |
| | Evaluation | — | D | D | D | C | C | C | B | B |
| | Hydrophobic powdery dust | % | 10 | 10 | 10 | 10 | 10 | 11 | 12 | 12 |
| | adhesive properties | | | | | | | | | |
| | Evaluation | — | D | D | D | D | D | D | D | D |

| | | | | Comparative Example | | | | | | |
|---|---|---|---|---|---|---|---|---|---|---|
| Items | | | Units | b49 | b50 | b51 | b52 | b53 | b54 | b55 |
| Composition | Component A | PET | parts by | | 100 | | | | 100 | |
| | | PBT | mass | 100 | | 100 | 100 | 100 | | 100 |
| | Component B | PEPO-1 | parts by | 5.0 | 5.0 | 10.0 | | | | |
| | | PEPO-2 | mass | | | | | | | |
| | | StZn | parts by | | | | | | | |
| | Component C | StAl-1 | mass | | | | | | | |
| | | SlAl-2 | | | | | 0.3 | 2.0 | 2.0 | 5.0 |
| | | StAl-3 | | | | | | | | |

| Extrusion temperature (cylinder | | ° C. | 240 | 260 | 240 | 240 | 240 | 260 | 240 |
|---|---|---|---|---|---|---|---|---|---|
| temperature) | | | | | | | | | |
| Drying temperature/cylinder | | ° C. | 100/ | 100/ | 100/ | 100/ | 100/ | 100/ | 100/ |
| temperature/metal mold | | | 240/ | 260/ | 240/ | 240/ | 240/ | 260/ | 240/ |
| temperature | | | 30 | 60 | 30 | 30 | 30 | 60 | 30 |
| Evaluation | Tensile strength | MPa | 56 | 54 | 55 | 57 | 58 | 58 | 58 |
| | Evaluation | — | A | A | A | A | A | A | A |
| | Flexural modulus | MPa | 2400 | 2320 | 2380 | 2500 | 2520 | 2450 | 2550 |
| | Evaluation | — | A | A | A | A | A | A | A |
| | Surface impact strength | J | 23 | 24 | 23 | 24 | 25 | 24 | 20 |
| | (breakage energy) | | | | | | | | |
| | Form of fracture | — | A | A | A | A | A | A | A |
| | Deflection temperature | °c | 58 | 59 | 58 | 59 | 59 | 60 | 58 |
| | under load | | | | | | | | |
| | Hydrophilic powdery dust | % | 8 | 8 | 7 | 11 | 10 | 10 | 11 |
| | adhesive properties | | | | | | | | |
| | Evaluation | — | C | C | C | D | D | D | D |
| | Hydrophobic powdery dust | % | 11 | 10 | 11 | 10 | 10 | 10 | 8 |
| | adhesive properties | | | | | | | | |
| | Evaluation | — | D | D | D | D | D | D | C |

| | | | | Comparative Example | | | | | | |
|---|---|---|---|---|---|---|---|---|---|---|
| Items | | | Units | b56 | b57 | b58 | b59 | b60 | b61 | b62 |
| Composition | Component A | PET | parts by | | | | | | | |
| | | PBT | mass | 100 | 100 | 100 | 100 | 100 | 100 | 100 |
| | Component B | PEPO-1 | parts by | | | | | | | |
| | | PEPO-2 | mass | | | | | | | |
| | | StZn | parts by | | 2.0 | 5.0 | | | | |
| | Component C | StAl-1 | mass | | | | 2.0 | 5.0 | | |
| | | SlAl-2 | | 12.0 | | | | | | |
| | | StAl-3 | | | | | | | 2.0 | 5.0 |

| Extrusion temperature (cylinder | | ° C. | 240 | 240 | 240 | 240 | 240 | 240 | 240 |
|---|---|---|---|---|---|---|---|---|---|
| temperature) | | | | | | | | | |
| Drying temperature/cylinder | | ° C. | 100/ | 100/ | 100/ | 100/ | 100/ | 100/ | 100/ |
| temperature/metal mold | | | 240/ | 240/ | 240/ | 240/ | 240/ | 240/ | 240/ |
| temperature | | | 30 | 30 | 30 | 30 | 30 | 30 | 30 |
| Evaluation | Tensile strength | MPa | 59 | 58 | 58 | 58 | 59 | 58 | 59 |
| | Evaluation | — | A | A | A | A | A | A | A |
| | Flexural modulus | MPa | 2570 | 2530 | 2540 | 2520 | 2550 | 2530 | 2540 |
| | Evaluation | — | A | A | A | A | A | A | A |
| | Surface impact strength | J | 18 | 24 | 20 | 23 | 20 | 24 | 20 |
| | (breakage energy) | | | | | | | | |
| | Form of fracture | — | B | A | A | A | A | A | A |
| | Deflection temperature | °c | 56 | 59 | 58 | 59 | 59 | 59 | 58 |
| | under load | | | | | | | | |
| | Hydrophilic powdery dust | % | 11 | 11 | 10 | 10 | 11 | 10 | 10 |
| | adhesive properties | | | | | | | | |
| | Evaluation | — | D | D | D | D | D | D | D |
| | Hydrophobic powdery dust | % | 7 | 10 | 10 | 10 | 10 | 10 | 10 |
| | adhesive properties | | | | | | | | |
| | Evaluation | — | C | D | D | D | D | D | D |

TABLE 13

| | | | | Example | | | | | | |
|---|---|---|---|---|---|---|---|---|---|---|
| Items | | | Units | b62 | b63 | b64 | b65 | b66 | b67 | b68 |
| Composition | Component A | PET | parts by | 30 | 30 | 30 | 75 | 30 | 30 | 30 |
| | | ABS | mass | 70 | 70 | 70 | 25 | 70 | 70 | 70 |
| | Component B | PEPO-1 | parts by | 0.5 | 3.0 | 5.0 | 5.0 | 10.0 | 18.0 | 24.0 |
| | | PEPO-2 | mass | | | | | | | |
| | Component C | StZn | parts by | | | | | | | |
| | | StAl-1 | mass | | | | | | | |
| | | StAl-2 | | 2.0 | 2.0 | 2.0 | 2.0 | 2.0 | 2.0 | 2.0 |
| | | StAl-3 | | | | | | | | |
| Extrusion temperature (cylinder | | | ° C. | 260 | 260 | 260 | 260 | 260 | 260 | 260 |
| temperature) | | | | | | | | | | |
| Drying temperature/cylinder | | | ° C. | 90/ | 90/ | 90/ | 90/ | 90/ | 90/ | 90/ |
| temperature/metal mold | | | | 260/ | 260/ | 260/ | 260/ | 260/ | 260/ | 260/ |
| temperature | | | | 50 | 50 | 50 | 50 | 50 | 50 | 50 |
| Evaluation | Tensile strength | | MPa | 45 | 45 | 45 | 53 | 43 | 42 | 40 |
| | Evaluation | | — | A | A | A | A | A | B | C |
| | Flexural modulus | | MPa | 2200 | 2200 | 2190 | 2210 | 2120 | 2050 | 1940 |
| | Evaluation | | — | A | A | A | A | A | B | C |
| | Surface impact strength | | kJ/m² | 9 | 9 | 9 | 8 | 10 | 12 | 14 |
| | (breakage energy) | | | | | | | | | |
| | Form of fracture | | J | 23 | 23 | 22 | 26 | 20 | 20 | 18 |
| | Deflection temperature | | — | A | A | A | A | A | A | A |
| | under load | | | | | | | | | |
| | Hydrophilic powdery dust | | ° C. | 75 | 76 | 75 | 65 | 75 | 73 | 72 |
| | adhesive properties | | | | | | | | | |
| | Evaluation | | % | 5 | 2 | 1 | 1 | 1 | 1 | 1 |
| | Hydrophobic powdery dust | | — | B | A | A | A | A | A | A |
| | adhesive properties | | | | | | | | | |
| | Evaluation | | % | 4 | 2 | 1 | 1 | 1 | 1 | 1 |
| | Evaluation | | — | B | A | A | A | A | A | A |
| | | | | Example | | | | | | |
| Items | | | Units | b69 | b70 | b71 | b72 | b73 | b74 | b75 |
| Composition | Component A | PET | parts by | 30 | 30 | 30 | 30 | 30 | 30 | 75 |
| | | ABS | mass | 70 | 70 | 70 | 70 | 70 | 70 | 25 |
| | Component B | PEPO-1 | parts by | 5.0 | 5.0 | 5.0 | 5.0 | 5.0 | | |
| | | PEPO-2 | mass | | | | | | 5.0 | 5.0 |
| | Component C | StZn | parts by | | | | | | | |
| | | StAl-1 | mass | | | | | | | |
| | | StAl-2 | | 0.3 | 1.0 | 5.0 | 8.0 | 12.0 | 2.0 | 2.0 |
| | | StAl-3 | | | | | | | | |
| Extrusion temperature (cylinder | | | ° C. | 260 | 260 | 260 | 260 | 260 | 260 | 260 |
| temperature) | | | | | | | | | | |
| Drying temperature/cylinder | | | ° C. | 90/ | 90/ | 90/ | 90/ | 90/ | 90/ | 90/ |
| temperature/metal mold | | | | 260/ | 260/ | 260/ | 260/ | 260/ | 260/ | 260/ |
| temperature | | | | 50 | 50 | 50 | 50 | 50 | 50 | 50 |
| Evaluation | Tensile strength | | MPa | 45 | 45 | 46 | 47 | 49 | 45 | 53 |
| | Evaluation | | — | A | A | A | A | A | A | A |
| | Flexural modulus | | MPa | 2170 | 2200 | 2210 | 2230 | 2240 | 2180 | 2200 |
| | Evaluation | | — | A | A | A | A | A | A | A |
| | Surface impact strength | | kJ/m² | 10 | 9 | 9 | 8 | 8 | 9 | 8 |
| | (breakage energy) | | | | | | | | | |
| | Form of fracture | | J | 22 | 22 | 21 | 18 | 16 | 22 | 26 |
| | Deflection temperature | | — | A | A | A | B | C | A | A |
| | under load | | | | | | | | | |
| | Hydrophilic powdery dust | | ° C. | 75 | 76 | 76 | 75 | 74 | 75 | 65 |
| | adhesive properties | | | | | | | | | |
| | Evaluation | | % | 4 | 1 | 1 | 1 | 1 | 2 | 1 |
| | Hydrophobic powdery dust | | — | B | A | A | A | A | A | A |
| | adhesive properties | | | | | | | | | |
| | Evaluation | | % | 5 | 1 | 1 | 1 | 1 | 1 | 1 |
| | Evaluation | | — | B | A | A | A | A | A | A |
| | | | | Example | | | | | | |
| Items | | | Units | b76 | b77 | b78 | b79 | b80 | b81 | b82 |
| Composition | Component A | PET | parts by | 30 | 30 | 30 | 30 | 30 | 30 | 30 |
| | | ABS | mass | 70 | 70 | 70 | 70 | 70 | 70 | 70 |
| | Component B | PEPO-1 | parts by | | 5.0 | 5.0 | 5.0 | 5.0 | 5.0 | 5.0 |
| | | PEPO-2 | mass | 10.0 | | | | | | |
| | Component C | StZn | parts by | | 0.3 | 2.0 | | | | |
| | | StAl-1 | mass | | | | 0.3 | 2.0 | | |
| | | StAl-2 | | 2.0 | | | | | | |
| | | StAl-3 | | | | | | | 0.3 | 2.0 |

| Extrusion temperature (cylinder | | ° C. | 260 | 260 | 260 | 260 | 260 | 260 | 260 |
|---|---|---|---|---|---|---|---|---|---|
| temperature) | | | | | | | | | |
| Drying temperature/cylinder | | ° C. | 90/ | 90/ | 90/ | 90/ | 90/ | 90/ | 90/ |
| temperature/metal mold | | | 260/ | 260/ | 260/ | 260/ | 260/ | 260/ | 260/ |
| temperature | | | 50 | 50 | 50 | 50 | 50 | 50 | 50 |
| Evaluation | Tensile strength | MPa | 43 | 45 | 45 | 45 | 46 | 45 | 45 |
| | Evaluation | — | A | A | A | A | A | A | A |
| | Flexural modulus | MPa | 2120 | 2180 | 2190 | 2180 | 2180 | 2180 | 2190 |
| | Evaluation | — | A | A | A | A | A | A | A |
| | Surface impact strength | kJ/m² | 9 | 9 | 9 | 9 | 9 | 9 | 9 |
| | (breakage energy) | | | | | | | | |
| | Form of fracture | J | 20 | 22 | 22 | 23 | 23 | 22 | 23 |
| | Deflection temperature | — | A | A | A | A | A | A | A |
| | under load | | | | | | | | |
| | Hydrophilic powdery dust | ° C. | 75 | 75 | 74 | 75 | 74 | 74 | 74 |
| | adhesive properties | | | | | | | | |
| | Evaluation | % | 1 | 7 | 6 | 7 | 4 | 7 | 4 |
| | Hydrophobic powdery dust | — | A | C | C | C | B | C | B |
| | adhesive properties | | | | | | | | |
| | Evaluation | % | 2 | 7 | 7 | 6 | 5 | 8 | 5 |
| | Evaluation | — | A | C | C | C | B | C | B |

TABLE 14

| | | | | Comparative Example | | | | | | | |
|---|---|---|---|---|---|---|---|---|---|---|---|
| Items | | | Units | b63 | b64 | b65 | b66 | b67 | b68 | b69 | b70 |
| Composition | Component A | PET | parts by | 30 | 75 | 30 | 30 | 75 | 30 | 30 | 30 |
| | | ABS | mass | 70 | 25 | 70 | 70 | 25 | 70 | 70 | 70 |
| | Component B | PEPO-1 | parts by | | | | | | | | |
| | | PEPO-2 | mass | | | 3.0 | 5.0 | 5.0 | 10.0 | 18.0 | 24.0 |
| | Component C | StZn | parts by | | | | | | | | |
| | | StAl-1 | mass | | | | | | | | |
| | | StAl-2 | | | | | | | | | |
| | | StAl-3 | | | | | | | | | |

| Extrusion temperature (cylinder | | ° C. | 260 | 260 | 260 | 260 | 260 | 260 | 260 | 260 |
|---|---|---|---|---|---|---|---|---|---|---|
| temperature) | | | | | | | | | | |
| Drying temperature/cylinder | | ° C. | 90/ | 90/ | 90/ | 90/ | 90/ | 90/ | 90/ | 90/ |
| temperature/metal mold | | | 260/ | 260/ | 260/ | 260/ | 260/ | 260/ | 260/ | 260/ |
| temperature | | | 50 | 50 | 50 | 50 | 50 | 50 | 50 | 50 |
| Evaluations | Tensile strength | MPa | 45 | 54 | 45 | 45 | 53 | 43 | 41 | 39 |
| | Evaluation | — | — | — | A | A | A | A | B | C |
| | Flexural modulus | MPa | 2200 | 2220 | 2200 | 2180 | 2200 | 2100 | 2050 | 1950 |
| | Evaluation | — | — | — | A | A | A | A | B | C |
| | Charpy impact strength | kJ/m² | 9 | 8 | 9 | 10 | 8 | 11 | 12 | 14 |
| | Surface impact strength | J | 23 | 27 | 23 | 22 | 26 | 20 | 19 | 18 |
| | (breakage energy) | | | | | | | | | |
| | Form of fracture | — | A | A | A | A | A | A | A | A |
| | Deflection temperature | ° C. | 76 | 65 | 76 | 75 | 65 | 75 | 74 | 73 |
| | under load | | | | | | | | | |
| | Hydrophilic powdery dust | % | 11 | 10 | 10 | 8 | 9 | 7 | 5 | 5 |
| | adhesive properties | | | | | | | | | |
| | Evaluation | — | D | D | D | C | D | C | B | B |
| | Hydrophobic powdery dust | % | 11 | 11 | 10 | 10 | 11 | 11 | 12 | 12 |
| | adhesive properties | | | | | | | | | |
| | Evaluation | — | D | D | D | D | D | D | D | D |

| | | | | Comparative Example | | | | | | |
|---|---|---|---|---|---|---|---|---|---|---|
| Items | | | Units | b71 | b72 | b73 | b74 | b75 | b76 | b77 |
| Composition | Component A | PET | parts by | 30 | 75 | 30 | 30 | 30 | 75 | 30 |
| | | ABS | mass | 70 | 25 | 70 | 70 | 70 | 25 | 70 |
| | Component B | PEPO-1 | parts by | 5.0 | 5.0 | 10.0 | | | | |
| | | PEPO-2 | mass | | | | | | | |
| | Component C | StZn | parts by | | | | | | | |
| | | StAl-1 | mass | | | | | | | |
| | | StAl-2 | | | | | 0.3 | 2.0 | 2.0 | 5.0 |
| | | StAl-3 | | | | | | | | |

| Extrusion temperature (cylinder | | ° C. | 260 | 260 | 260 | 260 | 260 | 260 | 260 |
|---|---|---|---|---|---|---|---|---|---|
| temperature) | | | | | | | | | |
| Drying temperature/cylinder | | ° C. | 90/ | 90/ | 90/ | 90/ | 90/ | 90/ | 90/ |
| temperature/metal mold | | | 260/ | 260/ | 260/ | 260/ | 260/ | 260/ | 260/ |
| temperature | | | 50 | 50 | 50 | 50 | 50 | 50 | 50 |
| Evaluations | Tensile strength | MPa | 45 | 53 | 43 | 45 | 46 | 54 | 47 |
| | Evaluation | — | A | A | A | A | A | A | A |
| | Flexural modulus | MPa | 2190 | 2190 | 2110 | 2200 | 2210 | 2230 | 2220 |
| | Evaluation | — | A | A | A | A | A | A | A |
| | Charpy impact strength | kJ/m² | 10 | 9 | 12 | 10 | 9 | 8 | 9 |
| | Surface impact strength | J | 21 | 26 | 20 | 23 | 24 | 26 | 20 |
| | (breakage energy) | | | | | | | | |
| | Form of fracture | — | A | A | A | A | A | A | A |
| | Deflection temperature | ° C. | 75 | 65 | 74 | 76 | 76 | 65 | 75 |
| | under load | | | | | | | | |
| | Hydrophilic powdery dust | % | 8 | 9 | 7 | 11 | 11 | 10 | 10 |
| | adhesive properties | | | | | | | | |
| | Evaluation | — | C | D | C | D | D | D | D |
| | Hydrophobic powdery dust | % | 11 | 11 | 11 | 11 | 11 | 10 | 7 |
| | adhesive properties | | | | | | | | |
| | Evaluation | — | D | D | D | D | D | D | C |

| | | | | Comparative Example | | | | | | |
|---|---|---|---|---|---|---|---|---|---|---|
| Items | | | Units | b78 | b79 | b80 | b81 | b82 | b83 | b84 |
| Composition | Component A | PET | parts by | 30 | 30 | 30 | 30 | 30 | 30 | 30 |
| | | ABS | mass | 70 | 70 | 70 | 70 | 70 | 70 | 70 |
| | Component B | PEPO-1 | parts by | | | | | | | |
| | | PEPO-2 | mass | | | | | | | |
| | Component C | StZn | parts by | | 2.0 | 5.0 | | | | |
| | | StAl-1 | mass | | | | 2.0 | 5.0 | | |
| | | StAl-2 | | 12.0 | | | | | | |
| | | StAl-3 | | | | | | | 2.0 | 5.0 |

| Extrusion temperature (cylinder | | ° C. | 260 | 260 | 260 | 260 | 260 | 260 | 260 |
|---|---|---|---|---|---|---|---|---|---|
| temperature) | | | | | | | | | |
| Drying temperature/cylinder | | ° C. | 90/ | 90/ | 90/ | 90/ | 90/ | 90/ | 90/ |
| temperature/metal mold | | | 260/ | 260/ | 260/ | 260/ | 260/ | 260/ | 260/ |
| temperature | | | 50 | 50 | 50 | 50 | 50 | 50 | 50 |
| Evaluations | Tensile strength | MPa | 49 | 45 | 46 | 45 | 45 | 45 | 46 |
| | Evaluation | — | A | A | A | A | A | A | A |
| | Flexural modulus | MPa | 2250 | 2220 | 2230 | 2210 | 2230 | 2200 | 2220 |
| | Evaluation | — | A | A | A | A | A | A | A |
| | Charpy impact strength | kJ/m² | 7 | 10 | 9 | 9 | 9 | 10 | 9 |
| | Surface impact strength | J | 16 | 23 | 24 | 24 | 24 | 23 | 24 |
| | (breakage energy) | | | | | | | | |
| | Form of fracture | — | C | A | A | A | A | A | A |
| | Deflection temperature | ° C. | 73 | 76 | 75 | 76 | 75 | 76 | 75 |
| | under load | | | | | | | | |
| | Hydrophilic powdery dust | % | 11 | 11 | 11 | 11 | 11 | 10 | 11 |
| | adhesive properties | | | | | | | | |
| | Evaluation | — | D | n | D | D | D | D | D |
| | Hydrophobic powdery dust | % | 6 | 10 | 9 | 11 | 10 | 11 | 10 |
| | adhesive properties | | | | | | | | |
| | Evaluation | — | C | D | D | D | D | D | D |

TABLE 15

| | | | | Example | | | | | | |
|---|---|---|---|---|---|---|---|---|---|---|
| Items | | | Units | b83 | b84 | b85 | b86 | b87 | b88 | b89 |
| Composition | Component A | m-PPE | parts by | 100 | 100 | 100 | 100 | 100 | 100 | 100 |
| | | | mass | | | | | | | |
| | Component B | PEPO-1 | parts by | | | | | | | |
| | | PEPO-2 | mass | 0.5 | 3.0 | 5.0 | 10.0 | 18.0 | 24.0 | 5.0 |
| | Component C | StZn | parts by | | | | | | | |
| | | StAl-1 | mass | | | | | | | |
| | | StAl-2 | | 2.0 | 2.0 | 2.0 | 2.0 | 2.0 | 2.0 | 0.3 |
| | | StAl-3 | | | | | | | | |

| Extrusion temperature (cylinder | | ° C. | 280 | 280 | 280 | 280 | 280 | 280 | 280 |
|---|---|---|---|---|---|---|---|---|---|
| temperature) | | | | | | | | | |
| Drying temperature/cylinder | | ° C. | 100/ | 100/ | 100/ | 100/ | 100/ | 100/ | 100/ |
| temperature/metal mold | | | 280/ | 280/ | 280/ | 280/ | 280/ | 280/ | 280/ |
| temperature | | | 70 | 70 | 70 | 70 | 70 | 70 | 70 |
| Evaluations | Tensile strength | MPa | 53 | 53 | 52 | 51 | 49 | 47 | 52 |
| | Evaluation | — | A | A | A | A | B | C | A |
| | Flexural modulus | MPa | 2490 | 2460 | 2420 | 2380 | 2350 | 2190 | 2430 |
| | Evaluation | — | A | A | A | A | B | C | A |
| | Charpy impact strength | kJ/m² | 5 | 8 | 10 | 12 | 15 | 20 | 10 |
| | Surface impact strength | J | 15 | 15 | 20 | 21 | 21 | 20 | 21 |
| | (breakage energy) | | | | | | | | |
| | Form of fracture | — | C | C | A | A | A | A | A |
| | Deflection temperature | ° C. | 106 | 106 | 106 | 104 | 103 | 101 | 106 |
| | under load | | | | | | | | |
| | Hydrophilic powdery dust | % | 5 | 2 | 1 | 1 | 1 | 1 | 4 |
| | adhesive properties | | | | | | | | |
| | Evaluation | — | B | A | A | A | A | A | B |
| | Hydrophobic powdery dust | % | 5 | 2 | 2 | 1 | 1 | 1 | 5 |
| | adhesive properties | | | | | | | | |
| | Evaluation | — | B | A | A | A | A | A | B |

| | | | | Example | | | | | |
|---|---|---|---|---|---|---|---|---|---|
| Items | | | Units | b90 | b91 | b92 | b93 | b94 | b95 |
| Composition | Component A | m-PPE | parts by | 100 | 100 | 100 | 100 | 100 | 100 |
| | | | mass | | | | | | |
| | Component B | PEPO-1 | parts by | | | | | 5.0 | 10.0 |
| | | PEPO-2 | mass | 5.0 | 5.0 | 5.0 | 5.0 | | |
| | Component C | StZn | parts by | | | | | | |
| | | StAl-1 | mass | | | | | | |
| | | StAl-2 | | 1.0 | 5.0 | 8.0 | 12.0 | 2.0 | 2.0 |
| | | StAl-3 | | | | | | | |

| Extrusion temperature (cylinder | | ° C. | 280 | 280 | 280 | 280 | 280 | 280 |
|---|---|---|---|---|---|---|---|---|
| temperature) | | | | | | | | |
| Drying temperature/cylinder | | ° C. | 100/ | 100/ | 100/ | 100/ | 100/ | 100/ |
| temperature/metal mold | | | 280/ | 280/ | 280/ | 280/ | 280/ | 280/ |
| temperature | | | 70 | 70 | 70 | 70 | 70 | 70 |
| Evaluations | Tensile strength | MPa | 53 | 54 | 54 | 56 | 51 | 51 |
| | Evaluation | — | A | A | A | A | A | A |
| | Flexural modulus | MPa | 2430 | 2440 | 2440 | 2460 | 2410 | 2390 |
| | Evaluation | — | A | A | A | A | A | A |
| | Charpy impact strength | kJ/m² | 10 | 11 | 10 | 9 | 10 | 12 |
| | Surface impact strength | J | 20 | 20 | 18 | 17 | 19 | 20 |
| | (breakage energy) | | | | | | | |
| | Form of fracture | — | A | A | B | C | A | A |
| | Deflection temperature | ° C. | 106 | 106 | 105 | 102 | 106 | 104 |
| | under load | | | | | | | |
| | Hydrophilic powdery dust | % | 1 | 1 | 1 | 1 | 1 | 1 |
| | adhesive properties | | | | | | | |
| | Evaluation | — | A | A | A | A | A | A |
| | Hydrophobic powdery dust | % | 2 | 1 | 1 | 1 | 2 | 2 |
| | adhesive properties | | | | | | | |
| | Evaluation | — | A | A | A | A | A | A |

| | | | | Example | | | | | |
|---|---|---|---|---|---|---|---|---|---|
| Items | | | Units | b96 | b97 | b98 | b99 | b100 | b101 |
| Composition | Component A | m-PPE | parts by | 100 | 100 | 100 | 100 | 100 | 100 |
| | | | mass | | | | | | |
| | Component B | PEPO-1 | parts by | | | | | | |
| | | PEPO-2 | mass | 5.0 | 5.0 | 5.0 | 5.0 | 5.0 | 5.0 |
| | Component C | StZn | parts by | 0.3 | 2.0 | | | | |
| | | StAl-1 | mass | | | 0.3 | 2.0 | | |
| | | StAl-2 | | | | | | | |
| | | StAl-3 | | | | | | 0.3 | 2.0 |

| Extrusion temperature (cylinder | | ° C. | 280 | 280 | 280 | 280 | 280 | 280 |
|---|---|---|---|---|---|---|---|---|
| temperature) | | | | | | | | |
| Drying temperature/cylinder | | ° C. | 100/ | 100/ | 100/ | 100/ | 100/ | 100/ |
| temperature/metal mold | | | 280/ | 280/ | 280/ | 280/ | 280/ | 280/ |
| temperature | | | 70 | 70 | 70 | 70 | 70 | 70 |
| Evaluations | Tensile strength | MPa | 52 | 52 | 52 | 52 | 57 | 53 |
| | Evaluation | — | A | A | A | A | A | A |
| | Flexural modulus | MPa | 2420 | 2420 | 2430 | 2430 | 2420 | 2420 |
| | Evaluation | — | A | A | A | A | A | A |
| | Charpy impact strength | kJ/m² | 10 | 10 | 10 | 9 | 10 | 10 |
| | Surface impact strength | J | 20 | 19 | 20 | 20 | 20 | 19 |
| | (breakage energy) | | | | | | | |
| | Form of fracture | — | A | A | A | A | A | A |
| | Deflection temperature | ° C. | 106 | 105 | 106 | 106 | 106 | 105 |
| | under load | | | | | | | |
| | Hydrophilic powdery dust | % | 6 | 6 | 6 | 4 | 6 | 4 |
| | adhesive properties | | | | | | | |
| | Evaluation | — | C | C | C | B | C | B |
| | Hydrophobic powdery dust | % | 7 | 6 | 6 | 5 | 8 | 5 |
| | adhesive properties | | | | | | | |
| | Evaluation | — | C | C | C | B | C | B |

TABLE 16

| | | | | Comparative Example | | | | | | | | |
|---|---|---|---|---|---|---|---|---|---|---|---|---|
| Items | | | Units | b85 | b86 | b87 | b88 | b89 | b90 | b91 | b92 | b93 |
| Composition | Component A | m-PPE | pads by | 100 | 100 | 100 | 100 | 100 | 100 | 100 | 100 | 100 |
| | | | mass | | | | | | | | | |
| | Component B | PEPO-1 | parts by | | 3.0 | 5.0 | 10.0 | 18.0 | 24.0 | | | |
| | | PEPO-2 | mass | | | | | | | 5.0 | 10.0 | |
| | Component C | StZn | parts by | | | | | | | | | |
| | | StAl-1 | mass | | | | | | | | | |
| | | StAl-2 | | | | | | | | | | 0.3 |
| | | StAl-3 | | | | | | | | | | |
| Extrusion temperature (cylinder | | | ° C. | 280 | 280 | 280 | 280 | 280 | 280 | 280 | 280 | 280 |
| temperature) | | | | | | | | | | | | |
| Drying temperature/cylinder | | | ° C. | 100/ | 100/ | 100/ | 100/ | 100/ | 100/ | 100/ | 100/ | 100/ |
| temperature/metal mold | | | | 280/ | 280/ | 280/ | 280/ | 280/ | 280/ | 280/ | 280/ | 280/ |
| temperature | | | | 70 | 70 | 70 | 70 | 70 | 70 | 70 | 70 | 70 |
| Evaluations | Tensile strength | | MPa | 53 | 53 | 52 | 50 | 49 | 47 | 52 | 50 | 53 |
| | Evaluation | | — | — | A | A | A | B | C | A | A | A |
| | Flexural modulus | | MPa | 2500 | 2450 | 2410 | 2380 | 2350 | 2200 | 2410 | 2390 | 2500 |
| | Evaluation | | — | — | A | A | A | B | C | A | A | A |
| | Charpy impact strength | | kJ/m² | 5 | 8 | 10 | 12 | 16 | 20 | 9 | 12 | 5 |
| | Surface impact strength | | J | 13 | 15 | 20 | 22 | 21 | 20 | 20 | 20 | 13 |
| | (breakage energy) | | | | | | | | | | | |
| | Form of fracture | | — | D | C | A | A | A | A | A | A | D |
| | Deflection temperature | | ° C. | 106 | 106 | 105 | 104 | 102 | 101 | 105 | 104 | 106 |
| | under load | | | | | | | | | | | |
| | Hydrophilic powdery dust | | % | 11 | 10 | 9 | 6 | 5 | 5 | 9 | 8 | 11 |
| | adhesive properties | | | | | | | | | | | |
| | Evaluation | | — | D | D | D | C | B | B | D | C | D |
| | Hydrophobic powdery dust | | % | 12 | 10 | 11 | 11 | 12 | 12 | 11 | 11 | 12 |
| | adhesive properties | | | | | | | | | | | |
| | Evaluation | | — | D | D | D | D | D | D | D | D | D |
| | | | | Comparative Example | | | | | | | | |
| Items | | | Units | b94 | b95 | b96 | b97 | b98 | b99 | b100 | b101 | b102 |
| Composition | Component A | m-PPE | pads by | 100 | 100 | 100 | 100 | 100 | 100 | 100 | 100 | 100 |
| | | | mass | | | | | | | | | |
| | Component B | PEPO-1 | parts by | | | | | | | | | |
| | | PEPO-2 | mass | | | | | | | | | |
| | Component C | StZn | parts by | | | | 2.0 | 5.0 | | | | |
| | | StAl-1 | mass | | | | | | 2.0 | 5.0 | | |
| | | StAl-2 | | 2.0 | 5.0 | 12.0 | | | | | | |
| | | StAl-3 | | | | | | | | | 2.0 | 5.0 |

| Extrusion temperature (cylinder | | ° C. | 280 | 280 | 280 | 280 | 280 | 280 | 280 | 280 | 280 |
|---|---|---|---|---|---|---|---|---|---|---|---|
| temperature) | | | | | | | | | | | |
| Drying temperature/cylinder | | ° C. | 100/ | 100/ | 100/ | 100/ | 100/ | 100/ | 100/ | 100/ | 100/ |
| temperature/metal mold | | | 280/ | 280/ | 280/ | 280/ | 280/ | 280/ | 280/ | 280/ | 280/ |
| temperature | | | 70 | 70 | 70 | 70 | 70 | 70 | 70 | 70 | 70 |
| Evaluations | Tensile strength | MPa | 53 | 54 | 56 | 53 | 54 | 53 | 53 | 53 | 54 |
| | Evaluation | — | A | A | A | A | A | A | A | A | A |
| | Flexural modulus | MPa | 2510 | 2530 | 2540 | 2520 | 2520 | 2510 | 2520 | 2510 | 2520 |
| | Evaluation | — | A | A | A | A | A | A | A | A | A |
| | Charpy impact strength | kJ/m² | 5 | 4 | 3 | 4 | 4 | 4 | 3 | 4 | 4 |
| | Surface impact strength | J | 13 | 11 | 9 | 13 | 11 | 12 | 11 | 13 | 12 |
| | (breakage energy) | | | | | | | | | | |
| | Form of fracture | — | D | D | D | D | D | D | D | D | D |
| | Deflection temperature | ° C. | 106 | 105 | 104 | 106 | 105 | 105 | 105 | 106 | 105 |
| | under load | | | | | | | | | | |
| | Hydrophilic powdery dust | % | 11 | 12 | 12 | 11 | 12 | 11 | 11 | 11 | 11 |
| | adhesive properties | | | | | | | | | | |
| | Evaluation | — | D | D | D | D | D | D | D | D | D |
| | Hydrophobic powdery dust | % | 11 | 8 | 7 | 11 | 9 | 11 | 10 | 11 | 10 |
| | adhesive properties | | | | | | | | | | |
| | Evaluation | — | D | C | C | D | D | D | D | D | D |

TABLE 17

| | | | | Example | | | | | | |
|---|---|---|---|---|---|---|---|---|---|---|
| Items | | | Units | b102 | b103 | b104 | b105 | b106 | b107 | b108 |
| Composition | Cooponent A | PMMA | parts by | 100 | 100 | 100 | 100 | 100 | 100 | 100 |
| | | | mass | | | | | | | |
| | Component B | PEPO-1 | parts by | | | | | | | |
| | | PEPO-2 | mass | 0.5 | 3.0 | 5.0 | 10.0 | 18.0 | 24.0 | 5.0 |
| | Component C | StZn | parts by | | | | | | | |
| | | StAl-1 | mass | | | | | | | |
| | | StAl-2 | | 2.0 | 2.0 | 2.0 | 2.0 | 2.0 | 2.0 | 0.3 |
| | | StAl-3 | | | | | | | | |

| Extrusion temperature (cylinder | | ° C. | 240 | 240 | 240 | 240 | 240 | 240 | 240 |
|---|---|---|---|---|---|---|---|---|---|
| temperature) | | | | | | | | | |
| Drying temperature/cylinder | | ° C. | 80/ | 80/ | 80/ | 80/ | 80/ | 80/ | 80/ |
| temperature/metal mold | | | 240/ | 240/ | 240/ | 240/ | 240/ | 240/ | 240/ |
| temperature | | | 50 | 50 | 50 | 50 | 50 | 50 | 50 |
| Evaluations \| | Tensile strength | MPa | 62 | 62 | 61 | 59 | 57 | 53 | 61 |
| | Evaluation | — | A | A | A | A | B | C | A |
| | Flexural modulus | MPa | 2490 | 2470 | 2450 | 2390 | 2310 | 2180 | 2440 |
| | Evaluation | — | A | A | A | A | B | C | A |
| | Deflection temperature | ° C. | 71 | 71 | 70 | 69 | 68 | 65 | 71 |
| | under load | | | | | | | | |
| | Hydrophilic powdery dust | % | 4 | 1 | 1 | 1 | 1 | 1 | 4 |
| | adhesive properties | | | | | | | | |
| | Evaluation | — | B | A | A | A | A | A | B |
| | Hydrophobic powdery dust | % | 4 | 2 | 2 | 1 | 1 | 1 | 4 |
| | adhesive properties | | | | | | | | |
| | Evaluation | — | B | A | A | A | A | A | B |

| | | | | Example | | | | | |
|---|---|---|---|---|---|---|---|---|---|
| Items | | | Units | b109 | b110 | b111 | b112 | b113 | b114 |
| Composition | Cooponent A | PMMA | parts by | 100 | 100 | 100 | 100 | 100 | 100 |
| | | | mass | | | | | | |
| | Component B | PEPO-1 | parts by | | | | | 5.0 | 10.0 |
| | | PEPO-2 | mass | 5.0 | 5.0 | 5.0 | 5.0 | | |
| | Component C | StZn | parts by | | | | | | |
| | | StAl-1 | mass | | | | | | |
| | | StAl-2 | | 1.0 | 5.0 | 8.0 | 12.0 | 2.0 | 2.0 |
| | | StAl-3 | | | | | | | |

| Extrusion temperature (cylinder | | ° C. | 240 | 240 | 240 | 240 | 240 | 240 |
|---|---|---|---|---|---|---|---|---|
| temperature) | | | | | | | | |
| Drying temperature/cylinder | | ° C. | 80/ | 80/ | 80/ | 80/ | 80/ | 80/ |
| temperature/metal mold | | | 240/ | 240/ | 240/ | 240/ | 240/ | 240/ |
| temperature | | | 50 | 50 | 50 | 50 | 50 | 50 |
| Evaluations \| | Tensile strength | MPa | 61 | 62 | 62 | 63 | 61 | 60 |
| | Evaluation | — | A | A | A | A | A | A |
| | Flexural modulus | MPa | 2450 | 2460 | 2470 | 2480 | 2440 | 2400 |
| | Evaluation | — | A | A | A | A | A | A |
| | Deflection temperature | ° C. | 71 | 70 | 69 | 68 | 71 | 70 |
| | under load | | | | | | | |
| | Hydrophilic powdery dust | % | 1 | 1 | 1 | 1 | 2 | 1 |
| | adhesive properties | | | | | | | |
| | Evaluation | — | A | A | A | A | A | A |
| | Hydrophobic powdery dust | % | 1 | 1 | 1 | 1 | 2 | 2 |
| | adhesive properties | | | | | | | |
| | Evaluation | — | A | A | A | A | A | A |

| | | | | Example | | | | | |
|---|---|---|---|---|---|---|---|---|---|
| Items | | | Units | b115 | b116 | b117 | b118 | b119 | b120 |
| Composition | Cooponent A | PMMA | parts by | 100 | 100 | 100 | 100 | 100 | 100 |
| | | | mass | | | | | | |
| | Component B | PEPO-1 | parts by | | | | | | |
| | | PEPO-2 | mass | 5.0 | 5.0 | 5.0 | 5.0 | 5.0 | 5.0 |
| | Component C | StZn | parts by | 0.3 | 2.0 | | | | |
| | | StAl-1 | mass | | | 0.3 | 2.0 | | |
| | | StAl-2 | | | | | | | |
| | | StAl-3 | | | | | | 0.3 | 2.0 |

| Extrusion temperature (cylinder | | ° C. | 240 | 240 | 240 | 240 | 240 | 240 |
|---|---|---|---|---|---|---|---|---|
| temperature) | | | | | | | | |
| Drying temperature/cylinder | | ° C. | 80/ | 80/ | 80/ | 80/ | 80/ | 80/ |
| temperature/metal mold | | | 240/ | 240/ | 240/ | 240/ | 240/ | 240/ |
| temperature | | | 50 | 50 | 50 | 50 | 50 | 50 |
| Evaluations \| | Tensile strength | MPa | 61 | 61 | 60 | 61 | 60 | 61 |
| | Evaluation | — | A | A | A | A | A | A |
| | Flexural modulus | MPa | 2440 | 2430 | 2430 | 2440 | 2440 | 2440 |
| | Evaluation | — | A | A | A | A | A | A |
| | Deflection temperature | ° C. | 71 | 70 | 71 | 71 | 71 | 70 |
| | under load | | | | | | | |
| | Hydrophilic powdery dust | % | 7 | 6 | 7 | 4 | 7 | 4 |
| | adhesive properties | | | | | | | |
| | Evaluation | — | C | C | C | B | C | B |
| | Hydrophobic powdery dust | % | 7 | 6 | 6 | 5 | 8 | 5 |
| | adhesive properties | | | | | | | |
| | Evaluation | — | C | C | C | B | C | B |

TABLE 18

| | | | | Comparative Example | | | | | | | | |
|---|---|---|---|---|---|---|---|---|---|---|---|---|
| Hems | | | Units | b103 | b104 | b105 | b106 | b107 | b108 | b109 | b110 | b111 |
| Composition | Component A | PMMA | parts by | 100 | 100 | 100 | 100 | 100 | 100 | 100 | 100 | 100 |
| | | | mass | | | | | | | | | |
| | Component B | PEPO-1 | parts by | | 3.0 | 5.0 | 10.0 | 18.0 | 24.0 | | | |
| | | PEPO-2 | mass | | | | | | | 5.0 | 10.0 | |
| | Component C | StZa | parts by | | | | | | | | | |
| | | StAl-1 | mass | | | | | | | | | |
| | | StAl-2 | | | | | | | | | | 0.3 |
| | | StAl-3 | | | | | | | | | | |
| Extrusion temperature (cylinder | | | ° C. | 240 | 240 | 240 | 240 | 240 | 240 | 240 | 240 | 240 |
| temperature) | | | | | | | | | | | | |
| Drying temperature/cylinder | | | ° C. | 80/ | 80/ | 80/ | 80/ | 80/ | 80/ | 80/ | 80/ | 80/ |
| temperature/metal mold | | | | 240/ | 240/ | 240/ | 240/ | 240/ | 240/ | 240/ | 240/ | 240/ |
| temperature | | | | 50 | 50 | 50 | 50 | 50 | 50 | 50 | 50 | 50 |
| Evaluations | Tensile strength | | MPa | 62 | 62 | 61 | 59 | 57 | 54 | 62 | 60 | 62 |
| | Evaluation | | — | — | A | A | A | B | C | A | A | A |
| | Flexural modulus | | MPa | 2500 | 2470 | 2440 | 2380 | 2310 | 2190 | 2440 | 2390 | 2500 |
| | Evaluation | | — | — | A | A | A | B | C | A | A | A |
| | Deflection temperature | | ° C. | 72 | 71 | 70 | 69 | 68 | 65 | 71 | 69 | 72 |
| | under load | | | | | | | | | | | |
| | Hydrophilic powdery dust | | % | 11 | 10 | 8 | 6 | 5 | 5 | 8 | 6 | 11 |
| | adhesive properties | | | | | | | | | | | |
| | Evaluation | | — | D | D | C | C | B | B | C | C | D |
| | Hydrophobic powdery dust | | % | 11 | 10 | 10 | 11 | 12 | 12 | 11 | 10 | 11 |
| | adhesive properties | | | | | | | | | | | |
| | Evaluation | | — | D | D | D | D | D | D | D | D | D |
| | | | | Comparative Example | | | | | | | | |
| Hems | | | Units | b112 | b113 | b114 | b115 | b116 | b117 | b118 | b119 | b120 |
| Composition | Component A | PMMA | parts by | 100 | 100 | 100 | 100 | 100 | 100 | 100 | 100 | 100 |
| | | | mass | | | | | | | | | |
| | Component B | PEPO-1 | parts by | | | | | | | | | |
| | | PEPO-2 | mass | | | | | | | | | |
| | Component C | StZa | parts by | | | | 2.0 | 5.0 | | | | |
| | | StAl-1 | mass | | | | | | 2.0 | 5.0 | | |
| | | StAl-2 | | 2.0 | 5.0 | 12.0 | | | | | | |
| | | StAl-3 | | | | | | | | | 2.0 | 5.0 |

| Extrusion temperature (cylinder | | ° C. | 240 | 240 | 240 | 240 | 240 | 240 | 240 | 240 | 240 |
|---|---|---|---|---|---|---|---|---|---|---|---|
| temperature) | | | | | | | | | | | |
| Drying temperature/cylinder | | ° C. | 80/ | 80/ | 80/ | 80/ | 80/ | 80/ | 80/ | 80/ | 80/ |
| temperature/metal mold | | | 240/ | 240/ | 240/ | 240/ | 240/ | 240/ | 240/ | 240/ | 240/ |
| temperature | | | 50 | 50 | 50 | 50 | 50 | 50 | 50 | 50 | 50 |
| Evaluations | Tensile strength | MPa | 62 | 63 | 65 | 62 | 62 | 62 | 63 | 62 | 63 |
| | Evaluation | — | A | A | A | A | A | A | A | A | A |
| | Flexural modulus | MPa | 2510 | 2520 | 2540 | 2500 | 2520 | 2510 | 2520 | 2510 | 2510 |
| | Evaluation | — | A | A | A | A | A | A | A | A | A |
| | Deflection temperature | ° C. | 71 | 70 | 68 | 70 | 69 | 71 | 69 | 70 | 69 |
| | under load | | | | | | | | | | |
| | Hydrophilic powdery dust | % | 11 | 12 | 12 | 11 | 12 | 12 | 11 | 11 | 12 |
| | adhesive properties | | | | | | | | | | |
| | Evaluation | — | D | D | D | D | D | D | D | D | D |
| | Hydrophobic powdery dust | % | 10 | 9 | 6 | 10 | 9 | 11 | 10 | 11 | 10 |
| | adhesive properties | | | | | | | | | | |
| | Evaluation | — | D | D | C | D | D | D | D | D | D |

TABLE 19

| | | | | Example | | | | | | |
|---|---|---|---|---|---|---|---|---|---|---|
| Items | | | Units | b121 | b122 | b123 | b124 | b125 | b126 | b127 |
| Composition | Component A | PPS | parts by | 100 | 100 | 100 | 100 | 100 | 100 | 100 |
| | | | mass | | | | | | | |
| | Component B | PEPO-1 | parts by | | | | | | | |
| | | PEPO-2 | mass | 0.3 | 3.0 | 5.0 | 10.0 | 18.0 | 24.0 | 5.0 |
| | Component C | StZn | parts by | | | | | | | |
| | | StAl-1 | mass | | | | | | | |
| | | StAl-2 | | 2.0 | 2.0 | 2.0 | 2.0 | 2.0 | 2.0 | 0.3 |
| | | StAl-3 | | | | | | | | |

| Extrusion temperature (cylinder | | ° C. | 300 | 300 | 300 | 300 | 300 | 300 | 300 |
|---|---|---|---|---|---|---|---|---|---|
| temperature) | | | | | | | | | |
| Drying temperature/cylinder | | ° C. | 120/ | 120/ | 120/ | 120/ | 120/ | 120/ | 120/ |
| temperature/metal mold | | | 300/ | 300/ | 300/ | 300/ | 300/ | 300/ | 300/ |
| temperature | | | 120 | 120 | 120 | 120 | 120 | 120 | 120 |
| | Tensile strength | MPa | 85 | 84 | 83 | 81 | 78 | 74 | 83 |
| | Evaluation | — | A | A | A | A | B | C | A |
| | Flexural modulus | MPa | 3810 | 3720 | 3680 | 3620 | 3450 | 3300 | 3670 |
| | Evaluation | — | A | A | A | A | B | C | A |
| | Deflection temperature | ° C. | 105 | 104 | 104 | 101 | 99 | 96 | 105 |
| | under load | | | | | | | | |
| | Hydrophilic powdery dust | % | 5 | 2 | 1 | 1 | 1 | 1 | 4 |
| | adhesive properties | | | | | | | | |
| | Evaluation | — | B | A | A | A | A | A | B |
| | Hydrophobic powdery dust | % | 5 | 2 | 2 | 1 | 1 | 1 | 5 |
| | adhesive properties | | | | | | | | |
| | Evaluation | | B | A | A | A | A | A | B |

| | | | | Example | | | | | |
|---|---|---|---|---|---|---|---|---|---|
| Items | | | Units | b128 | b129 | b130 | b131 | b132 | b133 |
| Composition | Component A | PPS | parts by | 100 | 100 | 100 | 100 | 100 | 100 |
| | | | mass | | | | | | |
| | Component B | PEPO-1 | parts by | | | | | 5.0 | 10.0 |
| | | PEPO-2 | mass | 5.0 | 5.0 | 5.0 | 5.0 | | |
| | Component C | StZn | parts by | | | | | | |
| | | StAl-1 | mass | | | | | | |
| | | StAl-2 | | 1.0 | 5.0 | 8.0 | 12.0 | 2.0 | 2.0 |
| | | StAl-3 | | | | | | | |

| Extrusion temperature (cylinder | | ° C. | 300 | 300 | 300 | 300 | 300 | 300 |
|---|---|---|---|---|---|---|---|---|
| temperature) | | | | | | | | |
| Drying temperature/cylinder | | ° C. | 120/ | 120/ | 120/ | 120/ | 120/ | 120/ |
| temperature/metal mold | | | 300/ | 300/ | 300/ | 300/ | 300/ | 300/ |
| temperature | | | 120 | 120 | 120 | 120 | 120 | 120 |
| | Tensile strength | MPa | 83 | 84 | 84 | 85 | 83 | 82 |
| | Evaluation | — | A | A | A | A | A | A |
| | Flexural modulus | MPa | 3680 | 3690 | 3690 | 3700 | 3670 | 3630 |
| | Evaluation | — | A | A | A | A | A | A |
| | Deflection temperature | ° C. | 104 | 103 | 103 | 102 | 104 | 102 |
| | under load | | | | | | | |
| | Hydrophilic powdery dust | % | 1 | 1 | 1 | 1 | 2 | 1 |
| | adhesive properties | | | | | | | |
| | Evaluation | — | A | A | A | A | A | A |
| | Hydrophobic powdery dust | % | 1 | 1 | 1 | 1 | 2 | 2 |
| | adhesive properties | | | | | | | |
| | Evaluation | | A | A | A | A | A | A |

| | | | | Example | | | | | |
|---|---|---|---|---|---|---|---|---|---|
| Items | | | Units | b134 | b135 | b136 | b137 | b138 | b139 |
| Composition | Component A | PPS | parts by | 100 | 100 | 100 | 100 | 100 | 100 |
| | | | mass | | | | | | |
| | Component B | PEPO-1 | parts by | | | | | | |
| | | PEPO-2 | mass | 5.0 | 5.0 | 5.0 | 5.0 | 5.0 | 5.0 |
| | Component C | StZn | parts by | 0.3 | 2.0 | | | | |
| | | StAl-1 | mass | | | 0.3 | 2.0 | | |
| | | StAl-2 | | | | | | | |
| | | StAl-3 | | | | | | 0.3 | 2.0 |

| | | | | | | | |
|---|---|---|---|---|---|---|---|
| Extrusion temperature (cylinder | ° C. | 300 | 300 | 300 | 300 | 300 | 300 |
| temperature) | | | | | | | |
| Drying temperature/cylinder | ° C. | 120/ | 120/ | 120/ | 120/ | 120/ | 120/ |
| temperature/metal mold | | 300/ | 300/ | 300/ | 300/ | 300/ | 300/ |
| temperature | | 120 | 120 | 120 | 120 | 120 | 120 |

| | | | | | | | |
|---|---|---|---|---|---|---|---|
| Tensile strength | MPa | 83 | 84 | 83 | 83 | 83 | 83 |
| Evaluation | — | A | A | A | A | A | A |
| Flexural modulus | MPa | 3670 | 3670 | 3680 | 3680 | 3670 | 3680 |
| Evaluation | — | A | A | A | A | A | A |
| Deflection temperature | ° C. | 105 | 105 | 105 | 104 | 104 | 104 |
| under load | | | | | | | |
| Hydrophilic powdery dust | % | 8 | 6 | 7 | 5 | 7 | 5 |
| adhesive properties | | | | | | | |
| Evaluation | — | C | C | C | B | C | B |
| Hydrophobic powdery dust | % | 7 | 7 | 8 | 5 | 7 | 4 |
| adhesive properties | | | | | | | |
| Evaluation | | C | C | C | B | C | B |

TABLE 20

| | | | | Comparative Example | | | | | | | | | |
|---|---|---|---|---|---|---|---|---|---|---|---|---|---|
| Items | | | Units | b121 | b122 | b123 | b124 | b125 | b126 | b127 | b128 | b129 | b130 |
| Composition | Component A | PPS | parts by | 100 | 100 | 100 | 100 | 100 | 100 | 100 | 100 | 100 | 100 |
| | | | mass | | | | | | | | | | |
| | Component B | PEPO-1 | parts by | | 3.0 | 5.0 | 10.0 | 18.0 | 24.0 | | | | |
| | | PEPO-2 | mass | | | | | | | 5.0 | 10.0 | | |
| | Component C | StZn | parts by | | | | | | | | | | |
| | | StAl-1 | mass | | | | | | | | | | |
| | | StAl-2 | | | | | | | | | | 0.3 | 2.0 |
| | | StAl-3 | | | | | | | | | | | |

| Extrusion temperature (cylinder | | ° C. | 300 | 300 | 300 | 300 | 300 | 300 | 300 | 300 | 300 | 300 |
|---|---|---|---|---|---|---|---|---|---|---|---|---|
| temperature) | | | | | | | | | | | | |
| Drying temperature/cylinder | | ° C. | 120/ | 120/ | 120/ | 120/ | 120/ | 120/ | 120/ | 120/ | 120/ | 120/ |
| temperature/metal mold | | | 300/ | 300/ | 300/ | 300/ | 300/ | 300/ | 300/ | 300/ | 300/ | 300/ |
| temperature | | | 120 | 120 | 120 | 120 | 120 | 120 | 120 | 120 | 120 | 120 |
| Evaluations | Tensile strength | MPa | 85 | 85 | 84 | 82 | 77 | 74 | 84 | 82 | 85 | 85 |
| | Evaluation | — | — | A | A | A | B | C | A | A | A | A |
| | Flexural modulus | MPa | 3800 | 3720 | 3690 | 3630 | 3500 | 3310 | 3680 | 3620 | 3800 | 3820 |
| | Evaluation | — | — | A | A | A | B | C | A | A | A | A |
| | Deflection temperature | ° C. | 105 | 104 | 103 | 101 | 98 | 95 | 102 | 101 | 105 | 105 |
| | under load | | | | | | | | | | | |
| | Hydrophilic powdery dust | % | 10 | 10 | 7 | 6 | 5 | 4 | 8 | 6 | 10 | 11 |
| | adhesive properties | | | | | | | | | | | |
| | Evaluation | — | D | D | C | C | B | B | C | C | D | D |
| | Hydrophobic powdery dust | % | 10 | 10 | 11 | 11 | 11 | 12 | 11 | 11 | 11 | 10 |
| | adhesive properties | | | | | | | | | | | |
| | Evaluation | | D | D | D | D | D | D | D | D | D | D |

| | | | | Comparative Example | | | | | | | |
|---|---|---|---|---|---|---|---|---|---|---|---|
| Items | | | Units | b131 | b132 | b133 | b134 | b135 | b136 | b137 | b138 |
| Composition | Component A | PPS | parts by | 100 | 100 | 100 | 100 | 100 | 100 | 100 | 100 |
| | | | mass | | | | | | | | |
| | Component B | PEPO-1 | parts by | | | | | | | | |
| | | PEPO-2 | mass | | | | | | | | |
| | Component C | StZn | parts by | | | 2.0 | 5.0 | | | | |
| | | StAl-1 | mass | | | | | 2.0 | 5.0 | | |
| | | StAl-2 | | 5.0 | 12.0 | | | | | | |
| | | StAl-3 | | | | | | | | 2.0 | 5.0 |

| Extrusion temperature (cylinder | | ° C. | 300 | 300 | 300 | 300 | 300 | 300 | 300 | 300 |
|---|---|---|---|---|---|---|---|---|---|---|
| temperature) | | | | | | | | | | |
| Drying temperature/cylinder | | ° C. | 120/ | 120/ | 120/ | 120/ | 120/ | 120/ | 120/ | 120/ |
| temperature/metal mold | | | 300/ | 300/ | 300/ | 300/ | 300/ | 300/ | 300/ | 300/ |
| temperature | | | 120 | 120 | 120 | 120 | 120 | 120 | 120 | 120 |
| Evaluations | Tensile strength | MPa | 87 | 88 | 85 | 87 | 85 | 86 | 86 | 87 |
| | Evaluation | — | A | A | A | A | A | A | A | A |
| | Flexural modulus | MPa | 3850 | 3880 | 3810 | 3860 | 3810 | 3850 | 3820 | 3850 |
| | Evaluation | — | A | A | A | A | A | A | A | A |
| | Deflection temperature | ° C. | 104 | 103 | 105 | 105 | 105 | 104 | 105 | 104 |
| | under load | | | | | | | | | |
| | Hydrophilic powdery dust | % | 11 | 11 | 11 | 11 | 11 | 11 | 11 | 11 |
| | adhesive properties | | | | | | | | | |
| | Evaluation | — | D | D | D | D | D | D | D | D |
| | Hydrophobic powdery dust | % | 9 | 7 | 10 | 9 | 10 | 10 | 10 | 10 |
| | adhesive properties | | | | | | | | | |
| | Evaluation | | D | C | D | D | D | D | D | D |

TABLE 21

| | | | | Example | | | | | | |
|---|---|---|---|---|---|---|---|---|---|---|
| Hems | | | Units | b140 | b141 | b142 | b143 | b144 | b145 | b146 |
| Compostion | Component A | PA6 | parts by | 100 | 100 | 100 | | 100 | 100 | 100 |
| | | PA66 | mass | | | | 100 | | | |
| | Component B | PEPO-1 | parts by | | | | | | | |
| | | FEPO-2 | mass | 0.5 | 3.0 | 5.0 | 5.0 | 10.0 | 18.0 | 24.0 |
| | Component C | StZn | parts by | | | | | | | |
| | | StAl-1 | mass | | | | | | | |
| | | StAl-2 | | 2.0 | 2.0 | 2.0 | 2.0 | 2.0 | 2.0 | 2.0 |
| | | StAl-3 | | | | | | | | |
| Extrusion temperature (cylinder | | | ° C. | 260 | 260 | 260 | 280 | 260 | 260 | 260 |
| temperature) | | | | | | | | | | |
| Drying temperature/cylinder | | | ° C. | 100/ | 100/ | 100/ | 100/ | 100/ | 100/ | 100/ |
| temperature/metal mold | | | | 260/ | 260/ | 260/ | 280/ | 260/ | 260/ | 260/ |
| temperature | | | | 80 | 80 | 80 | 80 | 80 | 80 | 80 |
| | Charpy impact strength | | kJ/m² | 30 | 32 | 33 | 27 | 30 | 28 | 26 |
| | Surface impact strength | | J | 29 | 29 | 30 | 28 | 28 | 26 | 24 |
| | (breakage energy) | | | | | | | | | |
| | Form of fracture | | — | A | A | A | A | A | A | A |
| | Deflection temperature | | ° C. | 59 | 59 | 58 | 67 | 58 | 57 | 56 |
| | under load | | | | | | | | | |
| | Hydrophilic powdery dust | | % | 5 | 2 | 1 | 1 | 1 | 1 | 1 |
| | adhesive properties | | | | | | | | | |
| | Evaluation | | — | B | A | A | A | A | A | A |
| | Hydrophobic powdery dust | | % | 6 | 2 | 1 | 1 | 1 | 1 | 1 |
| | adhesive properties | | | | | | | | | |
| | Evaluation | | — | B | A | A | A | A | A | A |
| | | | | Example | | | | | | |
| Hems | | | Units | b147 | b148 | b149 | b150 | b151 | b152 | b153 |
| Compostion | Component A | PA6 | parts by | 100 | 100 | 100 | 100 | 100 | 100 | |
| | | PA66 | mass | | | | | | | 100 |
| | Component B | PEPO-1 | parts by | | | | | | 5.0 | 5.0 |
| | | FEPO-2 | mass | 5.0 | 5.0 | 5.0 | 5.0 | 5.0 | | |
| | Component C | StZn | parts by | | | | | | | |
| | | StAl-1 | mass | | | | | | | |
| | | StAl-2 | | 0.3 | 1.0 | 5.0 | 8.0 | 12.0 | 2.0 | 2.0 |
| | | StAl-3 | | | | | | | | |
| Extrusion temperature (cylinder | | | ° C. | 260 | 260 | 260 | 260 | 260 | 260 | 280 |
| temperature) | | | | | | | | | | |
| Drying temperature/cylinder | | | ° C. | 100/ | 100/ | 100/ | 100/ | 100/ | 100/ | 100/ |
| temperature/metal mold | | | | 260/ | 260/ | 260/ | 260/ | 260/ | 260/ | 280/ |
| temperature | | | | 80 | 80 | 80 | 80 | 80 | 80 | 80 |
| | Charpy impact strength | | kJ/m² | 33 | 33 | 32 | 28 | 26 | 32 | 26 |
| | Surface impact strength | | J | 29 | 30 | 28 | 26 | 25 | 29 | 28 |
| | (breakage energy) | | | | | | | | | |
| | Form of fracture | | — | A | A | A | A | B | A | A |
| | Deflection temperature | | ° C. | 59 | 58 | 57 | 56 | 55 | 58 | 67 |
| | under load | | | | | | | | | |
| | Hydrophilic powdery dust | | % | 5 | 1 | 1 | 1 | 1 | 1 | 1 |
| | adhesive properties | | | | | | | | | |
| | Evaluation | | — | B | A | A | A | A | A | A |
| | Hydrophobic powdery dust | | % | 6 | 2 | 2 | 1 | 1 | 2 | 1 |
| | adhesive properties | | | | | | | | | |
| | Evaluation | | — | B | A | A | A | A | A | A |
| | | | | Example | | | | | | |
| Hems | | | Units | b154 | b155 | b156 | b157 | b158 | b159 | b160 |
| Compostion | Component A | PA6 | parts by | 100 | 100 | 100 | 100 | 100 | 100 | 100 |
| | | PA66 | mass | | | | | | | |
| | Component B | PEPO-1 | parts by | 10.0 | | | | | | |
| | | FEPO-2 | mass | | 5.0 | 5.0 | 5.0 | 5.0 | 5.0 | 5.0 |
| | Component C | StZn | parts by | | 0.3 | 2.0 | | | | |
| | | StAl-1 | mass | | | | 0.3 | 2.0 | | |
| | | StAl-2 | | 2.0 | | | | | | |
| | | StAl-3 | | | | | | | 0.3 | 2.0 |

| Extrusion temperature (cylinder | | ° C. | 260 | 260 | 260 | 260 | 260 | 260 | 260 |
|---|---|---|---|---|---|---|---|---|---|
| temperature) | | | | | | | | | |
| Drying temperature/cylinder | | ° C. | 100/ | 100/ | 100/ | 100/ | 100/ | 100/ | 100/ |
| temperature/metal mold | | | 260/ | 260/ | 260/ | 260/ | 260/ | 260/ | 260/ |
| temperature | | | 80 | 80 | 80 | 80 | 80 | 80 | 80 |
| | Charpy impact strength | kJ/m² | 30 | 32 | 32 | 33 | 32 | 32 | 32 |
| | Surface impact strength | J | 28 | 29 | 29 | 29 | 30 | 29 | 30 |
| | (breakage energy) | | | | | | | | |
| | Form of fracture | — | A | A | A | A | A | A | A |
| | Deflection temperature | ° C. | 58 | S9 | 58 | 58 | 58 | 59 | 58 |
| | under load | | | | | | | | |
| | Hydrophilic powdery dust | % | 1 | 8 | 6 | 7 | 4 | 8 | 4 |
| | adhesive properties | | | | | | | | |
| | Evaluation | — | A | C | C | C | B | C | B |
| | Hydrophobic powdery dust | % | 1 | 8 | 7 | 7 | 5 | 8 | 5 |
| | adhesive properties | | | | | | | | |
| | Evaluation | — | A | C | C | C | B | C | B |

TABLE 22

| | | | | Comparative Example | | | | | | | |
|---|---|---|---|---|---|---|---|---|---|---|---|
| Items | | | Units | b139 | b140 | b141 | b142 | b143 | b144 | b145 | b146 |
| Composition | Component A | PA6 | parts by | 100 | | 100 | 100 | | 100 | 100 | 100 |
| | | PA66 | mass | | 100 | | | 100 | | | |
| | Component B | PEPO-1 | parts by | | | | | | | | |
| | | PEPO-2 | mass | | | 3.0 | 5.0 | 5.0 | 10.0 | 18.0 | 24.0 |
| | Component C | StZn | parts by | | | | | | | | |
| | | StAl-1 | mass | | | | | | | | |
| | | StAl-2 | | | | | | | | | |
| | | StAl-3 | | | | | | | | | |

| Extrusion temperature (cylinder | | ° C. | 260 | 280 | 260 | 260 | 280 | 260 | 260 | 260 |
|---|---|---|---|---|---|---|---|---|---|---|
| temperature) | | | | | | | | | | |
| Drying temperature/cylinder | | ° C. | 100/ | 100/ | 100/ | 100/ | 100/ | 100/ | 100/ | 100/ |
| temperature/metal mold | | | 260/ | 280/ | 260/ | 260/ | 280/ | 260/ | 260/ | 260/ |
| temperature | | | 80 | 80 | 80 | 80 | 80 | 80 | 80 | 80 |
| | Charpy impact strength | kJ/m² | 30 | 25 | 33 | 35 | 28 | 32 | 28 | 25 |
| | Surface impact strength | J | 30 | 29 | 30 | 28 | 27 | 26 | 25 | 23 |
| | (breakage energy) | | | | | | | | | |
| | Form of fracture | — | A | A | A | A | A | A | A | A |
| | Deflection temperature | ° C. | 60 | 70 | 60 | 60 | 70 | 59 | 58 | 57 |
| | under load | | | | | | | | | |
| | Hydrophilic powdery dust | % | 11 | 10 | 11 | 8 | 8 | 7 | 5 | 4 |
| | adhesive properties | | | | | | | | | |
| | Evaluation | — | D | D | D | C | C | C | B | B |
| | Hydrophobic powdery dust | % | 12 | 12 | 11 | 10 | 11 | 11 | 12 | 12 |
| | adhesive properties | | | | | | | | | |
| | Evaluation | — | D | D | D | D | D | D | D | D |

| | | | | Comparative Example | | | | | | |
|---|---|---|---|---|---|---|---|---|---|---|
| Items | | | Units | b147 | b148 | b149 | b150 | b151 | b152 | b153 |
| Composition | Component A | PA6 | parts by | 100 | | 100 | 100 | 100 | | 100 |
| | | PA66 | mass | | 100 | | | | 100 | |
| | Component B | PEPO-1 | parts by | 5.0 | 5.0 | 10.0 | | | | |
| | | PEPO-2 | mass | | | | | | | |
| | Component C | StZn | parts by | | | | | | | |
| | | StAl-1 | mass | | | | | | | |
| | | StAl-2 | | | | | 0.3 | 2.0 | 2.0 | 5.0 |
| | | StAl-3 | | | | | | | | |

| Extrusion temperature (cylinder | | ° C. | 260 | 280 | 260 | 260 | 260 | 280 | 260 |
|---|---|---|---|---|---|---|---|---|---|
| temperature) | | | | | | | | | |
| Drying temperature/cylinder | | ° C. | 100/ | 100/ | 100/ | 100/ | 100/ | 100/ | 100/ |
| temperature/metal mold | | | 260/ | 280/ | 260/ | 260/ | 260/ | 280/ | 260/ |
| temperature | | | 80 | 80 | 80 | 80 | 80 | 80 | 80 |
| | Charpy impact strength | kJ/m² | 34 | 27 | 33 | 30 | 30 | 24 | 29 |
| | Surface impact strength | J | 28 | 26 | 25 | 30 | 29 | 27 | 30 |
| | (breakage energy) | | | | | | | | |
| | Form of fracture | — | A | A | A | A | A | A | A |
| | Deflection temperature | ° C. | 59 | 69 | 59 | 60 | 59 | 68 | 58 |
| | under load | | | | | | | | |
| | Hydrophilic powdery dust | % | 8 | 8 | 7 | 11 | 11 | 10 | 11 |
| | adhesive properties | | | | | | | | |
| | Evaluation | — | C | C | C | D | D | D | D |
| | Hydrophobic powdery dust | % | 11 | 10 | 11 | 11 | 10 | 10 | 9 |
| | adhesive properties | | | | | | | | |
| | Evaluation | — | D | D | D | D | D | D | D |

| | | | | Comparative Example | | | | | | |
|---|---|---|---|---|---|---|---|---|---|---|
| Items | | | Units | b154 | b155 | b156 | b157 | b158 | b159 | b160 |
| Composition | Component A | PA6 | parts by | 100 | 100 | 100 | 100 | 100 | 100 | 100 |
| | | PA66 | mass | | | | | | | |
| | Component B | PEPO-1 | parts by | | | | | | | |
| | | PEPO-2 | mass | | | | | | | |
| | Component C | StZn | parts by | | 2.0 | 5.0 | | | | |
| | | StAl-1 | mass | | | | 2.0 | 5.0 | | |
| | | StAl-2 | | 12.0 | | | | | | |
| | | StAl-3 | | | | | | | 2.0 | 5.0 |

| Extrusion temperature (cylinder | | ° C. | 260 | 260 | 260 | 260 | 260 | 260 | 260 |
|---|---|---|---|---|---|---|---|---|---|
| temperature) | | | | | | | | | |
| Drying temperature/cylinder | | ° C. | 100/ | 100/ | 100/ | 100/ | 100/ | 100/ | 100/ |
| temperature/metal mold | | | 260/ | 260/ | 260/ | 260/ | 260/ | 260/ | 260/ |
| temperature | | | 80 | 80 | 80 | 80 | 80 | 80 | 80 |
| | Charpy impact strength | kJ/m² | 27 | 30 | 30 | 30 | 29 | 30 | 30 |
| | Surface impact strength | J | 27 | 29 | 30 | 30 | 30 | 29 | 30 |
| | (breakage energy) | | | | | | | | |
| | Form of fracture | — | B | A | A | A | A | A | A |
| | Deflection temperature | ° C. | 56 | 59 | 59 | 60 | 59 | 60 | 58 |
| | under load | | | | | | | | |
| | Hydrophilic powdery dust | % | 11 | 11 | 10 | 11 | 11 | 10 | IO |
| | adhesive properties | | | | | | | | |
| | Evaluation | — | D | D | D | D | D | D | D |
| | Hydrophobic powdery dust | % | 8 | 11 | 11 | 11 | 10 | 11 | 10 |
| | adhesive properties | | | | | | | | |
| | Evaluation | — | C | D | D | D | D | D | D |

From the results of evaluations shown in Tables 1 to 22, it can be verified that a high effect of suppressing adhesion (anti-contamination effect) of hydrophilic powdery dust fouling and hydrophobic powdery dust fouling is obtained in Examples, i.e., the molded articles comprising the thermoplastic resin composition comprising the thermoplastic resin (A), the hydrophilic copolymer (B) having a polyoxyethylene chain, and the fatty acid metal salt (C).

Furthermore, it can be also verified that favorable mechanical strength of the molded articles is obtained by adjusting the compounding amounts of the components.

It can be observed that compared to the case where zinc stearate, aluminum monostearate, or aluminum tristearate is used, the effect of suppressing adhesion (anti-contamination effect) of both hydrophilic powdery dust fouling and hydrophobic powdery dust fouling is likely to be more excellent in the case where (hydroxy)aluminum distearate is used as the fatty acid metal salt (C) (that is, where a metal salt containing two fatty acids is used for the metal element M having a valency of 3).

It should be considered that the embodiments and Examples disclosed herein are illustrative and not limited to the present disclosure in all respects. The scope of the present disclosure is represented by Claims, rather than the descriptions above, and it is intended that the scope of the present disclosure covers meanings equivalent to Claims and all the modifications made within the scope.

### REFERENCE SIGNS LIST

10 body case, 11 air suction port, 12 air discharge port, 13 fan, 14 front surface panel, 15, 16 vertical wind directing plates, 17 prefilter, 18 drain pan, 19 horizontal wind directing plate, 20 rear surface wall, 21 wind path, 22 heat exchanger

1. A thermoplastic resin composition comprising:
a thermoplastic resin (A) selected from the group consisting of an aromatic polycarbonate resin (A1), a styrene-based resin (A2), an aromatic polyester resin (A3), a polyphenylene ether resin (A4), a methacrylic resin (A5), a polyarylene sulfide resin (A6), an olefin resin (A7), a polyamide resin (A8), and mixtures thereof;
a hydrophilic copolymer (B) having a polyoxyethylene chain, wherein the hydrophilic copolymer (B) is a hydrophilic copolymer (B1) composed of a polyolefin repeatedly and alternately bonded to a hydrophilic polymer having a polyoxyethylene chain, or a polyether ester amide (B2); and
a fatty acid metal salt (C) represented by the following formula (1):
M(OH)y(R—COO)x (1)
wherein R is an alkyl group or alkenyl group having 6 to 40 carbon atoms; M is at least one metal element selected from the group consisting of aluminum; and zinc; and x and y each independently represent an integer of 0 or more, and satisfy the relation represented by x+y=[valency of M].

2. The thermoplastic resin composition according to claim 1, comprising 100 parts by mass of the thermoplastic resin (A), 1 to 20 parts by mass of the hydrophilic copolymer (B), and 0.5 to 10 parts by mass of the fatty acid metal salt (C).

3. (canceled)

4. The thermoplastic resin composition according to claim 1, wherein in the formula (1), M is aluminum.

5. The thermoplastic resin composition according to claim 1, wherein in the formula (1), y is 1.

6. The thermoplastic resin composition according to claim 1, wherein the styrene-based resin (A2) is selected from the group consisting of PS resins, HIPS resins, MS resins, ABS resins, AS resins, AES resins, ASA resins, MBS resins, MABS resins, MAS resins, and mixtures thereof.

7. The thermoplastic resin composition according to claim 1, wherein the aromatic polyester resin (A3) is selected from the group consisting of polybutylene terephthalate resins, polyethylene terephthalate resins, and mixtures thereof.

8. (canceled)

9. A molded article comprising the thermoplastic resin composition according to claim 1.

10. The molded article according to claim 9, wherein the concentration of the fatty acid metal salt (C) in a portion ranging from a surface of the molded article to a predetermined depth is higher than the concentration of the fatty acid metal salt (C) in a portion deeper than the predetermined depth.

11. A product comprising the molded article according to claim 9.
